(19) United States
(12) Patent Application Publication
(10) Pub. No.: US 2026/0295930 A1
(43) Pub. Date: Oct. 1, 2026

(54) DROPLET IMPACT-INDUCED CHEMICAL RELEASE FROM STRUCTURED FLUIDS

(71) Applicant: Ohio State Innovation Foundation, Columbus, OH (US)

(72) Inventors: Xiaoguang WANG, Powell, OH (US); Meng ZHANG, Columbus, OH (US)

(21) Appl. No.: 19/479,662

(22) PCT Filed: Apr. 29, 2024
(86) PCT No.: PCT/US2024/026834

§ 371 Date: Oct. 28, 2025

Related U.S. Application Data
(60) Provisional application No. 63/498,861, filed on Apr. 28, 2023.

(51) Int. Cl. B29C 64/112; B29C 64/205; B29C 64/245; B33Y 10/00; B33Y 30/00; C08J 3/075

(52) U.S. Cl. CPC B29C 64/112; B29C 64/205; B29C 64/245; C08J 3/075; B33Y 10/00; B33Y 30/00

(57) ABSTRACT

The techniques described herein relate to a method for patterning including: depositing an aqueous printing liquid droplet from a source onto a top surface of a liquid crystal substrate, wherein a first printing material is disposed into the liquid crystal substrate, and wherein an impact of the aqueous printing liquid droplet causes the first printing material to be released onto the top surface of the liquid crystal substrate within a proximal area of the impacted aqueous printing liquid droplet; and curing the first printing material on the top surface of the liquid crystal substrate. A system for printing is additionally disclosed. A hydrogel produced using the disclosed system and method is also disclosed.

### CROSS REFERENCE TO RELATED APPLICATION

This application claims priority to, and the benefit of, U.S. Provisional Application Ser. No. 63/498,861, filed Apr. 28, 2023, the disclosure of which is expressly incorporated herein by reference in its entirety.

### BACKGROUND

Inkjet printing technology is a widely utilized manufacturing method because of its high precision, reproducibility, and throughput enabled by having multiple nozzles in one printhead. It also allows for multi-material printing, non-contact manufacturing, custom designs, and low material consumption. Over the past decades, inkjet printing has been exploited in a wide range of industrial and biological applications spanning several important sectors, including manufacturing circuit boards, solar cells, polymeric light-emitting diodes, optical microlens, metal and ceramics, and bioprinting. There are three key processes during inkjet printing: ink droplets are dispensed from the tip of a nozzle, impact on a receiving substrate, and cure through drying or chemical reactions to form the final products strongly bound to the receiving substrate. A successful print process must meet contradictory requirements. Specifically, the successful dispensing of ink droplets at the printhead requires a low viscosity and a high ejection speed, which can cause droplets to splash on the receiving substrate, compromising the print resolution and precision. As a result, only a limited combination of ink properties and operating conditions are “printable.”

Efforts have been made to unveil droplet impact physics and develop strategies to control the impact outcomes. The outcomes are orchestrated by the complex interactions between inertial, viscous, and surface tension effects. The most relevant dimensionless numbers to characterize these effects are the Weber number (We), Reynolds number (Re=β_{w}νD/μ, where μ is the dynamic viscosity), or Ohnesorge number (Oh=We^{1/2}/Re=μ/(ρ_{w}γ_{w}D))^{1/2}). To achieve a transition in the droplet impact behavior on fluid surfaces, specifically from bouncing to merging, PI Tang has developed a regime map based on We and liquid substrate thickness, as shown in FIG. 3A. The transition boundaries are found to be a function of both We and a dimensionless film thickness (H*=H/R, in which His the thickness of the liquid substrate and R is the radius of droplet) and have been predicted through scaling analysis. The criteria for a specific droplet impact behavior on solid surfaces can be found when He approaches zero. Furthermore, the effect of viscosity on the transition boundaries has also been experimentally measured and theoretically predicted (FIG. 3B). With the theoretical prediction of the impact outcome, the design space for the immediate merging and deposition of droplets on a receiving substrate has been mapped out to allow precise control of the printing resolution. Various scaling laws have been proposed for the criteria for splashing as well, with the commonly accepted threshold being WeRe^{1/2}>3,000. After the droplet merges with the substrate, complex mixing patterns arise due to the vortex generated from the shear stress during the impact. This vortex structure enhances the mixing and is important for the transport and delivery of chemicals when the droplet liquid reacts with the liquid film. At the same time, the stress field after merging is complicated. PI Tang's past research has studied the afterlife of droplets merging with the liquid film. This knowledge provides the basis to develop the understanding and design principles to control the drop behavior upon impact on a LC receiving substrate.

Despite the extensive studies, neither solid-nor simple liquid-based receiving substrates satisfy the requirements in the disclosed framework to trap microcapsules that droplet impacts can then release. Although simple liquid surfaces can trap immiscible liquid droplets, any impact inertia will result in mixing between the water droplet and the liquid substrate, leading to uncontrolled microcapsule release as simple liquids possess high levels of molecular mobility but no molecular order. To achieve the controlled release in the disclosed framework, a liquid substrate needs to trap the microcapsules until the impact force reaches a threshold value.

LCs are a representative class of structured fluids that exhibit properties commonly associated with crystalline solids (a long-range orientational ordering of constituent molecules) and simple fluids (high mobility of constituent molecules). As shown in FIG. 4, the LC molecules in the nematic phase have no positional order but tend to point in the same direction (along the director). In contrast, above the nematic to isotropic phase transition temperature (T_{N-I}), the LC molecules behave similarly to simple, non-structured fluids with no intrinsic molecular order. Recently, extensive studies have demonstrated that the intrinsic long-range orientational ordering of the constituent LC molecules leads to a remarkable diversity of interfacial phenomena distinct from simple fluids. Particularly, PI Wang's past research has demonstrated that the long-range molecular order of LCs provides an additional interparticle force that impedes the release of particles and droplets dispersed in the bulk LC. When a dispersed microphase of an immiscible liquid, solid, or gas (namely microcapsules) is introduced into a bulk LC, the orientational ordering around the microcapsule is determined by a competition between the elastic energy arising from the strain of the LCs (KR_{capsule}, where K is the Frank elastic constant of the LC and R_{capsule} is the microcapsule radius) and an orientation-dependent surface anchoring energy at the LC-microcapsule interface (WR_{capsule}², where W is the surface anchoring energy density). When R_{capsule}>K/W, the microcapsule will strain the LC orientation and form topological defect structures, which give rise to strong repulsive forces between the microcapsule and the LC boundaries and prevent the contact or coalescence of microcapsules in the bulk LC, as well as the release of the microcapsules from the LC bulk to the surrounding water phase. However, upon a nematic to isotropic phase transition by heating above T_{N-I}, the LC orientational ordering is disrupted. The absence of the repulsive LC elastic forces results in the release of microcapsules to the overlying aqueous phase. These results reveal that the release of microcapsules can be precisely controlled through manipulation of the LC orientational ordering using external stimuli such as heat and light. However, control over microcapsule release using droplet impacts is yet to be explored.

The manipulation of mass transfer from one fluid to the other is crucial in a wide range of applications, including adsorption and separation, emulsification, liquid-liquid extraction, reactor designs, and drug delivery. Up-to-date, extensive studies have reported that mass transport across the interfaces of two immiscible simple fluids (e.g., water-silicone oil) is dominated by van der Waals forces, electric double layer forces, and gravitational and buoyancy forces. Thermotropic liquid crystals (LCs), a representative class of anisotropic structural fluids, combine properties commonly associated with crystalline solids (long-range molecular order) and isotropic liquids (high levels of molecular mobility). Compared with simple fluids, the long-range molecular orientation introduces novel forces to the immiscible microphases (liquid, solid, or gas) dispersed in the bulk LC, specifically elastic forces and surface anchoring, resulting in novel colloidal assembly that has not been observed in simple fluids. More recently, studies have shown that a disruption of the LC orientation by heat and light enables the transportation of aqueous microdroplets or solid microparticles and their chemical contents initially encapsulated within the LC to the surrounding immiscible simple fluid (e.g., water), which provides a platform to investigate the mass transport between a simple fluid and a structured fluid. However, little is understood about droplet impact-induced mass transport between water droplets and LC films.

### SUMMARY

Disclosed herein are methods and systems for printing onto a liquid crystal-infused porous surface. An exemplary method for printing comprises dispensing an aqueous droplet from a source and impacting of the aqueous droplet onto a top surface of a receiving substrate. In some aspects, the receiving substrate comprises a first printing material, wherein an impact of the aqueous droplet causes the first printing material to transfer from the receiving substrate to the aqueous droplet.

In some aspects, the method described herein is a method for printing including: dispensing an aqueous droplet from a source; and impacting of the aqueous droplet onto a top surface of a receiving substrate, wherein the receiving substrate includes a first printing material; wherein an impact of the aqueous droplet causes the first printing material to transfer from the receiving substrate to the aqueous droplet.

In some aspects, the receiving substrate further includes: a supporting substrate; a porous polymer layer having a surface, wherein the porous polymer layer includes a continuous phase permeated by a plurality of pores, and wherein the continuous phase includes a liquid crystal polymer; and an anisotropic lubricant infused within and over the porous polymer layer, such that that the anisotropic lubricant at least partially fills the plurality of pores and forms a film on the surface of the porous polymer layer, wherein the anisotropic lubricant includes thermotropic liquid crystal mesogen and the first printing material.

In some aspects, the liquid crystal polymer is derived from 1,4-Bis-[4~ (3~ acryloyloxypropyloxy)benzoyloxy]-2-methylbenzene (RM257), 4-(6-acryloxy-hex-1-yl-oxy) phenyl 4-(hexyloxy)benzoate, 4-methoxybenzoic acid 4-(6-acryloyloxyhexyloxy) phenyl ester 4″-acryloyloxybutyl 2,5-di(4′-butyloxybenzoyloxy)benzoate, or combinations thereof.

In some aspects, the thermotropic liquid crystal mesogen includes 4-cyano-4′-n-pentyl-biphenyl (5CB), 4-cyano-4′-n-heptyl-biphenyl (7CB), 4-octyl-4-biphenylcarbonitrile (8CB), 4-cyano-4′-oxyoctyl-biphenyl (8OCB), 4-cyano-4′-n-pentyl-terphenyl (5CT), (S)-4-Cyano-4′-(2-methylbutyl) biphenyl (CB15), or a combination thereof.

In some aspects, the thermotropic liquid crystal mesogen has: a crystal mesophase when the thermotropic liquid crystal mesogen is at a temperature that is less than a first transition temperature, wherein when the thermotropic liquid crystal mesogen is in the crystal mesophase the thermotropic liquid crystal mesogen has long range orientational order and three dimensional positional order; a smectic mesophase when the thermotropic liquid crystal mesogen is at a temperature greater than the first transition temperature and less than a second transition temperature, wherein the second transition temperature is greater than the first transition temperature, and wherein the smectic mesophase has long range orientational order and at least unidirectional positional order; a nematic mesophase when the thermotropic liquid crystal mesogen is at a temperature greater than the second transition temperature and less than a third transition temperature, wherein the third transition temperature is greater than the second transition temperature, and wherein the nematic mesophase bas long range orientational order and no positional order; and an isotropic mesophase when the thermotropic liquid crystal mesogen is at a temperature above a second transition temperature, and wherein the isotropic mesophase has no orientational order and no positional order.

In some aspects, the method described herein further includes changing a temperature of the receiving substrate resulting in a mesophase change of the liquid crystal mesogen.

In some aspects, the first printing material includes a microparticle (e.g. ink, chemical, etc) in an aqueous solution.

In some aspects, the first printing material is present as an emulsion in the anisotropic lubricant.

In some aspects, the first printing material includes one or more of a polymer, a biologic material, a dye, a salt, a surfactant, an ionic liquid, or a colloidal dispersion of inorganic, organic, or metallic molecules, or combinations thereof.

In some aspects, an aqueous droplet density, a height of the source from the top surface of the receiving substrate, and/or a diameter of droplet of the aqueous droplet are varied to achieve an optimal Weber number (e.g. We).

In some aspects, the optimal Weber number is 10 to 200.

In some aspects, the source of the aqueous droplet is configured to dispense aqueous printing liquid droplets of 10 nL to 1 mL.

In some aspects, the first printing material has a viscosity of 1 cP to 10⁶ cP.

In some aspects, the receiving substrate includes up to 40% by volume of the first printing material.

In some aspects, the aqueous droplet includes one or more activating or reactive species, wherein an activating or reactive species is activating and/or reactive with the first printing material.

In some aspects, the receiving substrate includes a second printing material, and wherein the receiving substrate includes up to 40% by volume of the first printing material and the second printing material.

In some aspects, the aqueous droplet includes one or more activating or reactive species, wherein an activating or reactive species is activating and/or reactive with the first printing material and the second printing material.

In some aspects, the system described herein relates to a system for printing including: a receiving substrate including a first printing material (e.g. ink, chemical, etc); an aqueous printing liquid; and a device for dispensing said aqueous printing liquid as an aqueous droplet onto a top surface of the receiving substrate; wherein an impact of the aqueous droplet causes the first printing material to transfer from the receiving substrate to the aqueous droplet.

In some aspects, an aqueous droplet density, a height of the device for dispensing from the top surface of the receiving substrate, and a diameter of droplet of the aqueous droplet are varied to achieve an optimal Weber number (e.g. We).

In some aspects, the device for dispensing of the aqueous droplet is configured to dispense aqueous printing liquid droplets of 10 nL and 1 mL.

In some aspects, a hydrogel product is disclosed, the hydrogen product including one or more bioactive and/or bioinert compounds, the hydrogel product having a discrete size and shape, wherein the hydrogel material is formed by droplet-induced printing, wherein a receiving substrate includes one or more hydrogel precursors, and wherein a printing liquid includes an aqueous printing liquid dispensed from a source.

In some aspects, a hydrogel is printed on a receiving substrate, the receiving substrate including: a supporting substrate; a porous polymer layer having a surface, wherein the porous polymer layer includes a continuous phase permeated by a plurality of pores, and wherein the continuous phase includes a liquid crystal polymer; and an anisotropic lubricant infused within and over the porous polymer layer, such that that the anisotropic lubricant at least partially fills the plurality of pores and forms a film on the surface of the porous polymer layer, wherein the anisotropic lubricant includes thermotropic liquid crystal mesogen and the one or more hydrogel precursors.

In some aspects, the printing liquid further includes bioglass.

In some aspects, the hydrogel product includes a thickness of 5 micrometers to 20 micrometers.

In some aspects, the hydrogel product includes a tensile strength of 0.25 MPa to 2.5 MPa.

In some aspects, the hydrogel product has a disc shape.

In some aspects, the hydrogel product has a ring shape.

In some aspects, the source of the aqueous printing liquid is an ink jet printer.

### BRIEF DESCRIPTION OF THE DRAWINGS

FIG. 1A shows a schematic representation illustrating the impact of water droplets on LC surfaces.

FIG. 1B shows the molecular structure of 8CB and its molecular assembly across various mesophases.

FIG. 1C shows the phase diagram and high-speed photographs showing diverse droplet impact behaviors on 8CB surfaces with distinct mesophases. The impacting water droplet had a volume of 4.7 μL.

FIG. 2A shows high speed photographs illustrating the rebound phenomenon of droplet impact on nematic or isotropic LC surfaces at We=60.

FIG. 2B shows time-evolved changes in the droplet contact length D normalized by the droplet diameter Dₒ, termed the spread factor D/Dₒ, on 8CB films with different mesophases.

FIG. 2C shows plots showing the retraction rate of impacting droplets on 8CB films with various mesophases over time.

FIG. 2D shows the maximum spread factor Dₘₐₓ/Dₒ of impacting droplets on 8CB films with different mesophases as a function of We. The impacting water droplet had a volume of 4.7 μL. Error bars denote standard deviations derived from three independent measurements.

FIG. 3A shows a schematic of droplet impact-induced mass transfer from LC films to impacting droplets. FIG. 3B shows plots and corresponding photographs of the concentration of ethyl orange transferred from 8CB films to the impacting droplet over time. Scale bars, 5 mm.

FIG. 3C shows a plot of the concentrations of ethyl orange in the impacting water droplets on 8CB films of different mesophases at 3 seconds as a function of We. Temperatures were set at 25° C., 35° C., and 45° C. to achieve smectic A, nematic, and isotropic phases of 8CB, respectively.

FIG. 3D shows a schematic illustration of printed materials with a broad viscosity range induced by droplet impact, where the droplet evaporated after impacting.

FIG. 3E shows a plot of the independence of We_{LC→water} on substance viscosity. The impacting water droplet had a volume of 20 μL. Error bars indicate standard deviations from three independent measurements.

FIG. 4A shows a schematic displaying We-dependent scenarios of water-LC mass transfer.

FIG. 4B shows a plot illustrating the concentrations of oil blue transferred from an impacting droplet to the 8CB film (blue) and the concentrations of ethyl orange transferred to a water droplet impacting on an 8CB film (red) at 3 s as a function of We. Insets depict corresponding photographs of water droplets 7 s after impacting 8CB films. Scale bars, 1 mm. Temperatures were set at 25° C., 35° C., and 45° C. to achieve smectic A, nematic, and isotropic phases of 8CB, respectively. sodium dodecyl sulfate (SDS) concentration in the impacting water droplets and the encapsulated micrometer-sized aqueous droplets was 7 mM and 3 mM, respectively.

FIG. 4C shows a schematic depicting the printing of hydrogel patches enabled by droplet impact on LC film.

FIG. 4D shows a plot and photographs comparing tensile stress of the alginate hydrogels as function of alginate concentration in the aqueous microdroplets encapsulated in the LC film, with conventionally printed alginate hydrogels using different crosslinkers. Scale bars, 5 mm.

FIG. 4E shows plots and confocal laser scanning micrographs illustrating the inner-to-outer diameter ratio at different We. Scale bars, 1 mm.

FIG. 4F shows photographs showing the hemostatic capabilities of the hydrogel on a heart wound. Scale bars, 5 mm.

FIGS. 4G-4H show plots of the adhesive strengths (FIG. 4G) and the hemostatic performance of the hydrogels (FIG. 4H). Error bars represent standard deviations from three independent measurements.

FIGS. 5A-5B UV-visible spectrophotometry calibration curves of ethyl orange in water (FIG. 5A) and oil blue in ethanol (FIG. 5B). Insets show the molecular structures of (FIG. 5A) ethyl orange and (FIG. 5B) oil blue, respectively. The absorbance-concentration calibration curves were plotted using the absorbance at 474 nm for ethyl orange and 643 nm for oil blue.

FIG. 6 shows the concentration of ethyl orange transferred from smectic A 8CB films to the impacting droplet as a function of time. Insets exhibit corresponding photographs of water droplets on LC films 7 seconds after droplet impacting the 8CB films. The volume of the impacting water droplet was 20 μL. The fraction of ethyl orange aqueous microdroplets in 8CB film was 20 wt %. SDS concentration in the encapsulated micrometer-sized aqueous droplets was 3 mM. Temperature was set at 25° C. to achieve smectic A phase of 8CB. Scale bars, 5 mm.

FIG. 7 shows the concentration of ethyl orange (doped in glycerol microdroplets) in the water droplets on nematic 8CB films at 3 s as a function of We. The vertical red dashed line indicates the threshold We of LC-to-water mass transfer. The volume of the impacting water droplet was 20 μL. The fraction of ethyl orange-doped glycerol in neamtic 8CB was 20 wt %. The SDS concentration in glycerol was 3 mM. Temperature was set at 35° C. to achieve nematic phase of 8CB.

FIG. 8A shows We-dependent droplet impact-induced mass transfer from an impacting droplet to a nematic LC film. Insets show a schematic illustration and corresponding polarized light micrograph of the LC ordering within an oil blue-doped nematic 8CB microdroplet dispersed in a SDS aqueous solution. The black dashed lines indicate the local LC director in the nematic 8CB microdroplet. The white, crossed, double-headed arrows indicate the direction of the crossed polarizers. Scale bar, 5 μm.

FIG. 8B shows the concentration of oil blue transferred from an impacting droplet to 8CB films as a function of time. Insets show the corresponding photographs of the impacting water droplets 7 s after impacting the 8CB films. Scale bars, 5 mm.

FIG. 8C shows the concentration of oil blue in 8CB films in different mesophases at 3 s as a function of the We. The vertical red and black dashed lines indicate the threshold We of water-to-LC mass transfer (We_{water→LC}) for nematic and smectic A phases, respectively. The volume of the impacting water droplet was 20 μL. The fraction of oil blue-doped 8CB microdroplets in the impacting water droplet was 20 wt %. The SDS concentration in the impacting aquoeus droplet was 7 mM. The temperatures were set at 25° C., 35° C., and 45° C. to achieve smectic A, nematic, and isotropic phase 8CB, respectively.

FIG. 9A shows a water droplet impacting a 8CB film with ethyl orange aqueous microdroplets encapsulated within the porous polyRM257 network rather than the pure 8CB film on top.

FIG. 9B shows a corresponding plot showing no measurable ethyl orange transfer from the porous polyRM257 network to the impacting water droplet as a function of the We. The temperature was set at 37° C. to create a nematic 8CB film. The volume of ethyl orange aqueous microdroplets in the nematic 8CB-inflused porous polyRM257 network was 20 wt %, and the concentration of ethly orange in the aqueous microdroplets was 8.4 mM. The SDS concentration in the aqueous microdroplets was 5 mM. Error bars represent standard deviations from three independent measurements.

FIG. 10A shows the We-independent bidirectional mass transfer across a water-silicone oil interface.

FIG. 10B shows the concentration of ethyl orange transferred from the silicone oil film to an impacting water droplet and the concentration of oil blue transferred from an impacting droplet to the silicone oil film at 3 s as a function of We. The volume of the impacting water droplet was 20 μL. Both fractions of oil blue-doped silicone oil microdroplets in the impacting water droplet and ethyl orange aqueous microdroplets in silicone oil film were 20 wt %. SDS concentration in the impacting water droplets and the encapsulated micrometer-sized aqueous droplets was 7 mM and 3 mM, respectively. Temperature was set at 25° C.

FIG. 11A shows the direction of unidirectional mass transfer as a function of surfactant concentrations in aqueous microdroplets in nematic 8CB films and impacting water droplet containing nematic 8CB microdroplets.

FIG. 11B shows the concentrations of oil blue transferred from an impacting droplet to the 8CB film and the concentration of ethyl orange transferred to a water droplet impacting on an 8CB film at 3 s as a function of We. Insets show corresponding photographs of water droplets 7 s after impacting 8CB films. Scale bars, 1 mm. The volume of the impacting water droplet was 20 μL. Both fractions of ethyl orange aqueous microdroplets in the 8CB film and oil blue-doped 8CB microdroplets in the impacting water droplet were 20 wt %. SDS concentration in the impacting water droplets and the encapsulated micrometer-sized aqueous droplets was 3 mM and 7 mM, respectively. Temperatures were set at 25° C., 35° C., and 45° C. to achieve smectic A, nematic, and isotropic phases of 8CB, respectively.

FIGS. 12A-12B show a plot of We-dependent thickness of droplet impact-printed hydrogels (FIG. 12A) and a plot of light transmission of droplet impact-printed hydrogels as function of concentration of alginate in the aqueous microdroplets encapsulated in the LC film (FIG. 12B).

FIG. 13A shows droplet impact-enabled hydrogel printing.

FIG. 13B shows printed hydrogels (alginate, acrylic acid, acrylamide, and chitosan) encapsulating diverse chemicals in impacting droplets and LC films. Scale bars, 5 mm.

FIGS. 14A-14B show size distributions of ethyl orange aqueous microdroplets encapsulated in a LC film and oil blue-doped 8CB microdroplets encapsulated in a water droplet and polarized light micrographs and size distributions of ethyl orange aqueous microdroplets encapsulated in a nematic 8CB film (FIG. 14A) and oil blue-doped nematic 8CB microdroplets encapsulated in a water droplet (FIG. 14B) at 37° C. The white, crossed, double-headed arrows and red, dashed, double-headed arrow indicate the direction of the crossed polarizers and the rubbing direction, respectively. The fraction of ethyl orange aqueous microdroplets in the 8CB film was 20 wt %, and the concentration of ethly orange in the aqueous microdroplets was 8.4 mM. The fraction of oil blue-doped 8CB microdroplets in the water droplets was 20 wt %, and the concentration of oil blue in the 8CB microdroplets was 3 mM. Both ethyl orange aqueous microdroplets encapsulated in the 8CB film and the oil blue-doped 8CB microdroplets encapsulated in the water droplet were diluted 10 times using 8CB and water before photographing, respectively. The SDS concentration of the aqueous microdroplets encapsulated in the LC film and in the impacting droplet was 5 mM.

FIGS. 15A-15B show the hydrodyamic shear-induced mass transport from a nematic LC film to a water droplet on the surface (FIG. 15A) and corresponding plot showing the concentration of ethyl orange transferred to the water droplet on the nematic 8CB film as a function of the number of cycles (FIG. 15B). Each set of cycles (e.g. 5, 10, 15, etc.) was done with a different water droplet as part of the water droplet needed to be removed for testing. The temperature was set at 37° C. to create a nematic 8CB film. The volume of the water droplet on the 8CB film was 25 L. The fraction of ethyl orange aqueous microdroplets in the nematic 8CB film was 20 wt %, and the concentration of ethly orange in the aqueous microdroplets was 8.4 mM. The SDS concentration in the aqueous microdroplets was 5 mM. Error bars represent standard deviations from three independent measurements.

FIGS. 16A-16B show the percentage of mass transport across a water-nematic LC interface; (FIG. 16A) for ethyl orange transferred from the nematic 8CB film to an impacting water droplet and (FIG. 16B) the percentage of oil blue transferred from an impacting droplet to the nematic 8CB film as a function of time. The temperature was set at 37° C. to create a nematic 8CB film. The volume of the impacting water droplet was 20 μL. The size of the LC film was 1 cm×1 cm×240 μm. The fraction of oil blue-doped nematic 8CB microdroplets in the impacting water droplet was 20 wt %, and the concentration of oil blue in the nematic 8CB microdroplets was 3 mM. The fraction of ethyl orange aqueous microdroplets in the nematic 8CB film was 20 wt %, and the concentration of ethly orange in the aqueous microdroplets was 8.4 mM. The SDS concentration in the aqueous microdroplets encapsulated in the 8CB film and the impacting droplet was 5 mM. Error bars represent standard deviations from three independent measurements.

FIGS. 17A-17C show photographs and size distributions of encapsulated ethyl orange aqueous microdroplets in (FIGS. 17A, 17C) nematic (37° C.) and (FIGS. 17B, 17C) isotropic (47° C.) 8CB films. The microdroplet size distribution was measured five minutes after the microdroplets were prepared. Scale bars, 20 μm. The fraction of ethyl orange aqueous microdroplets in the 8CB was 20 wt %, and the concentration of ethly orange in the aqueous microdroplets was 8.4 mM. The ethyl orange aqueous microdroplets encapsulated in the LC films were diluted 10 times using pure 8CB before photographing.

FIGS. 18A-18C Colloidal stability of LC microdroplets in a water droplet. Photographs and size distributions of oil blue-doped 8CB microdroplets in water droplets in (FIGS. 18A, 18C) nematic (37° C.) and (FIGS. 18B, 18C) isotropic (47° C.) LC phase. The microdroplet size distribution was measured five minutes after the microdroplets were prepared. Scale bars, 20 μm. The fraction of oil blue-doped 8CB microdroplets in the water droplet was 20 wt %, and the concentration of oil blue in the 8CB microdroplets was 3 mM. The SDS concentration in the aqueous solution was 5 mM. The oil blue-doped 8CB microdroplets in the water droplets were diluted 10 times using a 5 mM SDS aqueous solution before photographing.

FIG. 19A shows Droplet impact-activated release of materials that are conventionally unable to be printed using inkjet. Right: regime map for state-of-the-art inkjet printing

FIG. 19B shows Control of the number of microcapsules released using droplet impacts with different We.

FIG. 19C shows Spatially patterned encapsulation of microcapsules in LC substrates;

FIG. 19D shows chemical reactions activated by droplet impacts.

FIG. 19E shows curing of reactive LC substrate or peeling-off of free-standing device after printing.

FIG. 20 shows a schematic of the inkjet printing process.

FIGS. 21A-21B show a regime map for droplet impact outcomes on simple fluids (FIG. 21A) 45 and effect of viscosity on the regime map (FIG. 21B).⁴⁶

FIG. 22 shows a schematic of the molecular order in the nematic and isotropic phases.

FIG. 23 shows a schematic of droplet sliding on a tilted surface.

FIGS. 24A-24C show optical micrograph of an aqueous microcapsule containing a red tracer in a nematic LC with a reconstructed LC director profile (FIG. 24A); a schematic of the dispersion of microcapsules in an LC bulk that is contained in a millimeter-sized well and submerged under a bulk aqueous phase (FIG. 24B); and sequential photographs of the release of microcapsules from the LC in the well upon subsequent LC phase transitions (FIG. 24C).

FIG. 25A shows stabilization of LC films against dewetting by water droplets using a porous polyRM257 network.

FIG. 25B shows a polarized light micrograph (top view) and a schematic illustration demonstrating the LC orientation (side view; not scaled to actual size) of a nematic 8CB film. Scale bar, 200 μm. Inset is a conoscopic image confirming the homeotropic alignment of 8CB at the interface between the 8CB and both air and the polyRM257-coated substrate. Crossed double-headed arrows indicate the orientations of the crossed polarizers.³⁷

FIGS. 26A-26C show a schematic of an LC-based open surface consisting of an LC film-infused porous polymeric network coated on a silane-functionalized glass substrate (FIG. 26A), a representative SEM image of the porous polyRM257 network without the infused LC (FIG. 26B) with a scale bar, 2 μm; and molecular structure of 5CB and polyRM257 (FIG. 25C).

FIG. 27A shows a schematic of droplet impact on a pure LC substrate.

FIGS. 27B-27D show time evolution of a 10 μL water droplet impacting on nematic 5CB surfaces at We of 134 (FIG. 27B), 212 (FIG. 27C), and 424 (FIG. 27D).

FIGS. 28A-28C show plots and corresponding photographs showing the release of ethyl orange-containing aqueous microcapsules from nematic (FIG. 28A) and isotropic (FIG. 28B) 5CB films to a 10 μL water droplet with different We. Scale bars, 0.5 mm.; and (FIG. 28C) a plot showing the release of ethyl orange from a nematic 5CB film to a 10 μL water droplet as a function of We.

FIG. 29 shows exemplary molecular structure of LCs.

FIGS. 30A-30B show schematics of the hydrostatic pressures experienced by the hemispheres of a microcapsule and all the interactions between the microcapsule and a water droplet (FIG. 30A); and the interaction between a microcapsule and water droplet (FIG. 30B). R₁ and R₂ are the two principal radii of curvature.

FIG. 31 shows thermoset polymer synthesis by droplet impact on LC surfaces.

FIG. 32 shows UV curing of reactive LCs.

### DETAILED SPECIFICATION

The compositions, methods, and devices described herein may be understood more readily by reference to the following detailed description of specific aspects of the disclosed subject matter and the Examples included therein.

Before the present compositions, methods, and devices are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification, the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

A new framework is propsoed to broaden the selection of printable inks and potential applications. Specifically, the ink within a substrate is encapsulated consisting of a responsive liquid and uses droplet impacts to activate ink release to the top surface, thus “printing”. The responsive liquid layer is then easily removed to obtain free-standing (i.e., substrate-free) printed products or solidified to serve as the substrate for the final product. Controlled ink release by droplet impact on simple fluid-based receiving substrates has not been achieved because the ink is released immediately upon droplet impact without proper interactions between the ink and the simple fluids to trap ink. In contrast, liquid crystals (LCs), a set of structured and anisotropic fluids, introduce intricate interparticle interactions with the encapsulated immiscible chemicals in the bulk LC because of their intrinsic long-range elasticity, which can be disrupted by external stimuli such as heat and light to trigger the release of chemicals. 37-39 It is found that droplet impact-induced shear stresses cause a structural change in the LC and disrupt the interparticle interactions acting on the ink in the LC, which enables the ‘printing’ of ink with a wide range of viscosities pre-encapsulated in the LC-based receiving substrate. The effect of droplet impacts on the release of pre-encapsulated immiscible micrometer-sized capsules (microcapsules) from a LC film are described herein and shown in the following examples.

Disclosed herein are methods and systems for printing onto a liquid crystal-infused porous surface. An exemplary method for printing comprises dispensing an aqueous droplet from a source and impacting of the aqueous droplet onto a top surface of a receiving substrate. In some aspects, the receiving substrate comprises a first printing material, wherein an impact of the aqueous droplet causes the first printing material to transfer from the receiving substrate to the aqueous droplet.

In the exemplary method, the receiving substrate includes a supporting substrate; a porous polymer layer having a surface, wherein the porous polymer layer comprises a continuous phase permeated by a plurality of pores, and wherein the continuous phase comprises a liquid crystal polymer; and an anisotropic lubricant infused within and over the porous polymer layer, such that that the anisotropic lubricant at least partially fills the plurality of pores and forms a film on the surface of the porous polymer layer. In some aspects, the anisotropic lubricant comprises thermotropic liquid crystal mesogen and the first printing material.

In some aspects, the liquid crystal-infused porous surface is disposed on a supporting substrate. Examples of suitable supporting substrates include, but are not limited to, polymers (e.g., porous polymers), glass fibers, glass, quartz, silicon, nitrides (e.g., silicon nitride), a ceramic, a fabric (e.g., cotton), a rubber, a metal (e.g., aluminum foil, steel, tin), a cellulosic substrate (e.g., wood), and combinations thereof. In some examples, the supporting substrate comprises glass.

In some aspects, the liquid crystal polymer includes any suitable liquid crystal polymer. For examples, the liquid crystal polymer is derived from 1,4-Bis-[4-(3-acryloyloxypropyloxy)benzoyloxy]-2-methylbenzene (RM257), 4-(6-acryloxy-hex-1-yl-oxy) phenyl 4-(hexyloxy)benzoate, 4-methoxybenzoic acid 4-(6-acryloyloxyhexyloxy) phenyl ester 4″-acryloyloxybutyl 2,5-di(4′-butyloxybenzoyloxy)benzoate, or combinations thereof. In some examples, the liquid crystal polymer can be derived from 1,4-Bis-[4-(3-acryloyloxypropyloxy)benzoyloxy]-2-methylbenzene (RM257).

In some examples, the porous polymer layer infused with the anisotropic lubricant has an average thickness of 100 nanometers (nm) or more (e.g., 110 nm or more, 120 nm or more, 130 nm or more, 140 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 μm or more, 3 μm or more, 4 μm or more, 5 μm or more, 10 μm or more, 15 μm or more, 20 μm or more, 25 μm or more, 30 μm or more, 40 μm or more, 50 μm or more, 75 μm or more, 100 μm or more, 125 μm or more, 150 μm or more, 175 μm or more, 200 μm or more, 250 μm or more, 300 μm or more, 350 μm or more, 400 μm or more, 450 μm or more, 500 μm or more, 600 μm or more, 700 μm or more, 800 μm or more, or 900 μm or more). In some examples, the porous polymer layer infused with the anisotropic lubricant has an average thickness of 1 millimeter (mm) or less (e.g., 900 μm or less, 800 μm or less, 700 μm or less, 600 μm or less, 500 μm or less, 450 μm or less, 400 μm or less, 350 μm or less, 300 μm or less, 250 μm or less, 200 μm or less, 150 μm or less, 125 μm or less, 100 μm or less, 75 μm or less, 50 μm or less, 40 μm or less, 30 μm or less, 25 μm or less, 20 μm or less, 15 μm or less, 10 μm or less, 5 μm or less, 4 μm or less, 3 μm or less, 2 μm or less, 1 μm or less, 900 nm or less, 800 nm or less, 700 nm or less, 600 nm or less, 500 nm or less, 450 nm or less, 400 nm or less, 350 nm or less, 300 nm or less, 275 nm or less, 250 nm or less, 225 nm or less, 200 nm or less, 190 nm or less, 180 nm or less, 170 nm or less, 160 nm or less, 150 nm or less, 140 nm or less, 130 nm or less, 120 nm or less, or 110 nm or less).

The average thickness of the porous polymer layer infused with the anisotropic lubricant can range from any of the minimum values described above to any of the maximum values described above. For example, the porous polymer layer infused with the anisotropic lubricant can have an average thickness of from 100 nm to 1 mm (e.g., from 100 nm to 10 μm, from 10 μm to 1 mm, from 100 nm to 1 μm, from 1 μm to 10 μm, from 10 μm to 100 μm, from 100 μm to 1 mm, from 100 nm to 900 μm, from 110 nm to 1 mm, from 110 nm to 900 μm, from 500 nm to 500 μm, from 750 nm to 500 μm, from 1 μm to 500 μm, from 1 μm to 250 μm, or from 150 μm to 175 μm). In some examples, the porous polymer layer infused with the anisotropic lubricant has an average thickness of 160 μm. The average thickness of the porous polymer layer infused with the anisotropic lubricant can be measured using methods known in the art, such as microscopy (e.g., optical microscopy, electron microscopy, etc.).

The porous polymer layer can, for example, have a porosity (e.g., pore volume percentage) of greater than 0% (e.g., 1% or more, 2% or more, 3% or more, 4% or more, 5% or more, 10% or more, 15% or more, 20% or more, 25% or more, 30% or more, 35% or more, 40% or more, 45% or more, 50% or more, 55% or more, 60% or more, 65% or more, 70% or more, 75% or more, 80% or more, 85% or more, or 90% or more). In some examples, the porous polymer layer can have a porosity of 95% or less (e.g., 90% or less, 85% or less, 80% or less, 75% or less, 70% or less, 65% or less, 60% or less, 55% or less, 50% or less, 45% or less, 40% or less, 35% or less, 30% or less, 25% or less, 20% or less, 15% or less, 10% or less, or 5% or less). The porosity of the porous polymer layer can range from any of the minimum values described above to any of the maximum values described above. For example, the porous polymer layer can have a porosity of from greater than 0% to 95% (e.g., from greater than 0% to 50%, from 50% to 95%, from greater than 0% to 30%, from 30% to 60%, from 60% to 95%, from 5% to 95%, from greater than 0% to 90%, or from 5% to 90%).

The film of the anisotropic lubricant can, for example, have an average thickness of 500 nm or more (e.g., 600 nm or more, 700 nm or more, 800 nm or more, 900 nm or more, 1 micrometer (micron, μm) or more, 2 μm or more, 3 μm or more, 4 μm or more, 5 μm or more, 10 μm or more, 15 μm or more, 20 μm or more, 25 μm or more, 30 μm or more, 40 μm or more, 50 μm or more, 75 μm or more, 100 μm or more, 125 μm or more, 150 μm or more, 175 μm or more, 200 μm or more, 250 μm or more, 300 μm or more, 350 μm or more, 400 μm or more, 450 μm or more, 500 μm or more, 600 μm or more, 700 μm or more, 800 μm or more, 900 μm or more, 1 millimeter (mm) or more, 2 mm or more, 3 mm or more, 4 mm or more, 5 mm or more, 10 mm or more, 15 mm or more, 20 mm or more, 25 mm or more, 30 mm or more, 40 mm or more, 50 mm or more, 75 mm or more, 100 mm or more, 125 mm or more, 150 mm or more, 200 mm or more, 250 mm or more, 300 mm or more, 350 mm or more, 400 mm or more, or 450 mm or more). In some examples, the film of the anisotropic lubricant can have an average thickness of 500 millimeters (mm) or less (e.g., 450 mm or less, 400 mm or less, 350 mm or less, 300 mm or less, 250 mm or less, 200 mm or less, 150 mm or less, 125 mm or less, 100 mm or less, 75 mm or less, 50 mm or less, 40 mm or less, 30 mm or less, 25 mm or less, 20 mm or less, 15 mm or less, 10 mm or less, 5 mm or less, 4 mm or less, 3 mm or less, 2 mm or less, 1 mm or less, 900 μm or less, 800 μm or less, 700 μm or less, 600 μm or less, 500 μm or less, 450 μm or less, 400 μm or less, 350 μm or less, 300 μm or less, 250 μm or less, 200 μm or less, 150 μm or less, 125 μm or less, 100 μm or less, 75 μm or less, 50 μm or less, 40 μm or less, 30 μm or less, 25 μm or less, 20 μm or less, 15 μm or less, 10 μm or less, 5 μm or less, 4 μm or less, 3 μm or less, 2 μm or less, 1 μm or less, 900 nm or less, 800 nm or less, 700 nm or less, or 600 nm or less). The average thickness of the film of anisotropic lubricant can range from any of the minimum values described above to any of the maximum values described above. For example, the film of the anisotropic lubricant can have an average thickness of from 500 nm to 500 mm (e.g., from 500 nm to 1 μm, from 1 μm to 500 μm, from 500 μm to 1 mm, from 1 mm to 500 mm, from 500 nm to 400 mm, from 600 nm to 500 mm, from 600 nm to 500 mm, from 500 nm to 250 mm, from 500 nm to 1 mm, from 500 nm to 750 μm, from 500 nm to 500 μm, from 750 nm to 500 μm, from 1 μm to 500 μm, from 1 μm to 250 μm, or from 100 μm to 150 μm). In some examples, the film of the anisotropic lubricant can have an average thickness of 130 μm. The average thickness of the film of the anisotropic lubricant can be measured using methods known in the art, such as microscopy (e.g., optical microscopy, fluorescence microscopy, etc.) or by measuring weight of the anisotropic lubricant and then dividing by the mass density of the anisotropic lubricant and the total surface area.

In some aspects, the thermotropic liquid crystal mesogen can include any suitable thermotropic liquid crystal mesogen. For example, the thermotropic liquid crystal mesogen comprises 4-cyano-4′-n-pentyl-biphenyl (5CB), 4-cyano-4′-n-heptyl-biphenyl (7CB), 4′-octyl-4-biphenylcarbonitrile (8CB), 4-cyano-4′-oxyoctyl-biphenyl (8OCB), 4-cyano-4′-n-pentyl-terphenyl (5CT), E7 (a nematic liquid crystal mixture containing cyanobiphenyl and cyanoterphenol components commercially available from Merck), (S)-4-Cyano-4′-(2-methylbutyl) biphenyl (CB15), or a combination thereof. In some examples, the thermotropic liquid crystal mesogen comprises 8CB.

In some examples, the anisotropic lubricant can include the thermotropic liquid crystal mesogen and can further comprise a dopant. For example, the anisotropic lubricant cam include the thermotropic liquid crystal mesogen and can further comprise a chiral dopant, such that the liquid crystal comprises a chiral liquid crystal. Examples of chiral dopants include, but are not limited to, 4-(1-methylheptyloxycarbonyl)phenyl-4-hexyloxybenzoate (S-811/R-811).

The thermotropic liquid crystal mesogen, in some aspects, has: a crystal mesophase when the thermotropic liquid crystal mesogen is at a temperature that is less than a first transition temperature, wherein when the thermotropic liquid crystal mesogen is in the crystal mesophase the thermotropic liquid crystal mesogen has long range orientational order and three dimensional positional order; a smectic mesophase when the thermotropic liquid crystal mesogen is at a temperature greater than the first transition temperature and less than a second transition temperature, wherein the second transition temperature is greater than the first transition temperature, and wherein the smectic mesophase has long range orientational order and at least unidirectional positional order; a nematic mesophase when the thermotropic liquid crystal mesogen is at a temperature greater than the second transition temperature and less than a third transition temperature, wherein the third transition temperature is greater than the second transition temperature, and wherein the nematic mesophase has long range orientational order and no positional order; and an isotropic mesophase when the thermotropic liquid crystal mesogen is at a temperature above a second transition temperature, and wherein the isotropic mesophase has no orientational order and no positional order.

In some aspects, the method further includes changing a temperature of the receiving substrate resulting in a mesophase change of the liquid crystal mesogen. A temperature change of the receiving substrate may result in a change from a crystal mesophase to a smectic mesophase, from a smectic mesophase to a nematic mesophase, from a nematic mesophase to a isotropic mesophase, from an isotropic mesophase to a nematic mesophase, from a nematic mesophase to a smectic mesophase, or from a smectic mesophase to a crystal mesophase. It is contemplated that the temperature of the receiving substrate may be changed before dispensing an aqueous droplet or after one or more aqueous droplets are dispensed. Changing the temperature of the receiving substrate may be carried out to affect the resulting printed material.

In some aspects, the first printing material includes a microparticle in an aqueous solution. In some aspects, the first printing material is present as an emulsion in the anisotropic lubricant or as a plurality of droplets in the anisotropic lubricant.

The plurality of droplets can, for example, have an average diameter of 1 nm or more (e.g., 2 nm or more, 3 nm or more, 4 nm or more, 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 μm or more, 3 μm or more, 4 μm or more, 5 μm or more, 10 μm or more, 15 μm or more, 20 μm or more, 25 μm or more, 30 μm or more, 35 μm or more, 40 μm or more, 45 μm or more, 50 μm or more, 60 μm or more, 70 μm or more, 80 μm or more, or 90 μm or more). In some examples, the plurality of droplets can have an average diameter of 100 μm or less (e.g., 90 μm or less, 80 μm or less, 70 μm or less, 60 μm or less, 50 μm or less, 45 μm or less, 40 μm or less, 35 μm or less, 30 μm or less, 25 μm or less, 20 μm or less, 15 μm or less, 10 μm or less, 5 μm or less, 4 μm or less, 3 μm or less, 2 μm or less, 1 μm or less, 900 nm or less, 800 nm or less, 700 nm or less, 600 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 5 nm or less, 4 nm or less, 3 nm or less, or 2 nm or less). The average diameter of the plurality of droplets can range from any of the minimum values described above to any of the maximum values described above. For example, the plurality of droplets can have an average diameter of from 1 nm to 100 μm (e.g., from 1 nm to 100 nm, from 100 nm to 100 μm, from 1 nm to 10 nm, from 10 nm to 100 nm, from 100 nm to 1 μm, from 1 μm to 10 μm, from 10 μm to 100 μm, from 1 nm to 90 μm, from 10 nm to 100 μm, or from 10 nm to 90 μm).

In some aspects, the receiving substrate includes up to 40% by volume of the first printing material.

In some aspects, the receiving substrate includes a second printing material, wherein the receiving substrate comprises up to 40% by volume of the first and second printing material.

In some aspects, the first or second printing material includes one or more of a polymer, a biologic material, a dye, a salt, a surfactant, an ionic liquid, or a colloidal dispersion of inorganic, organic, or metallic molecules, or combinations thereof.

For example, the first or second printing material includes an organic species, a photocatalyst, a heavy metal ion capture species, a medicament, a drug, or a combination thereof. In some examples, the printing materials include an organic species and the organic species comprises an organic contaminant. In some examples, the printing materials include an organic species and organic species comprises a water soluble dye. Examples of water soluble dyes include, but are not limited to, ethyl orange, rhodamine B, methyl orange, methylene blue, and combinations thereof. In some examples, the printing materials include a plurality of particles comprising a photocatalyst. In some examples, the photocatalyst comprises TiO₂, ZnO, CdS, WO₂, derivatives thereof, and combinations thereof. In some examples, the printing materials include a heavy metal ion capture species comprising S²⁻.

It is contemplated that various properties of the aqueous droplet are varied to affect the Weber number (We) on impact with the receiving substrate. For example, an aqueous droplet density, a height of the source from the top surface of the receiving substrate, or a diameter of droplet of the aqueous droplet are varied to achieve an optimal We.

In some aspects, the optimal Weber number is 10 to 200 (e.g. 20 to 200, 30 to 200, 40 to 200, 50 to 200, 60 to 200, 70 to 200, 80 to 200, 90 to 200, 100 to 200, 110 to 200, 120 to 200, 130 to 200, 140 to 200, 150 to 200, 160 to 200, 170 to 200, 180 to 200, 190 to 200, 10 to 190, 10 to 190, 20 to 190, 30 to 190, 40 to 190, 50 to 190, 60 to 190, 70 to 190, 80 to 190, 90 to 190, 100 to 190, 110 to 190, 120 to 190, 130 to 190, 140 to 190, 150 to 190, 160 to 190, 170 to 190, 180 to 190, 10 to 180, 20 to 180, 30 to 180, 40 to 180, 50 to 180, 60 to 180, 70 to 180, 80 to 180, 90 to 180, 100 to 180, 110 to 180, 120 to 180, 130 to 180, 140 to 180, 150 to 180, 160 to 180, 170 to 180, 10 to 170, 20 to 170, 30 to 170, 40 to 170, 50 to 170, 60 to 170, 70 to 170, 80 to 170, 90 to 170, 100 to 170, 110 to 170, 120 to 170, 130 to 170, 140 to 170, 150 to 170, 160 to 170, 10 to 160, 20 to 160, 30 to 160, 40 to 160, 50 to 160, 60 to 160, 70 to 160, 80 to 160, 90 to 160, 100 to 160, 110 to 160, 120 to 160, 130 to 160, 140 to 160, 150 to 160, 10 to 150, 20 to 150, 30 to 150, 40 to 150, 50 to 150, 60 to 150, 70 to 150, 80 to 150, 90 to 150, 100 to 150, 110 to 150, 120 to 150, 130 to 150, 140 to 150, 10 to 140, 20 to 140, 30 to 140, 40 to 140, 50 to 140, 60 to 140, 70 to 140, 80 to 140, 90 to 140, 100 to 140, 110 to 140, 120 to 140, 130 to 140, 10 to 130, 20 to 130, 30 to 130, 40 to 130, 50 to 130, 60 to 130, 70 to 130, 80 to 130, 90 to 130, 100 to 130, 110 to 130, 120 to 130, 10 to 120, 20 to 120, 30 to 120, 40 to 120, 50 to 120, 60 to 120, 70 to 120, 80 to 120, 90 to 120, 100 to 120, 110 to 120, 10 to 110, 20 to 110, 30 to 110, 40 to 110, 50 to 110, 60 to 110, 70 to 110, 80 to 110, 90 to 110, 100 to 110, 10 to 100, 20 to 100, 30 to 100, 40 to 100, 50 to 100, 60 to 100, 70 to 100, 80 to 100, 90 to 100, 10 to 90, 20 to 90, 30 to 90, 40 to 90, 50 to 90, 60 to 90, 70 to 90, 80 to 90, 10 to 80, 20 to 80, 30 to 80, 40 to 80, 50 to 80, 60 to 80, 70 to 80, 10 to 70, 20 to 70, 30 to 70, 40 to 70, 50 to 70, 60 to 70, 10 to 60, 20 to 60, 30 to 60, 40 to 60, 50 to 60, 10 to 50, 20 to 50, 30 to 50, 40 to 50, 10 to 40, 20 to 40, 30 to 40, 10 to 30, 20 to 30, or 10 to 20).

The aqueous droplet can, for example, have a volume of 0.01 microliters (μL) or more (e.g., 0.02 μL or more, 0.03 μL or more, 0.04 μL or more, 0.05 μL or more, 0.075 μL or more, 0.1 μL or more, 0.2 μL or more, 0.3 μL or more, 0.4 μL or more, 0.5 μL or more, 0.75 μL or more, 1 μL or more, 1.25 μL or more, 1.5 μL or more, 1.75 μL or more, 2 μL or more, 2.5 λL or more, 3 μL or more, 3.5 μL or more, 4 μL or more, 4.5 μL or more, 5 μL or more, 6 μL or more, 7 μL or more, 8 μL or more, 9 μL or more, 10 μL or more, 11 μL or more, 12 μL or more, 13 μL or more, 14 μL or more, 15 μL or more, 20 μL or more, 25 μL or more, 30 μL or more, 35 μL or more, 40 μL or more, 45 μL or more, 50 μL or more, 60 μL or more, 70 μL or more, 80 μL or more, 90 μL or more, 100 μL or more, 125 μL or more, 150 μL or more, 175 μL or more, 200 μL or more, 250 μL or more, 300 μL or more, 350 μL or more, 400 μL or more, 450 μL or more, 500 μL or more, 600 μL or more, 700 μL or more, 800 μL or more, 900 μL or more). In some examples, the aqueous droplet can have a volume of 1 milliliters (mL) or less (e.g., 1 mL or less, 900 μL or less, 800 μL or less, 700 μL or less, 600 μL or less, 500 μL or less, 450 μL or less, 400 μL or less, 350 μL or less, 300 μL or less, 250 μL or less, 200 μL or less, 175 μL or less, 150 μL or less, 125 μL or less, 100 μL or less, 90 μL or less, 80 μL or less, 70 μL or less, 60 μL or less, 50 μL or less, 45 μL or less, 40 μL or less, 35 μL or less, 30 μL or less, 25 μL or less, 20 μL or less, 15 μL or less, 14 μL or less, 13 μL or less, 12 μL or less, 11 μL or less, 10 μL or less, 9 μL or less, 8 μL or less, 7 μL or less, 6 μL or less, 5 μL or less, 4.5 μL or less, 4 μL or less, 3.5 μL or less, 3 μL or less, 2.5 μL or less, 2 μL or less, 1.75 μL or less, 1.5 μL or less, 1.25 μL or less, 1 μL or less, 0.75 μL or less, 0.5 μL or less, 0.25 μL or less, 0.1 μL or less, 0.075 μL or less or 0.05 μL or less). The volume of the aqueous droplet can range from any of the minimum values described above to any of the maximum values described above. For example, the aqueous droplet can have a volume of from 0.01 μL to 1 mL (e.g., from 0.01 μL to 10 μL, from 10 μL to 1 mL, from 0.01 μL to 1 μL, from 1 μL to 10 μL, from 10 μL to 100 μL, or from 100 μL to 1 mL). In some examples, the aqueous droplet can have a volume of 1 nanoliters (nL).

In some aspects, the first printing material has a viscosity of 1 cP to 10⁶ cP (e.g. 5 cP to 10⁶ cP, 10 cP to 10⁶ cP, 50 cP to 10⁶ cP, 10⁰ cP to 10⁶ cP, 500 cP to 10⁶ cP, 10³ cP to 10⁶ cP, 10⁴ cP to 10⁶ cP, 10⁵ cP to 10⁶ cP, 1 cP to 10⁵ cP, 5 cP to 10⁵ cP, 10 cP to 10⁵ cP, 50 cP to 10⁵ cP, 10⁰ cP to 10⁵ cP, 500 cP to 10⁵ cP, 10³ cP to 10⁵ cP, 10⁴ cP to 10⁵ cP, 1 cP to 10⁴ cP, 5 cP to 10⁴ cP, 10 cP to 10⁴ cP, 50 cP to 10⁴ cP, 10⁰ cP to 10⁴ cP, 500 cP to 10⁴ cP, 10³ cP to 10⁴ cP, 1 cP to 10³ cP, 5 cP to 10³ cP, 10 cP to 10³ cP, 50 cP to 10³ cP, 10⁰ cP to 10³ cP, 500 cP to 10³ cP, 1 cP to 500 cP, 5 cP to 500 cP, 10 cP to 500 cP, 50 cP to 500 cP, 100 cP to 500 cP, 1 cP to 100 cP, 5 cP to 100 cP, 10 cP to 100 cP, 50 cP to 100 cP, 1 cP to 50 cP, 5 cP to 50 cP, 10 cP to 50 cP, 1 cP to 10 cP, 5 cP to 10 cP, or 1 cP to 5 cP.

In some aspects, the aqueous droplet includes one or more activating or reactive species, wherein an activating or reactive species is activating and/or reactive with the first printing material. In some examples, an activating or reactive species may be a polymer curing agent, an ionic salt, a catalyst, or other species that activates or reacts with the first printing material to form the target.

In some aspects, the source of the aqueous printing liquid is an ink jet printer.

Referring now to an exemplary system for printing. The system includes a receiving substrate comprising a first printing material (e.g. ink, chemical, etc); an aqueous printing liquid; and a device for dispensing said aqueous printing liquid as an aqueous droplet onto a top surface of the receiving substrate; wherein an impact of the aqueous droplet causes the first printing material to transfer from the receiving substrate to the aqueous droplet.

In some aspects, the receiving substrate of the system further includes a supporting substrate; a porous polymer layer having a surface, wherein the porous polymer layer includes a continuous phase permeated by a plurality of pores, and wherein the continuous phase includes a liquid crystal polymer; and an anisotropic lubricant infused within and over the porous polymer layer, such that that the anisotropic lubricant at least partially fills the plurality of pores and forms a film on the surface of the porous polymer layer, wherein the anisotropic lubricant includes thermotropic liquid crystal mesogen and the first printing material.

In some aspects of the exemplary system, the liquid crystal-infused porous surface is disposed on a supporting substrate. Examples of suitable supporting substrates include, but are not limited to, polymers (e.g., porous polymers), glass fibers, glass, quartz, silicon, nitrides (e.g., silicon nitride), a ceramic, a fabric (e.g., cotton), a rubber, a metal (e.g., aluminum foil, steel, tin), a cellulosic substrate (e.g., wood), and combinations thereof. In some examples, the supporting substrate comprises glass.

In some aspects of the exemplary system, the liquid crystal polymer can include any suitable liquid crystal polymer. For examples, the liquid crystal polymer is derived from 1,4-Bis-[4-(3-acryloyloxypropyloxy)benzoyloxy]-2-methylbenzene (RM257), 4-(6-acryloxy-hex-1-yl-oxy) phenyl 4-(hexyloxy)benzoate, 4-methoxybenzoic acid 4-(6-acryloyloxyhexyloxy) phenyl ester 4″-acryloyloxybutyl 2,5-di(4′-butyloxybenzoyloxy)benzoate, or combinations thereof. In some examples, the liquid crystal polymer can be derived from 1,4-Bis-[4-(3-acryloyloxypropyloxy)benzoyloxy]-2-methylbenzene (RM257).

In some examples of the exemplary system, the porous polymer layer infused with the anisotropic lubricant has an average thickness of 100 nanometers (nm) or more (e.g., 110 nm or more, 120 nm or more, 130 nm or more, 140 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 μm or more, 3 μm or more, 4 μm or more, 5 μm or more, 10 μm or more, 15 μm or more, 20 μm or more, 25 μm or more, 30 μm or more, 40 μm or more, 50 μm or more, 75 μm or more, 100 μm or more, 125 μm or more, 150 μm or more, 175 μm or more, 200 μm or more, 250 μm or more, 300 μm or more, 350 μm or more, 400 μm or more, 450 μm or more, 500 μm or more, 600 μm or more, 700 μm or more, 800 μm or more, or 900 μm or more). In some examples, the porous polymer layer infused with the anisotropic lubricant has an average thickness of 1 millimeter (mm) or less (e.g., 900 μm or less, 800 μm or less, 700 μm or less, 600 μm or less, 500 μm or less, 450 μm or less, 400 μm or less, 350 μm or less, 300 μm or less, 250 μm or less, 200 μm or less, 150 μm or less, 125 μm or less, 100 μm or less, 75 μm or less, 50 μm or less, 40 μm or less, 30 μm or less, 25 μm or less, 20 μm or less, 15 μm or less, 10 μm or less, 5 μm or less, 4 μm or less, 3 μm or less, 2 μm or less, 1 μm or less, 900 nm or less, 800 nm or less, 700 nm or less, 600 nm or less, 500 nm or less, 450 nm or less, 400 nm or less, 350 nm or less, 300 nm or less, 275 nm or less, 250 nm or less, 225 nm or less, 200 nm or less, 190 nm or less, 180 nm or less, 170 nm or less, 160 nm or less, 150 nm or less, 140 nm or less, 130 nm or less, 120 nm or less, or 110 nm or less).

The average thickness of the porous polymer layer infused with the anisotropic lubricant can range from any of the minimum values described above to any of the maximum values described above. For example, the porous polymer layer infused with the anisotropic lubricant can have an average thickness of from 100 nm to 1 mm (e.g., from 100 nm to 10 μm, from 10 μm to 1 mm, from 100 nm to 1 μm, from 1 μm to 10 μm, from 10 μm to 100 μm, from 100 μm to 1 mm, from 100 nm to 900 μm, from 110 nm to 1 mm, from 110 nm to 900 μm, from 500 nm to 500 μm, from 750 nm to 500 μm, from 1 μm to 500 μm, from 1 μm to 250 μm, or from 150 μm to 175 μm). In some examples, the porous polymer layer infused with the anisotropic lubricant has an average thickness of 160 μm. The average thickness of the porous polymer layer infused with the anisotropic lubricant can be measured using methods known in the art, such as microscopy (e.g., optical microscopy, electron microscopy, etc.).

The porous polymer layer can, for example, have a porosity (e.g., pore volume percentage) of greater than 0% (e.g., 1% or more, 2% or more, 3% or more, 4% or more, 5% or more, 10% or more, 15% or more, 20% or more, 25% or more, 30% or more, 35% or more, 40% or more, 45% or more, 50% or more, 55% or more, 60% or more, 65% or more, 70% or more, 75% or more, 80% or more, 85% or more, or 90% or more). In some examples, the porous polymer layer can have a porosity of 95% or less (e.g., 90% or less, 85% or less, 80% or less, 75% or less, 70% or less, 65% or less, 60% or less, 55% or less, 50% or less, 45% or less, 40% or less, 35% or less, 30% or less, 25% or less, 20% or less, 15% or less, 10% or less, or 5% or less). The porosity of the porous polymer layer can range from any of the minimum values described above to any of the maximum values described above. For example, the porous polymer layer can have a porosity of from greater than 0% to 95% (e.g., from greater than 0% to 50%, from 50% to 95%, from greater than 0% to 30%, from 30% to 60%, from 60% to 95%, from 5% to 95%, from greater than 0% to 90%, or from 5% to 90%).

The film of the anisotropic lubricant can, for example, have an average thickness of 500 nm or more (e.g., 600 nm or more, 700 nm or more, 800 nm or more, 900 nm or more, 1 micrometer (micron, μm) or more, 2 μm or more, 3 μm or more, 4 μm or more, 5 μm or more, 10 μm or more, 15 μm or more, 20 μm or more, 25 μm or more, 30 μm or more, 40 μm or more, 50 μm or more, 75 μm or more, 100 μm or more, 125 μm or more, 150 μm or more, 175 μm or more, 200 μm or more, 250 μm or more, 300 μm or more, 350 μm or more, 400 μm or more, 450 μm or more, 500 μm or more, 600 μm or more, 700 μm or more, 800 μm or more, 900 μm or more, 1 millimeter (mm) or more, 2 mm or more, 3 mm or more, 4 mm or more, 5 mm or more, 10 mm or more, 15 mm or more, 20 mm or more, 25 mm or more, 30 mm or more, 40 mm or more, 50 mm or more, 75 mm or more, 100 mm or more, 125 mm or more, 150 mm or more, 200 mm or more, 250 mm or more, 300 mm or more, 350 mm or more, 400 mm or more, or 450 mm or more). In some examples, the film of the anisotropic lubricant can have an average thickness of 500 millimeters (mm) or less (e.g., 450 mm or less, 400 mm or less, 350 mm or less, 300 mm or less, 250 mm or less, 200 mm or less, 150 mm or less, 125 mm or less, 100 mm or less, 75 mm or less, 50 mm or less, 40 mm or less, 30 mm or less, 25 mm or less, 20 mm or less, 15 mm or less, 10 mm or less, 5 mm or less, 4 mm or less, 3 mm or less, 2 mm or less, 1 mm or less, 900 μm or less, 800 μm or less, 700 μm or less, 600 μm or less, 500 μm or less, 450 μm or less, 400 μm or less, 350 μm or less, 300 μm or less, 250 μm or less, 200 μm or less, 150 μm or less, 125 μm or less, 100 μm or less, 75 μm or less, 50 μm or less, 40 μm or less, 30 μm or less, 25 μm or less, 20 μm or less, 15 μm or less, 10 μm or less, 5 μm or less, 4 μm or less, 3 μm or less, 2 μm or less, 1 μm or less, 900 nm or less, 800 nm or less, 700 nm or less, or 600 nm or less). The average thickness of the film of anisotropic lubricant can range from any of the minimum values described above to any of the maximum values described above. For example, the film of the anisotropic lubricant can have an average thickness of from 500 nm to 500 mm (e.g., from 500 nm to 1 μm, from 1 μm to 500 μm, from 500 μm to 1 mm, from 1 mm to 500 mm, from 500 nm to 400 mm, from 600 nm to 500 mm, from 600 nm to 500 mm, from 500 nm to 250 mm, from 500 nm to 1 mm, from 500 nm to 750 μm, from 500 nm to 500 μm, from 750 nm to 500 μm, from 1 μm to 500 μm, from 1 μm to 250 μm, or from 100 μm to 150 μm). In some examples, the film of the anisotropic lubricant can have an average thickness of 130 μm. The average thickness of the film of the anisotropic lubricant can be measured using methods known in the art, such as microscopy (e.g., optical microscopy, fluorescence microscopy, etc.) or by measuring weight of the anisotropic lubricant and then dividing by the mass density of the anisotropic lubricant and the total surface area.

In some aspects of the exemplary system, the thermotropic liquid crystal mesogen can include any suitable thermotropic liquid crystal mesogen. For example, the thermotropic liquid crystal mesogen comprises 4-cyano-4′-n-pentyl-biphenyl (5CB), 4-cyano-4′-n-heptyl-biphenyl (7CB), 4′-octyl-4-biphenylcarbonitrile (8CB), 4-cyano-4′-oxyoctyl-biphenyl (8OCB), 4-cyano-4′-n-pentyl-terphenyl (5CT), E7 (a nematic liquid crystal mixture containing cyanobiphenyl and cyanoterphenol components commercially available from Merck), (S)-4-Cyano-4′-(2-methylbutyl) biphenyl (CB15), or a combination thereof. In some examples, the thermotropic liquid crystal mesogen comprises 8CB.

In some aspects of the exemplary system, the anisotropic lubricant includes the thermotropic liquid crystal mesogen and can further comprise a dopant. For example, the anisotropic lubricant includes the thermotropic liquid crystal mesogen and can further include a chiral dopant, such that the liquid crystal includes a chiral liquid crystal. Examples of chiral dopants include, but are not limited to, 4-(1-methylheptyloxycarbonyl)phenyl-4-hexyloxybenzoate (S-811/R-811).

The thermotropic liquid crystal mesogen, in some aspects of the exemplary system, has: a crystal mesophase when the thermotropic liquid crystal mesogen is at a temperature that is less than a first transition temperature, wherein when the thermotropic liquid crystal mesogen is in the crystal mesophase the thermotropic liquid crystal mesogen has long range orientational order and three dimensional positional order; a smectic mesophase when the thermotropic liquid crystal mesogen is at a temperature greater than the first transition temperature and less than a second transition temperature, wherein the second transition temperature is greater than the first transition temperature, and wherein the smectic mesophase has long range orientational order and at least unidirectional positional order; a nematic mesophase when the thermotropic liquid crystal mesogen is at a temperature greater than the second transition temperature and less than a third transition temperature, wherein the third transition temperature is greater than the second transition temperature, and wherein the nematic mesophase has long range orientational order and no positional order; and an isotropic mesophase when the thermotropic liquid crystal mesogen is at a temperature above a second transition temperature, and wherein the isotropic mesophase has no orientational order and no positional order.

In some aspects of the exemplary system, the first printing material includes a microparticle in an aqueous solution. In some aspects, the first printing material is present as an emulsion in the anisotropic lubricant or as a plurality of droplets in the anisotropic lubricant.

The plurality of droplets can, for example, have an average diameter of 1 nm or more (e.g., 2 nm or more, 3 nm or more, 4 nm or more, 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 μm or more, 3 μm or more, 4 μm or more, 5 μm or more, 10 μm or more, 15 μm or more, 20 μm or more, 25 μm or more, 30 μm or more, 35 μm or more, 40 μm or more, 45 μm or more, 50 μm or more, 60 μm or more, 70 μm or more, 80 μm or more, or 90 μm or more).

In some examples, the plurality of droplets can have an average diameter of 100 μm or less (e.g., 90 μm or less, 80 μm or less, 70 μm or less, 60 μm or less, 50 μm or less, 45 μm or less, 40 μm or less, 35 μm or less, 30 μm or less, 25 μm or less, 20 μm or less, 15 μm or less, 10 μm or less, 5 μm or less, 4 μm or less, 3 μm or less, 2 μm or less, 1 μm or less, 900 nm or less, 800 nm or less, 700 nm or less, 600 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 5 nm or less, 4 nm or less, 3 nm or less, or 2 nm or less). The average diameter of the plurality of droplets can range from any of the minimum values described above to any of the maximum values described above. For example, the plurality of droplets can have an average diameter of from 1 nm to 100 μm (e.g., from 1 nm to 100 nm, from 100 nm to 100 μm, from 1 nm to 10 nm, from 10 nm to 100 nm, from 100 nm to 1 μm, from 1 μm to 10 μm, from 10 μm to 100 μm, from 1 nm to 90 μm, from 10 nm to 100 μm, or from 10 nm to 90 μm).

In some aspects of the exemplary system, the receiving substrate includes up to 40% by volume of the first printing material.

In some aspects of the exemplary system, the receiving substrate includes a second printing material, wherein the receiving substrate comprises up to 40% by volume of the first and second printing material.

In some aspects of the exemplary system, the first or second printing material includes one or more of a polymer, a biologic material, a dye, a salt, a surfactant, an ionic liquid, or a colloidal dispersion of inorganic, organic, or metallic molecules, or combinations thereof.

For example, the first or second printing material includes an organic species, a photocatalyst, a heavy metal ion capture species, a medicament, a drug, or a combination thereof. In some examples, the printing materials include an organic species and the organic species comprises an organic contaminant. In some examples, the printing materials include an organic species and organic species comprises a water soluble dye. Examples of water soluble dyes include, but are not limited to, ethyl orange, rhodamine B, methyl orange, methylene blue, and combinations thereof. In some examples, the printing materials include a plurality of particles comprising a photocatalyst. In some examples, the photocatalyst comprises TiO₂, ZnO, CdS, WO₂, derivatives thereof, and combinations thereof. In some examples, the printing materials include a heavy metal ion capture species including S²⁻.

The aqueous droplet can, for example, have a volume of 0.01 microliters (μL) or more (e.g., 0.02 μL or more, 0.03 μL or more, 0.04 μL or more, 0.05 μL or more, 0.075 μL or more, 0.1 μL or more, 0.2 μL or more, 0.3 μL or more, 0.4 μL or more, 0.5 μL or more, 0.75 μL or more, 1 μL or more, 1.25 μL or more, 1.5 μL or more, 1.75 μL or more, 2 μL or more, 2.5 μL or more, 3 μL or more, 3.5 μL or more, 4 μL or more, 4.5 μL or more, 5 μL or more, 6 μL or more, 7 μL or more, 8 μL or more, 9 μL or more, 10 μL or more, 11 μL or more, 12 μL or more, 13 μL or more, 14 μL or more, 15 μL or more, 20 μL or more, 25 μL or more, 30 μL or more, 35 μL or more, 40 μL or more, 45 μL or more, 50 μL or more, 60 μL or more, 70 μL or more, 80 μL or more, 90 μL or more, 100 μL or more, 125 μL or more, 150 μL or more, 175 μL or more, 200 μL or more, 250 μL or more, 300 μL or more, 350 μL or more, 400 μL or more, 450 μL or more, 500 μL or more, 600 μL or more, 700 μL or more, 800 μL or more, 900 μL or more). In some examples, the aqueous droplet can have a volume of 1 milliliters (mL) or less (e.g., 1 mL or less, 900 μL or less, 800 μL or less, 700 μL or less, 600 μL or less, 500 μL or less, 450 μL or less, 400 μL or less, 350 μL or less, 300 μL or less, 250 μL or less, 200 μL or less, 175 μL or less, 150 μL or less, 125 μL or less, 100 μL or less, 90 μL or less, 80 μL or less, 70 μL or less, 60 μL or less, 50 μL or less, 45 μL or less, 40 μL or less, 35 μL or less, 30 μL or less, 25 μL or less, 20 μL or less, 15 μL or less, 14 μL or less, 13 μL or less, 12 μL or less, 11 μL or less, 10 μL or less, 9 μL or less, 8 μL or less, 7 μL or less, 6 μL or less, 5 μL or less, 4.5 μL or less, 4 μL or less, 3.5 μL or less, 3 μL or less, 2.5 μL or less, 2 μL or less, 1.75 μL or less, 1.5 μL or less, 1.25 μL or less, 1 μL or less, 0.75 μL or less, 0.5 μL or less, 0.25 μL or less, 0.1 μL or less, 0.075 μL or less or 0.05 μL or less). The volume of the aqueous droplet can range from any of the minimum values described above to any of the maximum values described above. For example, the aqueous droplet can have a volume of from 0.01 μL to 1 mL (e.g., from 0.01 μL to 10 μL, from 10 μL to 1 mL, from 0.01 μL to 1 μL, from 1 μL to 10 μL, from 10 μL to 100 μL, or from 100 μL to 1 mL). In some examples, the aqueous droplet can have a volume of 1 nanoliters (nL).

In some aspects of the exemplary system, the first printing material has a viscosity of 1 cP to 10⁶ cP (e.g. 5 cP to 10⁶ cP, 10 cP to 10⁶ cP, 50 cP to 10⁶ cP, 100 cP to 10⁶ cP, 500 cP to 10⁶ cP, 10³ cP to 10⁶ cP, 10⁴ cP to 10⁶ cP, 10⁵ cP to 10⁶ cP, 1 cP to 10⁵ cP, 5 cP to 10⁵ cP, 10 cP to 10⁵ cP, 50 cP to 10⁵ cP, 100 cP to 10⁵ cP, 500 cP to 10⁵ cP, 10³ cP to 10⁵ cP, 10⁴ cP to 10⁵ cP, 1 cP to 10⁴ cP, 5 cP to 10⁴ cP, 10 cP to 10⁴ cP, 50 cP to 10⁴ cP, 100 cP to 10⁴ cP, 500 cP to 104 cP, 10³ cP to 10⁴ cP, 1 cP to 10³ cP, 5 cP to 10³ cP, 10 cP to 10³ cP, 50 cP to 10³ cP, 100 cP to 10³ cP, 500 cP to 10³ cP, 1 cP to 500 cP, 5 cP to 500 cP, 10 cP to 500 cP, 50 cP to 500 cP, 100 cP to 500 cP, 1 cP to 100 cP, 5 cP to 100 cP, 10 cP to 100 cP, 50 cP to 100 cP, 1 cP to 50 cP, 5 cP to 50 cP, 10 cP to 50 cP, 1 cP to 10 cP, 5 cP to 10 cP, or 1 cP to 5 cP.

In some aspects of the exemplary system, the aqueous droplet includes one or more activating or reactive species, wherein an activating or reactive species is activating and/or reactive with the first printing material. In some examples, an activating or reactive species may be a polymer curing agent, an ionic salt, a catalyst, or other species that activates or reacts with the first printing material to form the target.

In some aspects, the device for printing includes an ink jet printer.

A hydrogel material is disclosed as being produced by the exemplary system and method. The hydrogel material includes one or more bioactive and/or bioinert compounds, the hydrogel material having a discrete size and shape. The hydrogel material is formed by droplet-induced printing, wherein a receiving substrate comprises one or more hydrogel precursors, and wherein a printing liquid comprises an aqueous printing liquid dispensed from a source.

In some aspects, the receiving substrate of the system further includes a supporting substrate; a porous polymer layer having a surface, wherein the porous polymer layer comprises a continuous phase permeated by a plurality of pores, and wherein the continuous phase comprises a liquid crystal polymer; and an anisotropic lubricant infused within and over the porous polymer layer, such that that the anisotropic lubricant at least partially fills the plurality of pores and forms a film on the surface of the porous polymer layer, wherein the anisotropic lubricant comprises thermotropic liquid crystal mesogen and the first printing material.

In some aspects, the printing liquid further includes a bioinert or a bioactive material, for example bioglass.

In some aspects, the hydrogel product has a controllable thickness of 5 μm to 20 μm (e.g., from 7.5 μm to 20 μm, from 10 μm to 20 μm, from 12.5 μm to 20 μm, from 15 μm to 20 μm, from 17.5 μm to 20 μm, from 5 μm to 17.5 μm, from 7.5 μm to 17.5 μm, from 10 μm to 17.5 μm, from 12.5 μm to 17.5 μm, from 15 μm to 17.5 μm, from 5 μm to 15 μm, from 7.5 μm to 15 μm, from 10 μm to 15 μm, from 12.5 μm to 15 μm, from 5 μm to 12.5 μm, from 7.5 μm to 12.5 μm, from 10 μm to 12.5 μm, from 5 μm to 10 μm, from 7.5 μm to 10 μm, or from 5 μm to 7.5 μm).

In some aspects, the hydrogel product has a tensile strength of 0.25 MPa to 2.5 MPa (e.g. from 0.5 MPa to 2.5 MPa, from 0.75 MPa to 2.5 MPa, from 1.0 MPa to 2.5 MPa, from 1.5 MPa to 2.5 MPa, from 2.0 MPa to 2.5 MPa, from 0.25 MPa to 2.0 MPa, from 0.5 MPa to 2.0 MPa, from 0.75 MPa to 2.0 MPa, from 1.0 MPa to 2.0 MPa, from 1.5 MPa to 2.0 MPa, from 0.25 MPa to 1.5 MPa, from 0.5 MPa to 1.5 MPa, from 0.75 MPa to 1.5 MPa, from 1.0 MPa to 1.5 MPa, from 0.25 MPa to 1.0 MPa, from 0.5 MPa to 1.0 MPa, from 0.75 MPa to 1.0 MPa, from 0.25 MPa to 0.75 MPa, from 0.5 MPa to 0.75 MPa, or from 0.25 MPa to 0.5 MPa).

In some aspects, the hydrogel product shape is a disc shape or a ring shape. The product shape is controllable by variation of We, wherein at higher We, a disc shape is produced and at a lower We, a ring shape is produced. For example, in the production of algenate hydrogels on receiving substrate, a We of 80 produces a ring shape, and a We of 125 produces a disc shape.

In some aspects, the source of the aqueous printing liquid is an ink jet printer.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1. Programmable Liquid-Liquid Mass Transfer Via Droplet Impact

Abstract. Manipulation of liquid-liquid mass transfer, a crucial aspect in various physical, chemical and biological processes, remains challenging to achieve simultaneous control across scenarios involving no material exchange, unidirectional transfer, and bidirectional transfer. In this study, we report a novel approach employing droplet impact on liquid crystal (LC) films to manipulate mass transfer between water and LC. By manipulating LC mesophases (e.g., temperature) and droplet impact parameters (e.g., droplet release height), we not only control droplet impact regimes and dynamics but, more importantly, manipulate the directionality of water-LC mass transfer. Capitalizing on these distinctive characteristics, we demonstrate the efficacy of droplet impact on transferring highly viscous substances with dynamic viscosities up to 10⁵ cP, four orders of magnitude of the viscosity limit of printable inks in the state-of-the-art inkjet printing techniques. Furthermore, this method enables printing of hydrogels with precisely controlled composition, shapes and dimensions, as well as excellent mechanical properties, optical transparency, biointerface adhesion, and hemostatic capability. Overall, this research unveils a novel liquid-liquid mass transfer mechanism, expanding the range of printable inks for additive manufacturing.

Introduction. Liquid-liquid mass transfer involves the movement of substances between two liquid phases and is prevalent in physical,^{1,2} chemical, and biological processes. Scheme 1 categorizes scenarios, including no material transfer (Scenario 1), unidirectional material transfer (Scenario 2), and bidirectional material transfer (Scenario 3). Understanding and controlling liquid-liquid mass transfer is crucial for applications such as liquid-liquid printing, biomedical drug delivery, environmental water treatment, and energy storage devices like batteries and fuel cells. Previous techniques, such as liquid gating membranes, microfluidic systems, electro-coalescence, and acoustic techniques, have demonstrated varying degrees of effectiveness in manipulating liquid-liquid mass transfer dynamics. However, achieving on-demand and simple switching between all three distinct scenarios within a material system remains challenging due to inherent complexities, limited adaptability, and relatively slow response times.

Liquid droplet impact, a dynamic phenomenon involving the collision of a droplet with a solid surface or a liquid film, plays a critical role in various applications such as additive manufacturing, inkjet printing, combustion, agricultural spray, biological essay, pharmaceutical and food industry. Characterized by rapid and transient interactions, this process provides a unique platform to comprehend and manipulate the intricacies of liquid-liquid interfacial dynamics. While prior research has shown that droplet impact behaviors depend on parameters such as impact velocity and droplet size, liquid-liquid mass transfer activated by droplet impact has not yet been realized.

Mass transport is tuned based on the parameters in the Weber number of the impacting droplet (We=ρ_{w}ν²D/γw, in which ρ_{w} is the droplet density, vis the impact velocity, D is the water droplet diameter in the air, and γ_{w} is the surface tension of water). However, herein it is shown that the LC mesophase also affects the droplet impact behaviors including the bouncing regimes of the droplets on the LC films. It was observed that the mass transport from a LC film (in either nematic or smectic A phases) to the impacting water droplet depends on both the LC mesophase and the We. Interestingly, the mass transport from a nematic LC film was activated above a threshold We. In contrast, the mass transport from impacting water droplets to nematic or smectic A LC films only depended on the We. Guided by the above findings, the We and LC mesophase were independently manipulated to activate the water-to-LC and LC-to-water mass transport, which has never been achieved in systems of water-simple fluid (e.g., water-silicone oil) and water-isotropic LC interfaces. Because LC mesophases can be reversibly switched through a wide range of external stimuli, the results herein provide design principles for additive manufacturing and drug delivery.

In this study, droplet impact was employed to investigate mass transfer dynamics between water droplets and liquid crystal (LC) films, a responsive and structured fluid influenced by external stimuli, such as temperature. The observation of the intricacies of water droplet impact at LC interfaces that the droplet bouncing regimes are not only influenced by droplet properties but also by the LC mesophase. Subsequently, by encapsulating substances in the LC film, it was found that mass transfer between water and LC depends on both the LC mesophase and We. Remarkably, in the nematic phase, the manipulation of We enables the independent activation of water-to-LC and LC-to-water mass transfer, achieving all three mass transfer scenarios in Scheme 1—a phenomena unprecedented in simple fluid systems like water-silicone oil. Leveraging these characteristics, the transfer of highly viscous and shear-thickening substances was achieved through droplet impact, overcoming the limitations of printable inks in traditional inkjet printing techniques. Finally, the droplet impact-driven printing of hydrogels with precisely controlled composition, shapes, and dimensions, as well as excellent mechanical properties, optical transparency, biointerface adhesion, and hemostatic capability were demonstrated. Overall, droplet impact on LC films reveals a novel mechanism for liquid-liquid mass transfer in additive manufacturing.

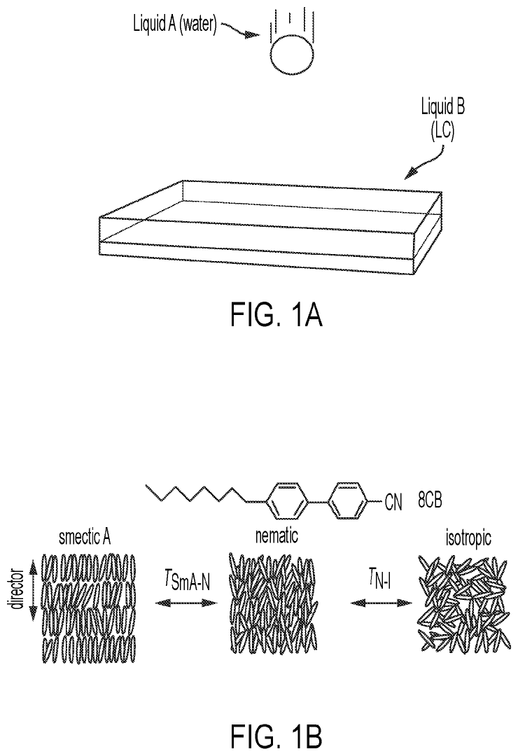

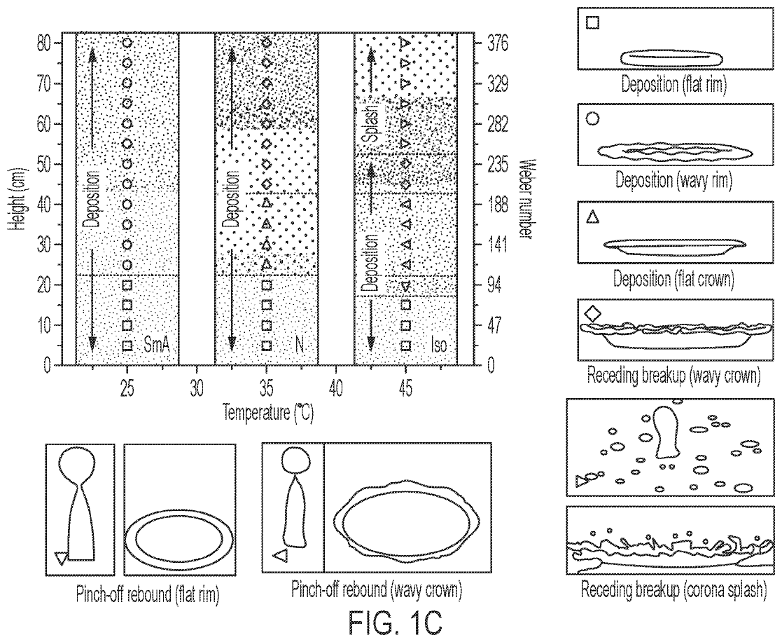

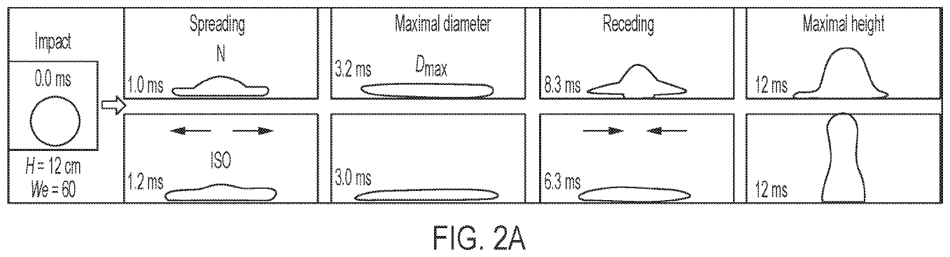

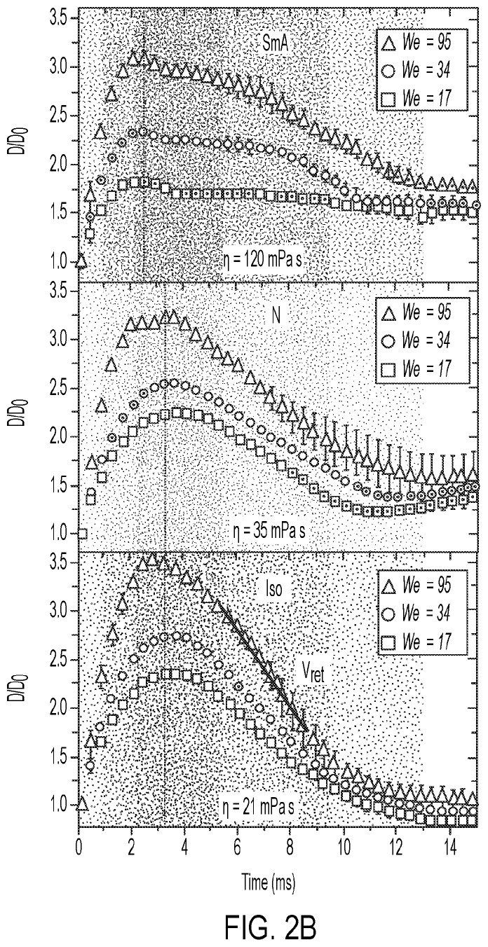

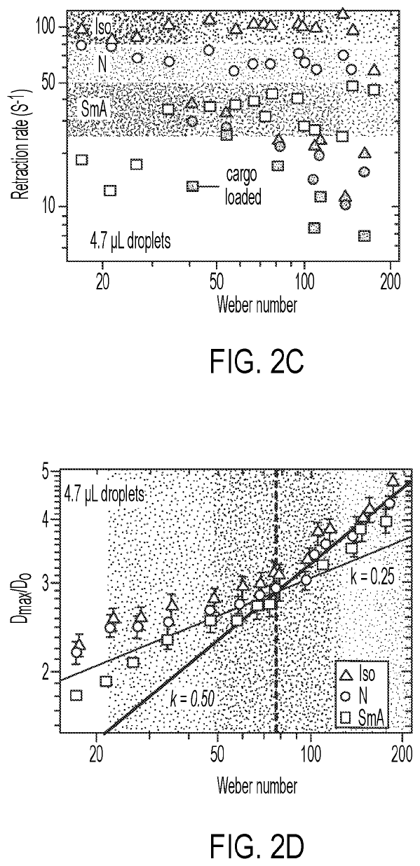

Results. Droplet impacts on LC films. As shown in FIG. 1A, how water droplets behave upon impact on an LC film was examined in consideration of the various LC mesophases and droplet impact conditions. In this work, 4′-octyl-4-biphenylcarbonitrile (8CB) was used to create the LC film because of its intrinsic mesophases: nematic, smectic, and isotropic, which vary by temperature (per FIG. 1B). The droplet impact properties can be tuned based on Weber number (We):

$$We = {ρ}_{w} {v}^{2} D / {γ}_{w} \qquad ( 1 )$$

in which ρ_{w} is the droplet density, ν is the impact velocity, D is the water droplet diameter in the air, and γ_{w} is the surface tension of water. In this series of experiments, a constant droplet volume of 4.7 μL was maintained while adjusting the droplet impact velocity through changes in the impact height.

As shown in FIG. 1C, on a smectic A phase 8CB film (25° C.), where the constituent molecules display both long-range orientational and unidirectional positional order (i.e., assembled into lamellar structures), the impacting water droplet underwent deposition (flat rim) and an ‘outside crown’ (wavy rim) with an increase in We. Transitioning to the nematic phase (35° C.), characterized by long-range orientational order but no positional order in 8CB molecules (i.e., self-aligning with randomly distributed centers of mass), the water droplet underwent a transition from deposition (flat rim) to deposition with a flat crown, and finally to a corona splash (wavy crown) with an increase in We. Further heating the 8CB film to isotropic phase with no intrinsic molecular order (45° C.) resulted in water droplet behaviors ranging from deposition to partial rebound with a crown, and ultimately a corona splash/partial rebound/receding breakup with an increase in We.

It is noted here that droplet bouncing behaviors were observed for each LC mesophase, even across multiple temperatures within the same mesophase. These findings, coupled with the temperature-independent bouncing observed on nonstructured fluid films like silicone oil, lead to the conclusion that droplet behaviors on LC films are strongly influenced by LC mesophases. Moreover, the formation of a wrapping layer of 8CB on the water droplets on the LC film was observed. This phenomenon is consistent with a positive value for the spreading coefficient(S) of 8CB at the air-water interface:

$$S = {γ}_{w} - ( {γ}_{w - LC} + {γ}_{LC} ) > 0 \qquad ( 2 )$$

where γ_{w-LC} is the interfacial tension between water and the LC, and γ_{LC} represents the surface tension of the LC (see Table 1). In the following studies of droplet impact-mediated mass transfer described below, a We ranging from 0 to 200 was targeted to avoid the complexities associated with the splashing regime.

Stability of LC films against water-induced dewetting. Inspired by the pitcher plant, an LC film was designed that was stable against water-induced dewetting. Past studies have reported that porous substrates require a specific level of energy in order to stabilize a slippery, isotropic lubricant film against water-induced dewetting. Here, the total interfacial energy of the water-wetted porous polyRM257 substrate (E_{A}) must be higher than that wetted by the LC with (E₁) or without (E₂) a water droplet on the surface. This can be written as:

$${Δ E}_{1} = {E}_{A} - {E}_{1} = r ( {γ}_{LC} {cosθ}_{LC} - {γ}_{w} {cosθ}_{w} ) - {γ}_{w - LC} > 0 \qquad ( 3 )$$

$${Δ E}_{2} = {E}_{A} - {E}_{2} = r ( {γ}_{LC} {cosθ}_{LC} - {γ}_{w} {cosθ}_{w} ) - {γ}_{w} - {γ}_{LC} > 0 \qquad ( 4 )$$

in which r is the roughness factor (or the ratio of the true versus the projected surface areas of the porous surface), γ_{w-LC} is the interfacial tension between water and the LC film, γ_{w} and γ_{LC} represent the surface tension of water and the LC, respectively, and θ_{w} and θ_{LC} are the equilibrium contact angles between the water and the LC on a solid surface, respectively.

The equilibrium contact angles and interfacial tensions of the water and 8CB on the polyRM257 substrate were measured, as summarized in Table 1. Using the values from Table 1 and substituting them into Equations 3 and 4, the interfacial energies were calculated to be ΔE₁=+12.2 mJ/m² and ΔE₂=+69.6 mJ/m² at room temperature (27° C.). These values remained positive even when r=1, corresponding to flat surfaces. For reference, the porous polyRM257 substrates have r>1. These results imply that the LC film was stable on the porous polyRM257 substrate through surface tension-induced capillary forces and resisted water-induced dewetting. The values of ΔE₁ and ΔE₂ were still positive even when the temperature was increased to 37° C. or 47° C.

The spreading coefficient was calculated using Equation (1), where γ_{w-s}, γ_{w-LC}, and γ_{LC-s} are the interfacial tensions of the water-polyRM257 substrate, LC-water, and LC-polyRM257 substrate, respectively (see Table 1). The spreading coefficient, S, was estimated to be positive (+16.8 mN/m), suggesting a wrapping layer of LCs formed around the water droplet on the LC film.

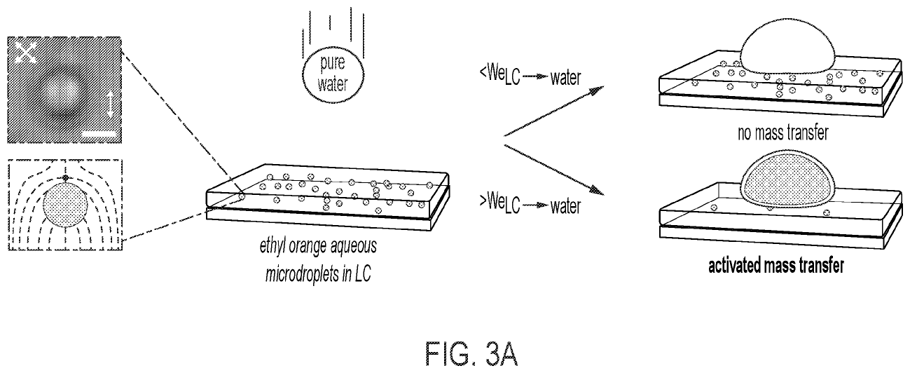

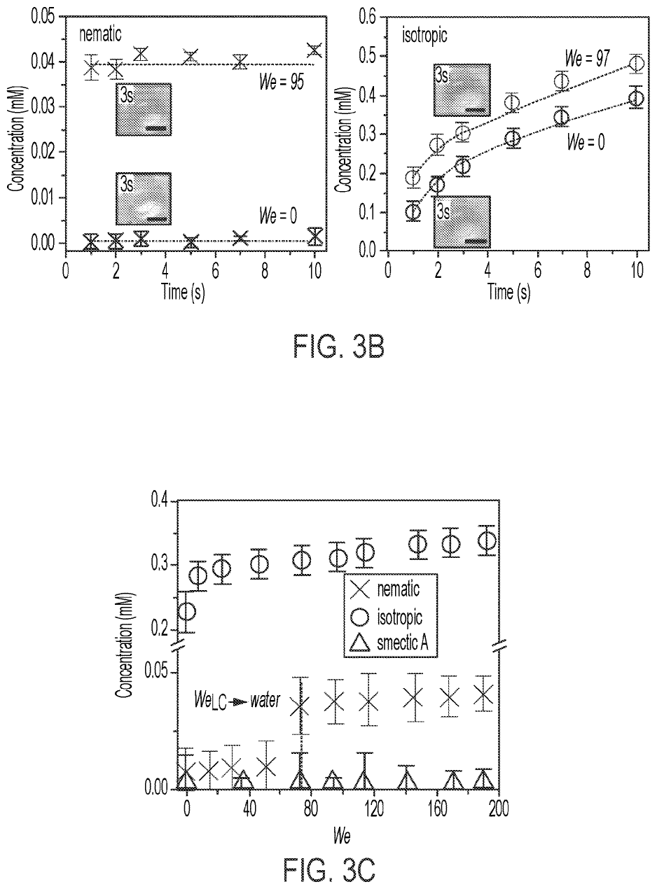

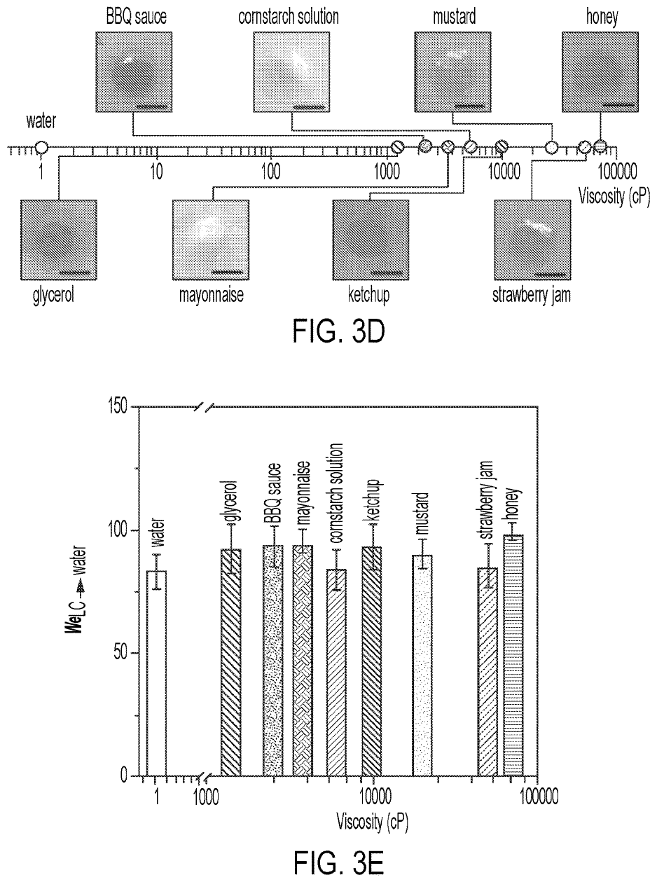

Droplet impact-activated mass transport from LC film to water droplets. As shown previously, there was a correlation between water droplet bouncing regimes and dynamics with the LC mesophase and We. The impact of droplet impact on mass transfer between the water droplet and the LC film by manipulating both the LC mesophase and We were thus further explored. Referring now to FIG. 3A, a schematic is shown that illustrates We-dependent droplet impact-induced mass transfer from nematic LC films to impacting droplets. Insets show a schematic and corresponding polarized light micrograph of the LC ordering around aqueous microdroplets. Sodium dodecyl sulfate (SDS) concentration in the encapsulated micrometer-sized aqueous droplets was 3 mM. The black dashed lines indicate the local LC orientation. The white crossed double-headed arrows and red arrow indicate the direction of the crossed polarizers and the rubbing direction. The scale bar is 5 μm.

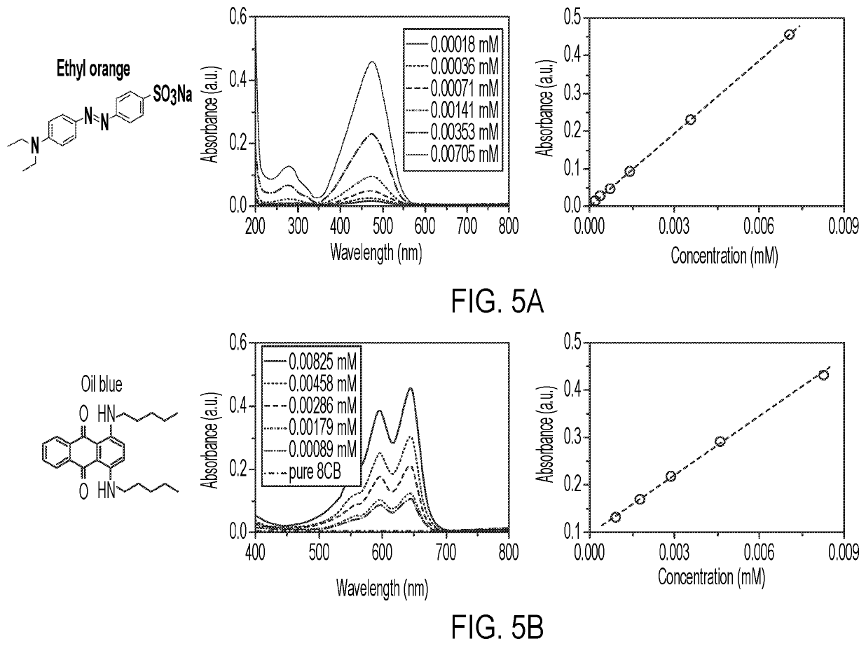

Micrometer-sized aqueous droplets of ethyl orange, a water-soluble dye, were encapsulated with a diameter of 9±5 μm, into a 8CB film. The concentration of ethyl orange released to the impacting water droplet was measured using UV-visible spectrophotometry (see FIGS. 5A-5B). To facilitate the determination of dye concentration in water droplets, the droplet volume was increased to 20 μL.

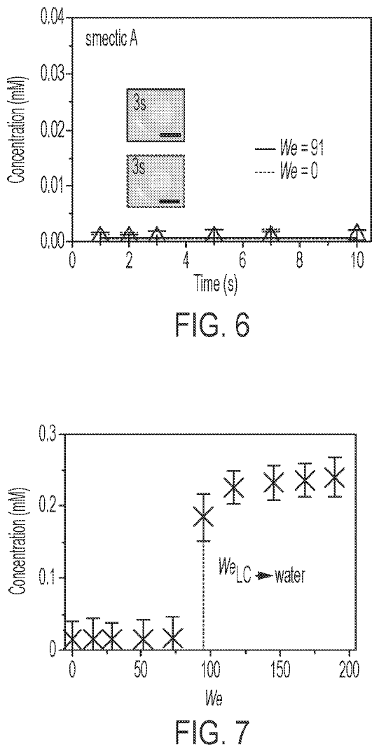

As shown in FIG. 3B, upon gently placing a water droplet on a nematic 8CB film (corresponding We=0), no measurable transfer of the encapsulated microdroplets to the water droplet on the 8CB film was observed. This lack of release was attributed to the long-range LC orientation-induced elastic repulsion around the encapsulated microdroplets. In contrast, when a water droplet was released to the nematic 8CB film from 10 cm (corresponding We=95), an abrupt transfer of ethyl orange aqueous microdroplets from the 8CB film to the water droplet occurred within 1 second, and no further mass transfer was detected. As shown in FIG. 3C, a threshold We (defined as We_{LC→water}; approximately 75) was observed for mass transfer from nematic LC films to the impacting droplets. Contrary to the nematic phase, a continuous transfer of ethyl orange aqueous microdroplets to water droplets on isotropic 8CB films was observed, with the concentration of ethyl orange in the water droplets at high We being larger than that at low We. Additionally, no mass transfer was observed when the LC film was in the smectic A phase (FIG. 6). Notably, similar characteristics were observed in nematic E7 and 4-cyano-4′-pentylbiphenyl (5CB).

In addition to studying mass transfer from LC films to impacting water droplets, the influence of water droplet impacts on the mass transfer from the water droplet to the LC film was investigated. Instead of using pure water droplets, a water droplet containing oil blue dye-doped 8CB microdroplets were released onto a pure 8CB film. As shown in FIGS. 5A-5C, when both the 8CB film and the 8CB microdroplets (within the impacting water droplet) are in the nematic phase, a threshold We (We_{water→LC}; approximately 140) was observed, similar to the existence of We_{LC→water} in the LC-to-water mass transfer process. In summary, the results reveal the dependence of droplet impact-induced water-LC mass transfer on LC mesophase and We.

Droplet impact-activated mass transport from water droplets to LC films. Besides mass transport from LC films to impacting water droplets, the effect of water droplet impacts on the mass transfer from the water droplet to the LC film (water→LC) was studied (FIGS. 5A-5C). Instead of pure water droplets, a water droplet consisting of oil blue dye-doped 8CB microdroplets was released onto the pure 8CB film (FIG. 5A). The diameter of the 8CB microdroplets was measured to be 12±4 μm (FIG. 14B), which is close to the diameter of ethyl orange-doped aqueous microdroplets encapsulated in the LC film used in the LC→water process (FIG. 3).

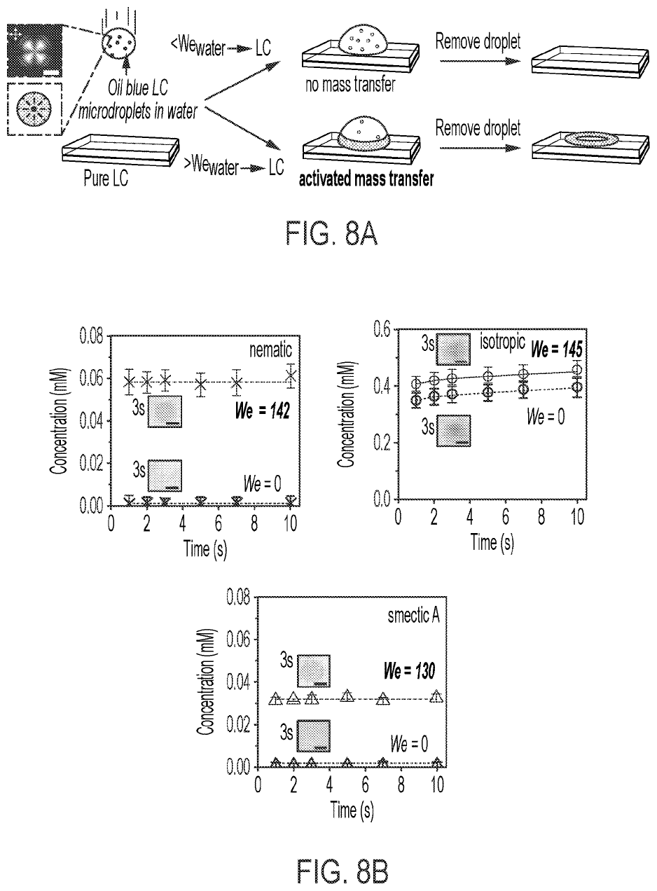

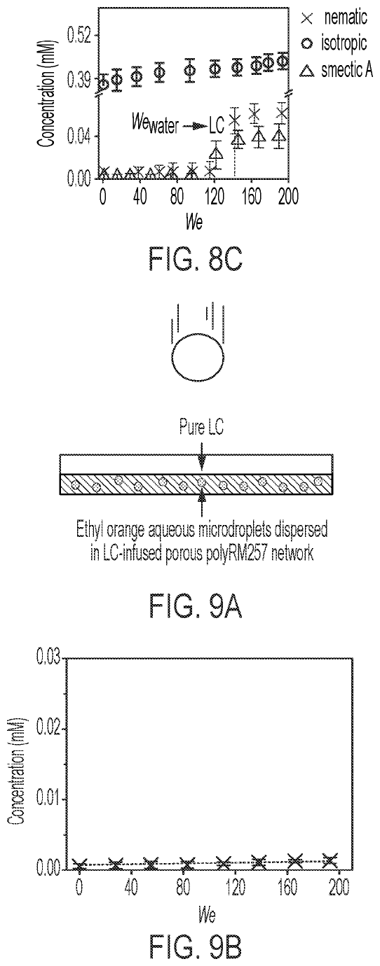

Three observations were made when comparing the results of ethyl orange-doped aqueous droplets (FIG. 5B) and oil blue dye-doped droplets FIG. 5C). First, when both the 8CB film and the 8CB microdroplets (in the impacting water droplet) were in the nematic phase, a threshold We (We_{water→LC}) was observed, which is similar to the existence of We_{LC→water} in the LC→water process (see FIGS. 3B and 3C). However, the value of We_{water→LC} (~60) was smaller than We_{LC→water} (~85). In addition, a similar We_{water→LC} existed when the 8CB was in the smectic A phase (FIGS. 8B and 8C), which has not been observed in the LC→water process when the 8CB film was in the smectic A phase (FIG. 3C). The existence of the similar values of the We_{water→LC} in the nematic and smectic A phases was attributed to the repulsive electric double layer and LC elastic forces against the merging of the 8CB microdroplets and 8CB film, which were overcome by the droplet impact-induced shear, activating the mass transport. Thirdly, when the 8CB was in the isotropic phase, a continuous transfer from the impacting water droplet to the 8CB film across the entire We range was observed, which was similar to the LC-to-water process when the 8CB film was in the isotropic phase (FIGS. 3B and 3C).

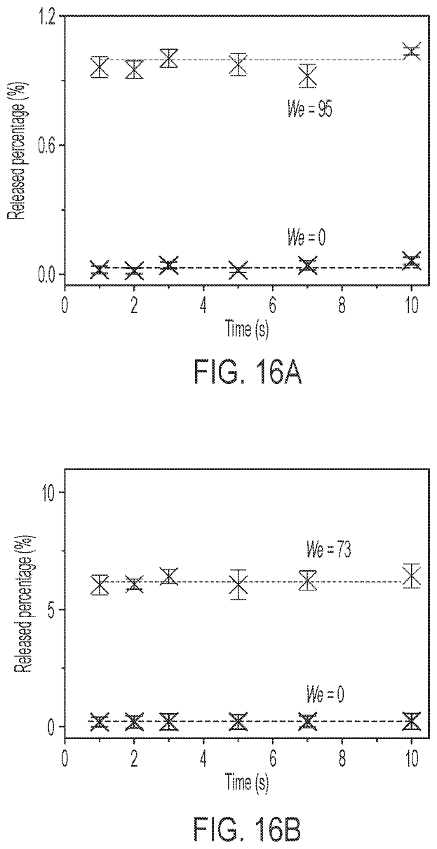

Next, the effect of water droplet impacts on the mass transfer from LC films to the impacting droplets (LC→water) was studied (see FIG. 3A). Specifically, aqueous microdroplets of ethyl orange, a water-soluble dye, was encapsulated with diameter of 9±5 μm (FIG. 14A), and the concentration of ethyl orange released to the impacting water droplet was measured using UV-visible spectrophotometry (see FIG. 5A). When a 20 μL water droplet was slowly placed on a nematic 8CB film with encapsulated ethyl orange aqueous microdroplets (corresponding We=0), no measurable transport of the microdroplets of ethyl orange to the water droplet on the 8CB film was observed, as shown in FIG. 3B and FIG. 16A. This lack of release is attributed to the LC long-range orientation-induced elastic repulsion around the encapsulated microdroplets, which agrees with past studies. Surprisingly, when a 20 μL water droplet was released to the 8CB film from 10 cm (corresponding We=95, where γ_{w} is ~69.4 mN/m at 37° C.), an abrupt transport of ethyl orange aqueous microdroplets from the 8CB film to the water droplet was observed within one second, and no further mass transfer was detected. In contrast to the nematic phase, a continuous transport of ethyl orange aqueous microdroplets to 20 μL water droplets with We=0 and 97 (impact height is 10 cm, and γ_{w} is ~67.9 mN/m at 47° C.) on isotropic 8CB films was observed, and the concentration of ethyl orange in the water droplets with a We=97 was larger than that of water droplets with We=0, as shown in FIG. 3B. In addition, no measurable transport of ethyl orange was detected on smectic A 8CB films.

To elucidate the roles of droplet impacts and LC mesophases in this mass transport process, the concentration of ethyl orange a second after the droplet impacted the LC film in different mesophases was compared (FIG. 3C). First, mass transport was observed on isotropic 8CB films over all the We range studied in this work (0-200), and the concentration of ethyl orange in the water droplets increased with an increase in the We. Second, no measurable transport to water droplets was observed over the whole We range on smectic A 8CB films. Third, and most importantly, a threshold We (defined as We_{LC→water}) was observed for mass transport on nematic 8CB films. Mass transport from the nematic films was prevented for We<85 and was observed for We>85. These observations suggest that the long-range orientational ordering of nematic LCs prevents the mass transport of ethyl orange aqueous microdroplets and that the droplet impact can disrupt the LC ordering and activates the release process.

Droplet impact-enabled printing of viscous fluids. Despite widespread use, current droplet impact-based printing, particularly inkjet printing, faces limitations with high-viscosity or shear-thickening fluids, limiting ink viscosity to around 15-25 cP. This restriction substantially limits the range of printable materials. While previous studies focused on droplet detachment, promising techniques like electrohydrodynamic and acoustophoretic printing require specific ink properties and intricate equipment setups.^{23,46} The above observations demonstrate that the droplet impact-induced shear stress can disrupt the long-range orientational ordering and activates the mass transfer process. Building on this finding, it was hypothesized that droplet impact-induced mass transfer predominantly relies on the droplet impact conditions and LC mesophase, not constrained by the properties of encapsulated materials. This insight hints at the potential of droplet impact to transfer conventionally hard-to-print materials from the LC film to impacting water droplets on the LC surface, thus achieving ‘printing.’ As demonstrated in FIG. 3D, the printing of a diverse range of highly viscous fluids and shear-thickening fluids was achieved, including glycerol, barbecue sauce, mayonnaise, cornstarch solution, ketchup, mustard, strawberry jam, and honey, with the highest dynamic viscosity up to approximately 10⁵ cP. This value surpasses the viscosity limit of printable ink in state-of-the-art inkjet printing techniques by four orders of magnitude. It is noteworthy that We_{LC→water} remains independent of fluid viscosity (FIG. 3E and FIG. 7), providing further support for the hypothesis.

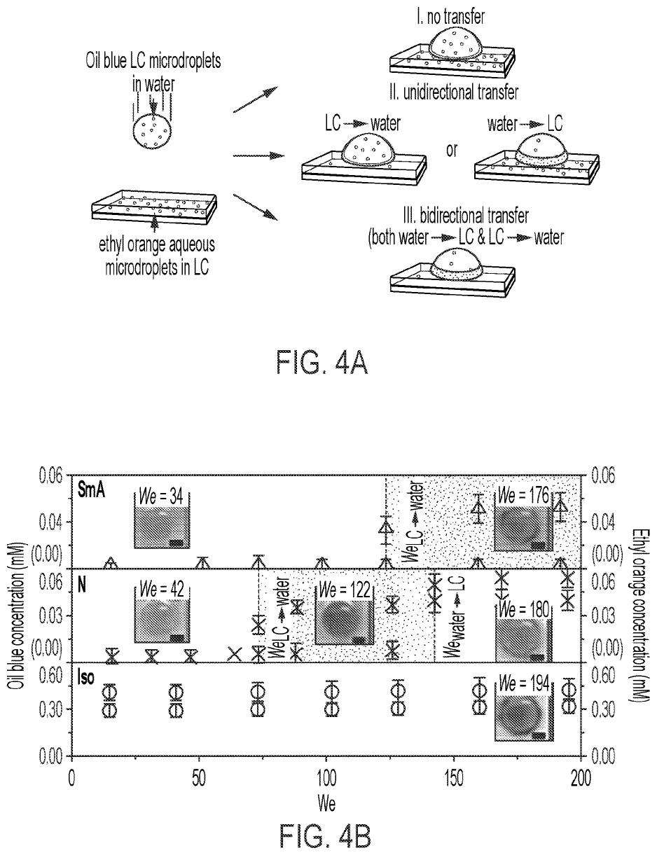

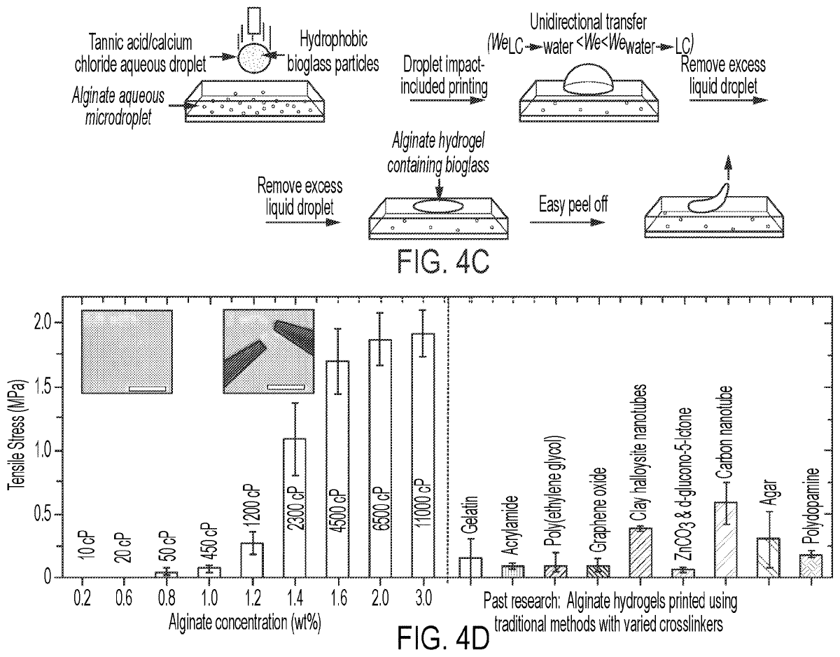

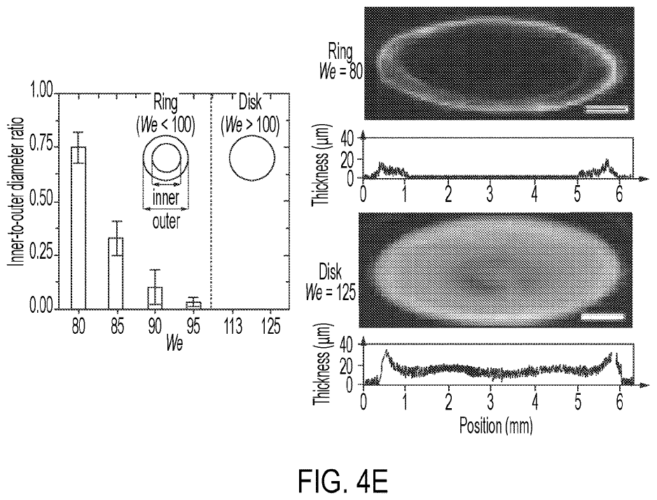

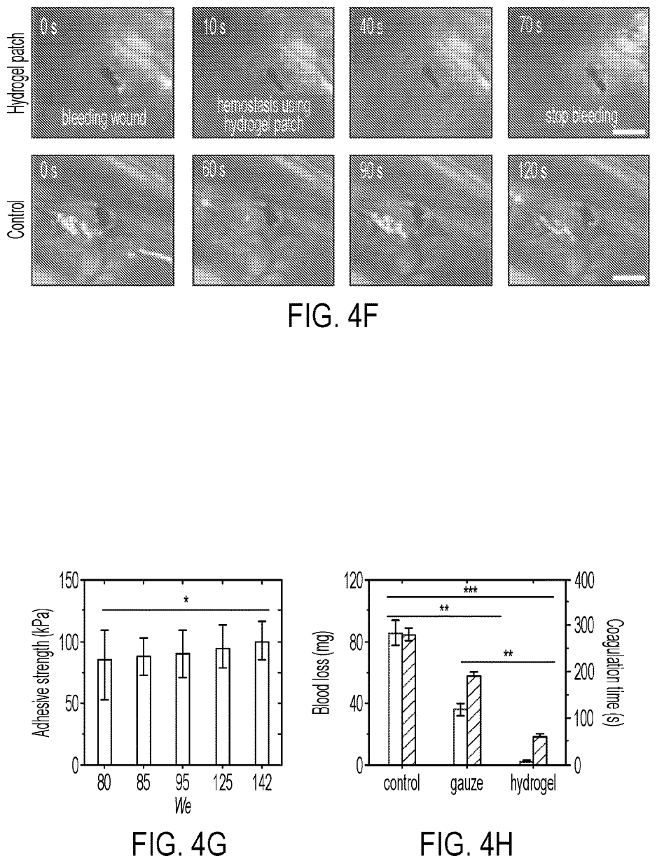

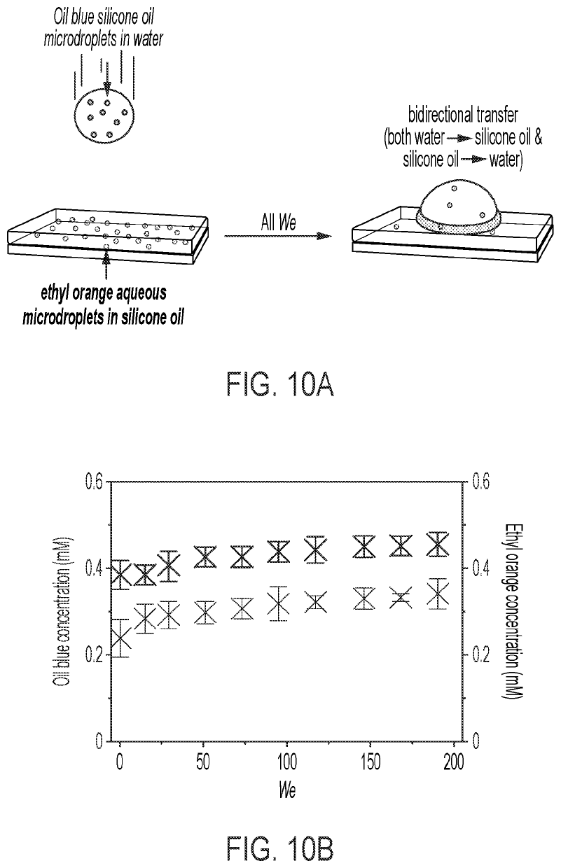

Droplet impact-regulated directionality of water-LC mass transfer. Independent LC-to-water and water-to-LC mass transfer has been demonstrated, and the ability to manipulate the direction of the mass transfer by simply tuning We is further explored. As shown in FIG. 4A, water droplets containing oil blue-doped nematic 8CB microdroplets were released onto a nematic LC film with encapsulated ethyl orange aqueous microdroplets. FIG. 4B shows that below We_{LC→water} (around 73), no water-LC mass transfer was observed, whereas above We_{water→LC} (around 142), bidirectional mass transfer occurred in both the LC-to-water and water-to-LC directions. Interestingly, between We_{LC→water} and We_{water→LC}, only the LC-to-water transfer was observed, with no water-to-LC transfer. Such unidirectional mass transfer has not been observed in isotropic 8CB systems and conventional non-structured oils (e.g., silicone oils), where bidirectional mass transfer occurs across the entire We range (see FIGS. 10A-10B). In addition, only the existence of no mass transfer and water-to-LC mass transfer in smectic A phase was observed. By further tuning the surfactant concentration in both LC films and water droplets, the direction of unidirectional mass transfer from LC-to-water to water-to-LC can be switched (see FIGS. 9A-9C).

Droplet-Impact Printing of Hydrogels. Expanding on the above findings that the directionality of water-nematic LC mass transfer can be regulated by simply tuning We, printing of viscous functional materials not achievable with traditional inkjet printing techniques was demonstrated. Hydrogels enable a variety of cutting-edge technologies such as tissue engineering, drug delivery, biomedical devices, stretchable and bio-integrated electronics, and soft robotics. As one of the most abundant hydrogels, alginate hydrogel offers advantages such as biodegradability, biocompatibility, solubility, and versatile modification capabilities, among other physiological functions. However, the intrinsically high viscosity of its chemical precursors (the dynamic viscosity of sodium alginate aqueous solutions above 1 wt % can reach 10³ cP) hinders the printing of alginate hydrogels with well-controlled dimensions and mechanical properties using conventional droplet impact-based printing techniques. Consequently, the precursors must be diluted for printability, resulting in a significant compromise in the mechanical properties of the final alginate hydrogels.

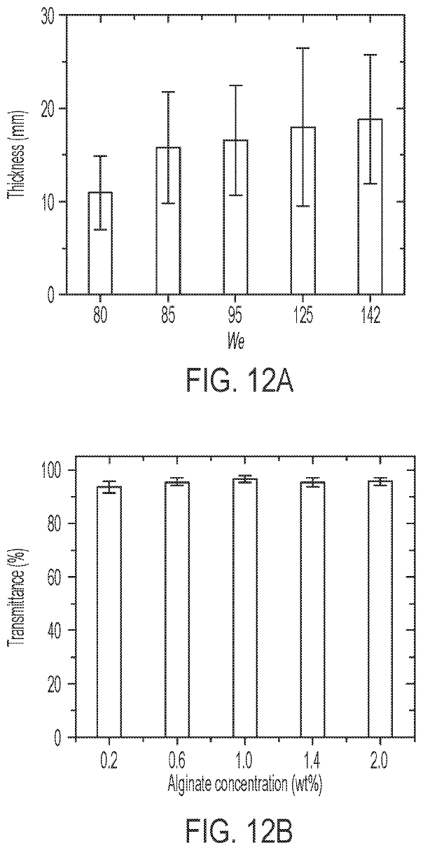

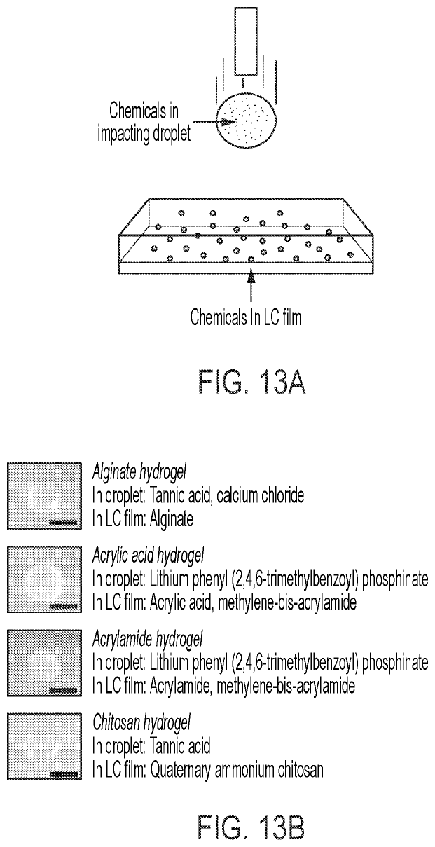

To overcome this challenge, printing using impact water droplets containing calcium chloride, tannic acid, and hydrophobic 45S5 BG bioactive glass particles onto a nematic LC film encapsulated with aqueous microdroplets containing different concentrations of sodium alginate was used (see FIG. 4C). Tannic acid crosslinks alginate with calcium ions, while bioactive glass imparts dual-adhesive and bioactive properties to the hydrogel. In the unidirectional mass transfer mode, alginate hydrogels formed through a reaction between calcium ions and sodium alginate, while bioactive glass particles remained in the aqueous phase, resulting in an alginate hydrogel encapsulated with bioactive glass particles. FIG. 4D demonstrates that precursor viscosities below the limit of conventional inkjet printing techniques yield fragile hydrogels, while exceeding 2,300 cP results in stretchable hydrogels with exceptional mechanical strength (tensile stress >1.5 MPa), surpassing the strength of conventionally printed alginate hydrogels using a dilute precursor but a delicate crosslinker selection. FIG. 4E shows that hydrogel shape can be tuned by varying We—a ring shape when We is below 100 and a disk shape when We is above 100, in accordance with the characteristics of the droplet deposition regime featuring a flat crown. FIGS. 12A-12B demonstrate that adjusting We enables precise modulation of hydrogel thickness from 8 μm to 25 μm, with all alginate concentration variations maintaining ultrahigh transparency. As evident in FIGS. 4F and 4H, the fabricated hydrogel disks exhibited strong biointerface adhesion and rapid hemostatic abilities for heart wounds. In addition to alginate hydrogels, a diverse range of hydrogels, such as acrylic acid, acrylamide, and chitosan hydrogels, can be printed utilizing droplet impact on LC films (FIG. 13).

No mass transfer from a porous polyRM257 network to an impacting water droplet. It has been shown that the long-range orientational ordering of nematic LCs inhibits the mass transfer of ethyl orange aqueous microdroplets within the LC film. Additionally shown was that droplet impact disrupts the LC ordering, leading to the activation of the mass transfer process. To further clarify this point, the mass transfer behavior of ethyl orange aqueous microdroplets encapsulated in a porous polyRM257 network layer, not in the LC film were investigated (FIGS. 9A-9B). A porous polyRM257 substrate was infused with 8CB consisting of ethyl orange aqueous microdroplets and subsequently drop-cast 80 μL of pure 8CB on the ethyl orange aqueous microdroplet-containing 8CB-infused polyRM257 substrate to form a 120 μm-thick pure 8CB lubricating film. When a 20 μL water droplet was released onto the 8CB film in the nematic phase, no measurable transfer of the ethyl orange microdroplets from the porous polyRM257 substrate to the impacting water droplet was observed over the entire We range (0-200), as shown in FIG. 9B. These results demonstrate the significant role of interfacial dynamics induced by droplet impact in LC-water mass transfer, rather than the influence of the porous substrate.

Droplet impact-influenced mass transport from a porous polyRM257 network to the water droplet. It has been shown that long-range orientational ordering of nematic LCs prevents the mass transport of ethyl orange aqueous microdroplets in the LC film and that a droplet impact can disrupt the LC ordering and can activate the release process. To further clarify this point, the release behavior of ethyl orange aqueous microdroplets encapsulated in a porous polyRM257 network layer, not in the LC film was investigated (FIG. 9A). A porous polyRM257 substrate, prepared normally, was used to encapsulate the ethyl orange aqueous microdroplets. After fully drying the substrate, the polyRM257 substrate was infused with ethyl orange aqueous microdroplets. Finally, pure 8CB (volume of 150 μL) was drop-cast on the ethyl orange aqueous microdroplet-containing 8CB-infused polyRM257 substrate to form a 240 μm thick 8CB lubricating film. When a 20 μL water droplet was released onto the 8CB film in the nematic phase, no measurable transport of the ethyl orange microdroplets from the substrate to the impacting water droplet was observed over the entire We range (0-200), as shown in FIG. 9B. These results demonstrate that the mass transfer takes place between the impacting droplet and the lubricating LC film on top of the polyRM257 substrate rather than the LC film infused within the substrate.

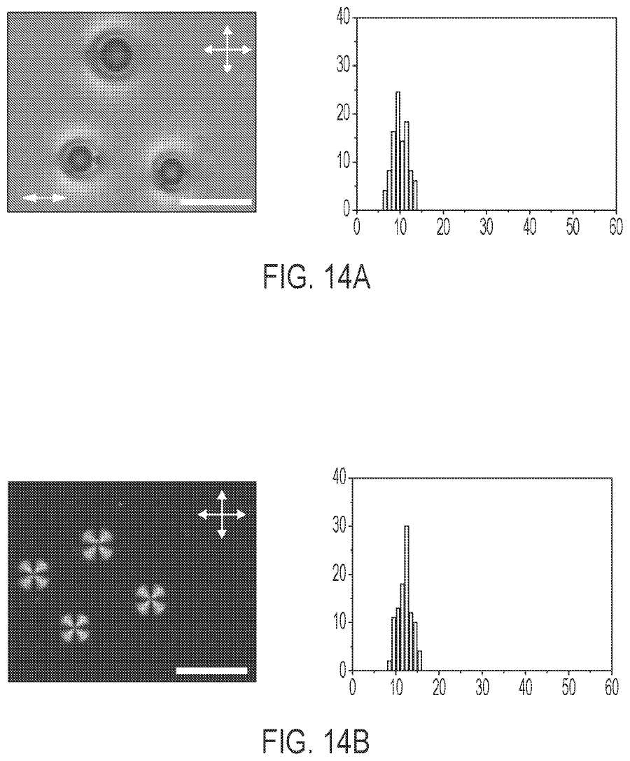

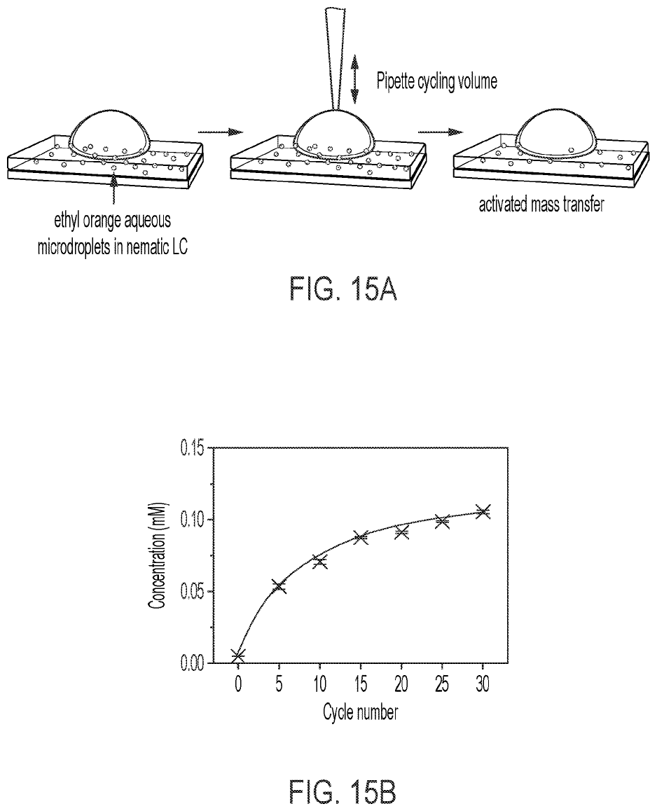

Shear force-triggered release of ethyl orange aqueous microdroplets encapsulated in a LC film. It is shown that droplet impact-induced shear disrupts the LC ordering and activate the LC→water mass transfer process. Referring now to FIG. 15A to demonstrate the shear-force triggered release, a 25 μL water droplet was slowly placed on a nematic 8CB film with encapsulated ethyl orange aqueous microdroplets (corresponding We=0) and quickly cycled 5 μL of the water droplet in and out using a pipette. This was repeated with a fresh film and droplet for each increase in the cycle number (e.g., one set was used for 5 cycles, another set was used for 10 cycles, and so on). A 5 μL sample was taken from the water droplet on the LC film after every set of cycles. Then, the samples were diluted with 2 ml of water. The concentration in the samples was measured using UV-visible absorption spectra ranging from 200 to 800 nm. The concentration was calculated using the UV calibration curve of ethyl orange. A continuous transport of ethyl orange aqueous microdroplets to the water droplet during the cycling was observed, as can be seen in FIG. 15B. These results support the observation that the shear force plays an important role in activating the mass transport.

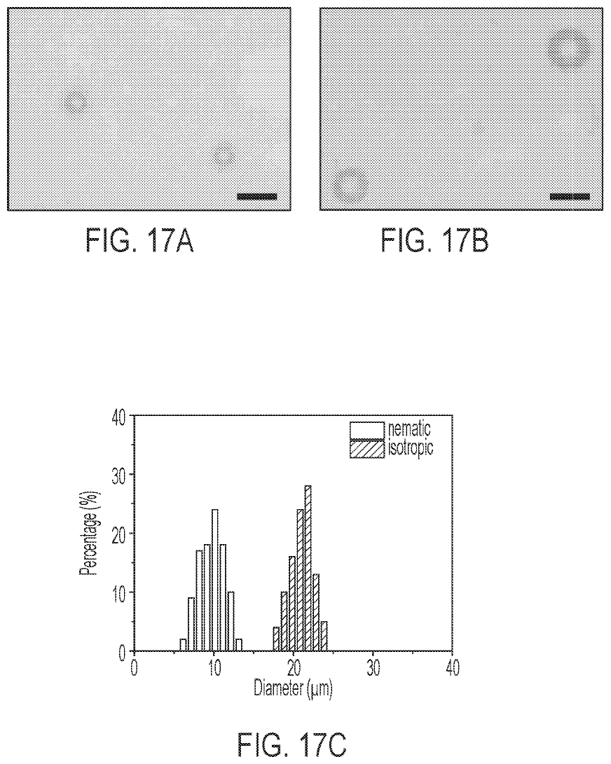

Colloidal stability of ethyl orange aqueous microdroplets encapsulated in an LC film. As shown in FIG. 14A, ethyl orange aqueous microdroplets encapsulated in an 8CB film with the size of ~9±5 μm were prepared. When the temperature of the 8CB film was increased to 37° C. (nematic phase) and kept there for five minutes, the size of the ethyl orange aqueous microdroplets remained almost unchanged (~10±4 μm) (FIG. 17A). However, the size of the ethyl orange aqueous microdroplets increased to ~22±4 μm after the temperature of the 8CB films increased to 47° C. (isotropic phase) and were kept there for five minutes (FIG. 17B). These results demonstrate that the encapsulated ethyl orange aqueous microdroplets exhibit a good colloidal stability in smectic A and nematic 8CB films, but not in an isotropic 8CB film.

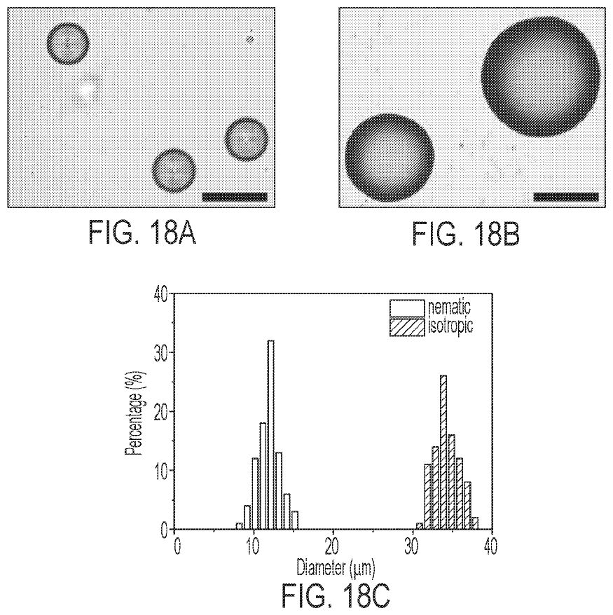

Colloidal stability of oil blue-doped 8CB microdroplets in a water droplet. Similar to the above experiment, the colloidal stability of oil blue-doped 8CB microdroplets in a water droplet was investigated. As shown in FIG. 14B, the size of the oil blue-doped 8CB microdroplets in a water droplet at room temperature (27° C.) was ~12±4 μm. When the temperature of the water droplet was increased to 37° C. (nematic phase) and kept there for five minutes, the size of the oil blue-doped 8CB microdroplets in the water droplet remained almost unchanged (~13±5 μm) (FIG. 18A). However, when the temperature of the water was increased to 47° C. (isotropic phase) and kept there for five minutes, the oil blue-doped 8CB microdroplets were observed to aggregate, which resulted in a larger size (~34±6 μm) demonstrating that the oil blue-doped isotropic 8CB microdroplets in the water droplets exhibit a poor colloidal stability. This difference was attributed to the absence of a repulsive electric double layer and the LC elastic forces acting against the merging of the oil blue-doped 8CB microdroplets. The above results, in combination with the mass transport behavior from a water droplet to the 8CB film (FIGS. S5A-S5C), lead to the conclusion that the coalescence of oil blue-doped 8CB microdroplets in a water droplet significantly affects the mass transport during the water→LC process over the entire We range (0-200).

We-independent mass transport across water-silicone oil interfaces. It has been shown the mass transport between a simple fluid (e.g., water) and a structured fluid (e.g., 8CB) are precisely controlled by manipulating the We and the LC mesophases, demonstrating that the intrinsic molecular order of the LC films plays an important role in the mass transport. To elucidate this phenomenon, the mass transport between simple fluids was investigated (e.g., water and silicone oil) (FIG. 10A). A water droplet consisting of oil blue-doped silicone oil microdroplets was released onto a silicone oil film with encapsulated ethyl orange aqueous microdroplets. The concentration of the encapsulated ethyl orange aqueous microdroplets in the silicone oil was the same as that in the 8CB film. As shown in FIG. 10B, mass transport in both directions was observed (silicone oil→water and water→silicone oil) over the entire We range (0-200), which was consistent with the mass transport between water and isotropic 8CB (FIG. 4B). Therefore, the direction of the mass transport cannot be controlled by tuning the We because no regimes where no mass transfer or unidirectional transfer were observed.

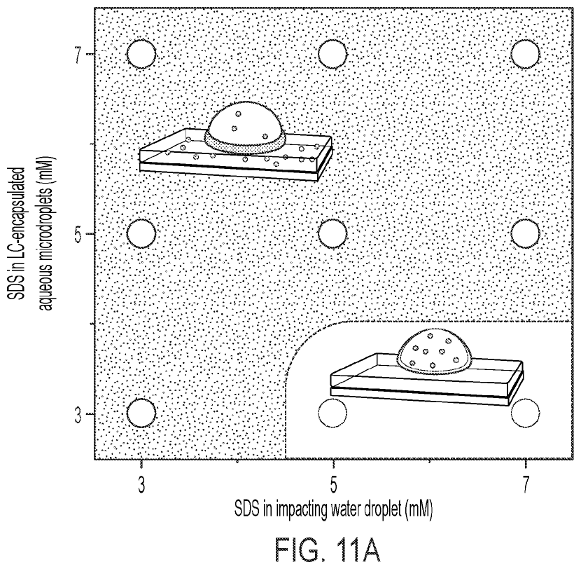

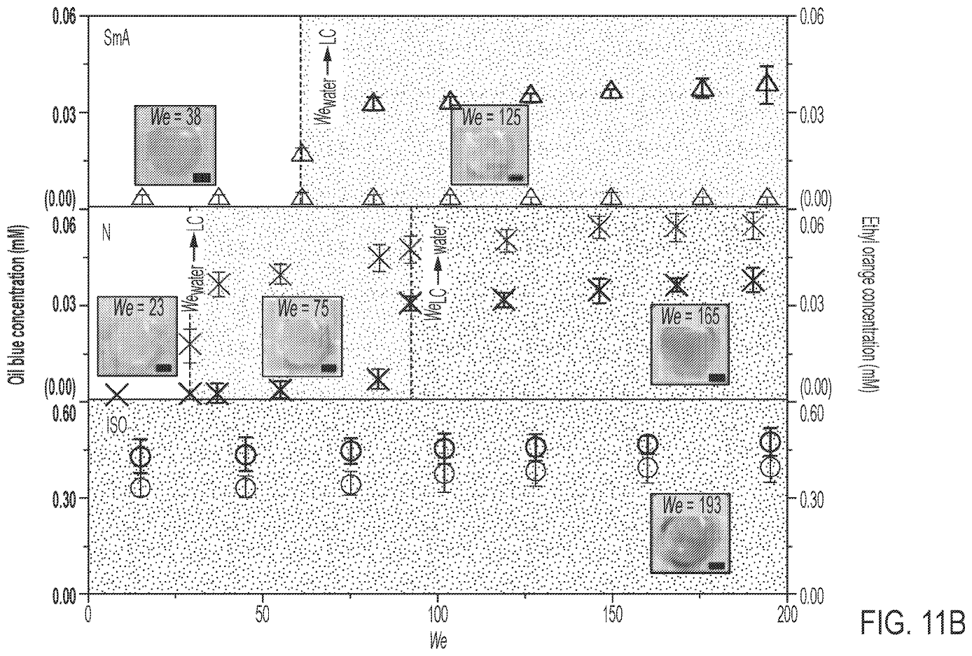

Surfactant concentration-dependent directionality of unidirectional mass transfer across water-nematic 8CB interfaces. Referring now to FIGS. 4A and 4B, it was demonstrated that the capacity to control the direction of mass transfer between water and LC by tuning We, revealing the existence of a We window for unidirectional mass transfer. To further explore this characteristic phenomenon, the concentrations of SDS were independently varied in aqueous microdroplets within LC films and impacting water droplets containing 8CB microdroplets. FIG. 11A illustrates that unidirectional mass transfer occurs from LC to the impacting water droplet when the SDS concentration in LC films is low and in impacting water droplets is high. Conversely, unidirectional mass transfer from water to LC is achieved under different concentration conditions. These findings led to manipulating the surfactant concentration and thus the electric double layer interaction allows to control the direction of unidirectional mass transfer.

FIG. 11B shows one example of unidirectional mass transfer from the impacting water droplet to the LC film, which contrasts with the water-to-LC unidirectional transfer shown in FIG. 4B of the main text. Specifically, water droplets consisting of oil blue-doped nematic 8CB microdroplets (with 3 mM SDS) were released onto a nematic LC film with encapsulated ethyl orange aqueous microdroplets (with 7 mM SDS). In the nematic phase, below We_{water→LC}~35, no mass transfer was observed between the impacting water droplet and the nematic 8CB film in either the LC-to-water or water-to-LC directions. However, above We_{LC→water}~95, mass transfer occurs bidirectionally. Between We_{water→LC} and We_{LC→water}, the transfer of nematic 8CB microdroplets from the impacting water droplets to the nematic 8CB film was observed but not the release of ethyl orange aqueous microdroplets from the nematic 8CB film to the impacting water droplets.

Materials and Methods. The following LC monomers were purchased from Jiangsu Hecheng Advanced Materials Co. Ltd: 4′-octyl-4-biphenylcarbonitrile (8CB), and 1,4-bis-[4-(3-acryloyloxypropyloxy)benzoyloxy]-2-methylbenzene (RM257). The following chemicals were purchased from Sigma-Aldrich: 10 cSt silicone oil, ethyl orange, oil blue, sodium dodecyl sulfate (SDS), 2,2-dimethoxy-2-phenylacetophenone (DMPAP), dimethyloctadecyl[3-(trimethoxysilyl) propyl]ammonium chloride (DMOAP), poly(pyromellitic dianhydride-co-4,4′-oxydianiline) amic acid, 1-methyl-2-pyrrolidinone and dehydrated ethanol. Water used in all experiments was purified by a Milli-Q water purification system (Simplicity C9210). Plain microscope slides (25 mm×75 mm×1 mm) were purchased from Fisher Scientific. Unless stated otherwise, purchased chemicals and materials were used as received without further modification or purification.

Preparation of DMOAP-functionalized glass slides. First, glass slides were rinsed with water and ethanol and dried under a stream of nitrogen gas. Then, the cleaned glass slides were placed in a 1% v/v DMOAP water solution for fifteen minutes. Afterwards, the glass slides were washed first with water and then ethanol to remove unreacted DMOAP molecules. Afterwards, the DMOAP-functionalized glass slides were dried using nitrogen gas. These slides were stored in a dark room at ambient pressure and temperature to prevent light from damaging the DMOAP coating.

Preparation of polyimide-coated glass slides. First, rinsed glass slides were spin-coated with a mixture of poly(pyromellitic dianhydride-co-4,4′-oxydianiline) amic acid (10% v/v) and 1-methyl-2-pyrrolidinone (90% v/v) at 4,000 rpm for two minutes by using a Laurell WS-650Mz-23NPPB spin processor. The glass slides were then heated at 350° C. for three hours. Next, a velvet cloth was used to rub the polyimide coating on the glass slides unidirectionally 60 times.

Preparation of LC films. To make the LC films, an LC mixture consisting of 8CB (90 wt %) and RM257 (10 wt %) was prepared. A photoinitiator, DMPAP, was added to the mixture at 1 wt % based on the total mass of the LC mixture. Next, 100 μL of the mixture was spread evenly on a 2.5 cm×2.5 cm DMOAP-functionalized glass slide. Subsequently, the reactive LC mixture-covered glass slide was exposed to a UV lamp (Spectroline, E_{A}-140; 365 nm) at 2.0 mW/cm² for 30 minutes at 35° C. This photopolymerization created an 8CB-infused polyRM257 porous substrate with a thickness of 160 μm. Finally, 150 μL of the same non-reactive LC mesogen (8CB) was drop-cast onto the 8CB-infused polyRM257 nanoporous structure to form a 240 μm thick 8CB lubricating film, which is referred to as ‘8CB film’ in this work.

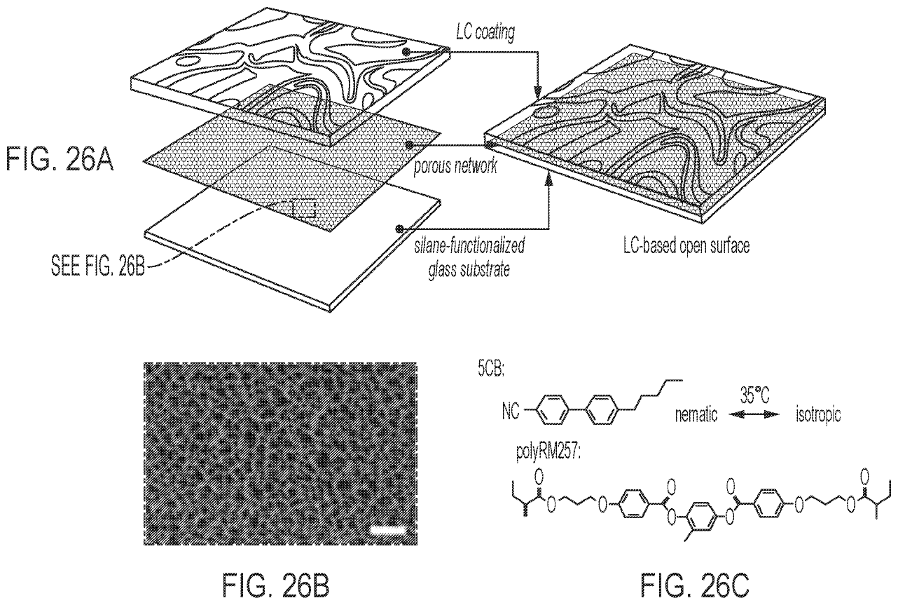

Characterization of the morphology of porous polyRM257 substrates. The porous polyRM257 substrate used for the scanning electron microscopy (SEM) imaging was prepared through the photopolymerization of a mixture of 10 wt % RM257 in 8CB followed by extracting the nonreactive 8CB with ethanol. After being fully dried, the porous substrate was coated with a thin layer of gold before imaging. Finally, the morphology of the porous polyRM257 substrate was imaged using an FEI Quanta 200 SEM with an acceleration voltage of 5 kV at a working distance of 9 mm (See FIGS. 26A-26C).

TABLE 1
Measurements of Water and LCs on Porous Substrates

| γ_{w} (mN/m) | 67.9 ± 0.7 (47° C.) |
|---|---|
| | 69.4 ± 1.2 (37° C.) |
| | 72.8 ± 0.4 (27° C.) |
| γ_{SDS aqueous solution} (mN/m) | 45.4 ± 0.6 (47° C.) |
| | 46.2 ± 0.4 (37° C.) |
| | 47.3 ± 0.5 (27° C.) |
| γ_{SDS with oil blue/8CB} (mN/m) | 34.4 ± 0.3 (47° C.) |
| | 36.1 ± 0.5 (37° C.) |
| | 39.6 ± 0.7 (27° C.) |
| γ_{w-LC} (mN/m) | 20.3 ± 1.2 |
| γ_{LC} (mN/m) | 35.7 ± 1.3 |
| θ_{w} (°) | 87.5 ± 1.1 |
| θ_{LC} (°) | 0 |

Interfacial tension and contact angle measurement using a goniometer. A KRÜSS DSA 100 goniometer was used to measure contact angles using the sessile drop method, as well as the interfacial tensions using the pendant drop method. In detail, contact angles were measured using 2 μL water droplets that were deposited on the LC films. For the interfacial tensions measurements, subject liquids were pushed through a needle at a rate of 5 μL/min to minimize the effect of dynamic forces on the shape of the droplet. The air-8CB and water-8CB interfacial tensions were calculated from approximately ten measurements taken from three different droplets. For the water-8CB interfacial tension measurements, water was placed in a quartz cell while the LC was placed in a syringe with a needle that was held under the surface of the water. A high-resolution camera captured images of these pendant droplets, which were then analyzed, and calculated the surface tensions using built-in software. A Linkam PE120 Peltier hot stage was used to control the temperature of these liquids before testing. The obtained data can be found in Table 1.

Where γ_{w} is interfacial tension of air-water, γ_{SDS aqueous solution} is interfacial tension of air-5 mM SDS aqueous solution, γSDS with oil blue/8CB is interfacial tension of air-5 mM SDS with oil blue/8CB, γ_{w-LC} is interfacial tension of water-LC, and γ_{LC} is interfacial tension of air-LC interfaces and contact angle measurements of water and LCs on porous substrates.

Droplet impact-activated mass transport from LC films to water droplets. First, the aqueous droplets were prepared by mixing 8 μL of a 35 mM SDS aqueous solution, 42 μL of a 10 mM ethyl orange aqueous solution, and 200 μL of 8CB with a vortex mixer at 2,000 rpm to prepare LC mixtures with encapsulated ethyl orange aqueous microdroplets. The final concentration of ethyl orange in the mixture was 8.4 mM. Next, ethyl orange aqueous microdroplet-encapsulated 8CB films were fabricated by using the same procedure as written above for the creation of 8CB-infused polyRM257 porous substrates but used the aqueous microdroplet/8CB mixture instead of pure 8CB. Next, 150 μL of the aqueous microdroplet/8CB mixture was added on to the 8CB-infused polyRM257 porous substrates and spread evenly to form a 240 μm thick lubricating layer. An Eppendorf micropipette was equipped on a clamp attached to a ring stand and placed above the surface. The volume of the water droplets was varied between 10 μL and 20 μL. The distance between the end of the micropipette tip and the surface was varied from 0 cm to 20 cm. The tests were done at 27° C. (smectic A), 37° C. (nematic), and 47° C. (isotopic). The water droplets were carefully dropped to avoid any initial velocity and quickly took 5 μL sample from the droplet after impact for further quantitative analysis.

Droplet impact-activated mass transport from water droplets to LC films. First, 1 mg of oil blue dye was dissolved in 1 mL of 8CB. Then, 60 μL of the obtained oil blue 8CB solution was mixed with 35 μL of a 35 mM SDS aqueous solution and 200 μL of water using a vortex mixer at 3,000 rpm to prepare water droplets consisting of oil blue-doped 8CB microdroplets. The same method as the droplet impact-activated mass transfer from 8CB films to water droplets was done for the mass transport from water droplets consisting of oil blue-doped 8CB microdroplets to pure 8CB films at 27° C. (smectic A), 37° C. (nematic), and 47° C. (isotopic). A 20 μL sample from the 8CB film under the impacting droplet was quickly taken for further quantitative analysis.

Droplet impact-mediated bidirectional mass transport between water droplets and LC films. Combining the above two processes, water droplets consisting of oil blue-doped 8CB microdroplets were released onto an 8CB film with encapsulated ethyl orange aqueous microdroplets. The water droplets consisting of oil blue-doped nematic 8CB microdroplets were dropped from 0 cm to 20 cm with varied volumes of 10 μL, 15 μL, and 20 μL. The tests were done at 27° C. (smectic A), 37° C. (nematic), and 47° C. (isotopic). The water droplets were carefully dropped to avoid any initial velocity. A 5 μL sample was taken from the droplet after impact and a 20 μL sample was taken from the 8CB film under the impacting droplet for further quantitative analysis.

Characterization of LC ordering around aqueous microdroplets and within LC microdroplets. An Olympus BX53 microscope equipped with crossed polarizers was used to image the ordering of the nematic 8CB around the ethyl orange aqueous microdroplets and the ordering of 8CB within the 8CB microdroplets dispersed in the SDS aqueous solution. Both mixtures were injected into a 100 μm thick optical cell that was prepared by pairing two rubbed, polyimide-coated glass slides that were oriented to induce a 0° twist.

Size measurements of ethyl orange aqueous microdroplets in a LC film and oil blue-doped 8CB microdroplets in a water droplet. An Olympus BX53 microscope was used to measure the size distributions of the encapsulated ethyl orange aqueous microdroplets in an 8CB film and the oil blue-doped nematic 8CB microdroplets in a water droplet. Then, the optical micrographs were analyzed with the Nano Measure software by measuring the diameter of at least 50 microdroplets (FIGS. 14A-14B).

UV-visible spectrophotometry measurement. The concentration of ethyl orange in the water droplets was characterized by using a UV-visible spectrophotometer (Perkin Elmer Lambda 950). 5 μL of the water droplets after impact were taken and diluted with 2 ml of water. The samples were measured in the UV-visible absorption spectra ranging from 200 to 800 nm. The concentration was calculated using the UV calibration curve of ethyl orange (FIGS. 5A-5B). To determine the concentration of oil blue on the LC films, 20 μL of oil blue encapsulated LC on the LC films was taken and diluted with 2 ml of ethanol. The absorbance-concentration calibration curves were plotted using the absorbance at 474 nm for ethyl orange and 643 nm for oil blue.

Calculation of the percentage of released microdroplets. The percentage of encapsulated ethyl orange aqueous microdroplets transferred from an 8CB film into a water droplet was calculated as was the percentage of oil blue-doped 8CB microdroplets transferred from a water droplet into an 8CB film by using the change in the moles of the dye (FIGS. 16A-16B). The size of the 8CB film was 1 cm×1 cm×240 μm. For the encapsulated ethyl orange aqueous microdroplets transferred from the 8CB film into a water droplet, Equation 5 was used:

$$Percent Released = \frac{{c}_{w} \times {V}_{w}}{{c}_{i} \times S \times d \times y} \times 100 \% \qquad ( 5 )$$

where c_{w} and cᵢ represent the concentration of ethyl orange transferred from the 8CB film into a water droplet and the initial concentration of ethyl orange in the aqueous microdroplets encapsulated in the 8CB film, respectively. V_{w} is the volume of the impacting water droplet, S is the surface area of the 8CB film, dis the thickness of 8CB film, and y is the volume fraction of encapsulated ethyl orange aqueous microdroplets in the 8CB film. For the oil blue-doped 8CB microdroplets transferred from a water droplet to the 8CB film, Equation 6 was used:

$$Percent Released = \frac{{c}_{o} \times S \times d}{{c}_{{w}^{′}} \times {V}_{{w}^{′}} \times {y}^{′}} \times 100 \% \qquad ( 6 )$$

where cₒ and c_{w′} represent the concentration of oil blue transferred from a water droplet into the 8CB film and the initial concentration of oil blue in the 8CB microdroplets, respectively. S is the surface area of the 8CB film, dis the thickness of 8CB film, V_{w′} is the volume of the impacting droplet with encapsulated oil blue-doped 8CB microdroplets, and y′ is the volume fraction of oil blue-doped 8CB microdroplets in the impacting water droplet.

Discussion. The above results demonstrate that mass transport between a simple fluid (e.g., water) and a structured fluid (e.g., LC) can be precisely tuned through manipulating the droplet impact properties and the LC mesophases. Given the broad range of triggers that can perturb the underlying colloidal particle interactions, the results provide the basis for a highly versatile approach for multiple-stimuli-responsive mass transport. Promising future directions include the use of other LC phases such as cholesteric and blue phases. Finally, on the basis of droplet impact-induced mass transport on LC films, it is contemplated that the intrinsic molecular order of LC films will offer avenues for the design of next generation additive manufacturing. For example, encapsulating the ink within the LC films and using droplet impacts to activate the ink release to the top surface, in effect, “printing” the ink. It is contemplated that the droplet impact-induced ink printing can be applied to conventionally hard-to-print materials, like highly viscous liquids and solids, in nozzle-based printing techniques, such as inkjet printing and liquid-liquid printing.

### Example 2. Advanced Print Manufacturing

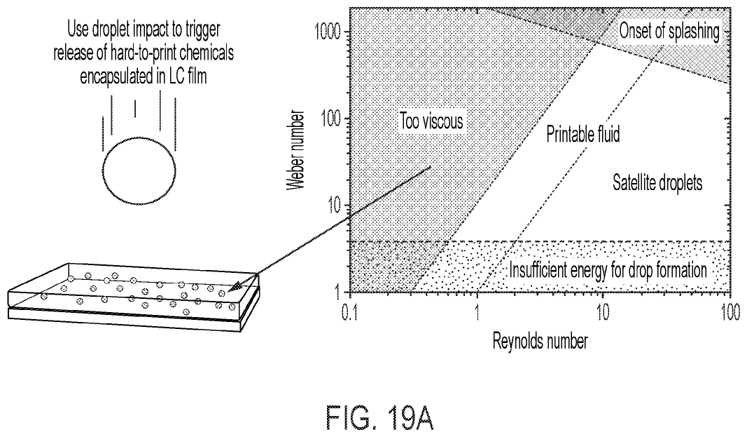

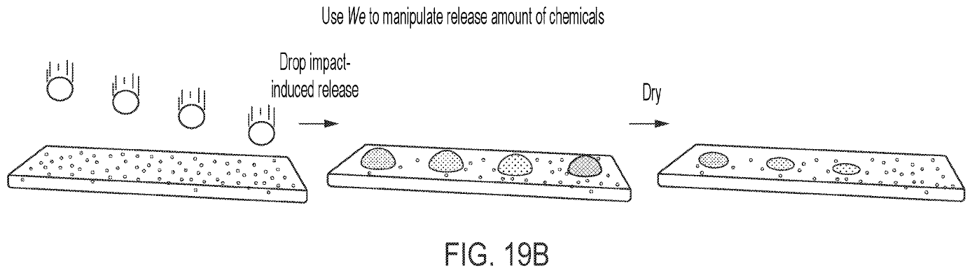

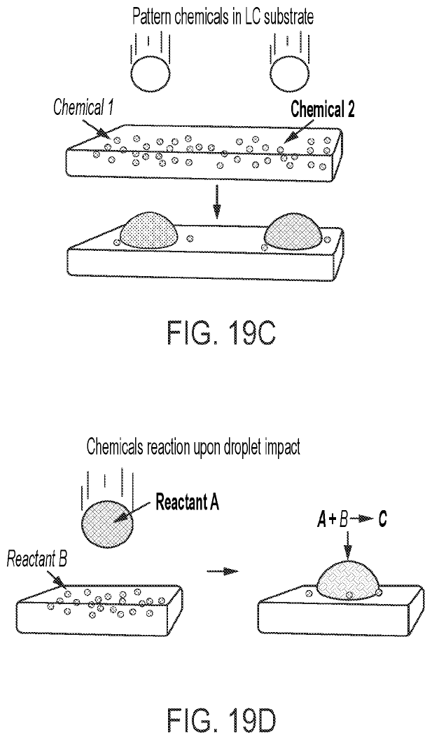

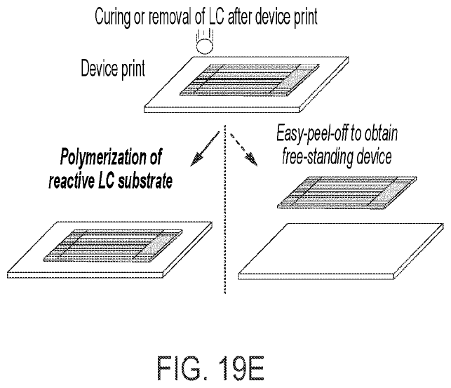

The release of microcapsules of an aqueous-glycerol mixture doped with ethyl orange dye was strongly dependent on the Weber number of the impacting droplet (We=ρ_{w}ν²D/γ_{w}, in which ρ_{w} is the droplet density, ν is the impact velocity, D is the water droplet diameter in the air, and γ_{w} is the surface tension of water). Specifically, at room temperature, microcapsules released from the nematic phase 5CB LC film occurred only above a threshold We, whereas no release was observed below this threshold, as evidenced in FIG. 3A. Importantly, the viscosity of the released microcapsules (80% glycerol) was 62 cP, which was approximately four times the viscosity limit of printable ink in the state-of-the-art inkjet printing (~15 cP). 2,3,5,15,22,31-36 It is contemplated that the droplet impact-induced shear stresses disrupt the LC molecular ordering, which triggers the release of microcapsules that can be composed of conventionally hard-to-print materials, such as highly viscous liquids and thermosetting polymers (i.e. polymers that cannot be remolded, reheated or solvent-dissolved after initial curing), as shown in FIG. 19A.1 The underlying mechanisms behind the droplet impact-activated microcapsule release behavior of LC surfaces and a design principle for a novel framework that enables inkjet printing of conventionally hard-to-print inks are provided herewith.

Referring now to FIG. 19B, in some aspects, the techniques described herein allow for control of the number of microcapsules released using droplet impacts with different We is demonstrated.

Referring now to FIG. 19D, in some aspects, the techniques described herein allow for chemical reactions activated by droplet impacts sot that materials are printed not in their final, hard-to-print state, but through in-situ reactions induced by droplet impacts.

Referring now to FIG. 19C, in some aspects, the techniques described herein allow for spatially patterned encapsulation of microcapsules in LC substrates to achieve multi-material printing.

Referring now to FIG. 19E, in some aspects, the techniques described herein allow for curing of reactive LC substrate or peeling-off of free-standing device after printing. In other aspects, the slipperiness of the LC substrate allow the printed material to be easily peeled off to obtain a free-standing printed device.

LC orientational ordering-mediated chemical release. Despite the extensive studies, neither solid-nor simple liquid-based receiving substrates satisfy the requirements in the proposed framework to trap microcapsules that droplet impacts can then release. Although simple liquid surfaces can trap immiscible liquid droplets, any impact inertia will result in mixing between the water droplet and the liquid substrate, leading to uncontrolled microcapsule release as simple liquids possess high levels of molecular mobility but no molecular order. To achieve the controlled release in the disclosed framework, a liquid crystal substrate is used to trap the microcapsules until the impact force reaches a threshold value.

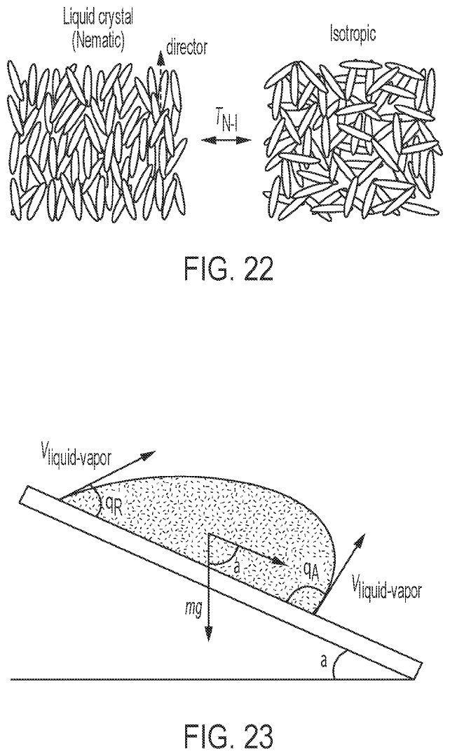

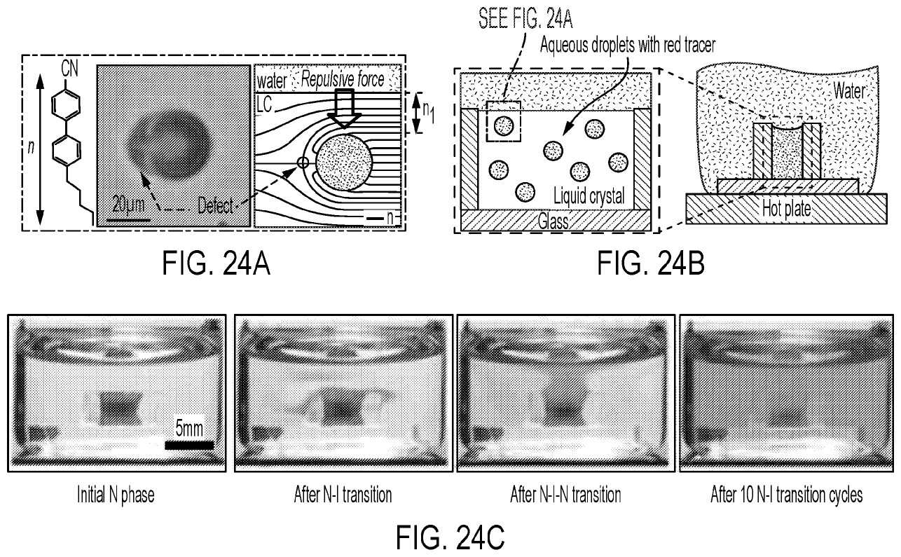

LCs are a representative class of structured fluids that exhibit properties commonly associated with crystalline solids (a long-range orientational ordering of constituent molecules) and simple fluids (high mobility of constituent molecules).⁵¹⁻⁵³ As shown in FIG. 22, the LC molecules in the nematic phase have no positional order but tend to point in the same direction (along the director). In contrast, above the nematic to isotropic phase transition temperature (T_{N-I}), the LC molecules behave similarly to simple, non-structured fluids with no intrinsic molecular order. Recently, extensive studies have demonstrated that the intrinsic long-range orientational ordering of the constituent LC molecules leads to a remarkable diversity of interfacial phenomena distinct from simple fluids.^{39,54-61} In particular that the long-range molecular order of LCs provides an additional interparticle force that impedes the release of particles and droplets dispersed in the bulk LC.⁵⁴ When a dispersed microphase of an immiscible liquid, solid, or gas (namely microcapsules) is introduced into a bulk LC, the orientational ordering around the microcapsule is determined by a competition between the elastic energy arising from the strain of the LCs (KR_{capsule}, where K is the Frank elastic constant of the LC and R_{capsule} is the microcapsule radius) and an orientation-dependent surface anchoring energy at the LC-microcapsule interface (WR_{capsule}², where W is the surface anchoring energy density).^{53,56-58,62-64} When R_{capsule}>K/W, the microcapsule will strain the LC orientation and form topological defect structures, which give rise to strong repulsive forces between the microcapsule and the LC boundaries (FIGS. 24A and 24B) and prevent the contact or coalescence of microcapsules in the bulk LC, as well as the release of the microcapsules from the LC bulk to the surrounding water phase. However, upon a nematic to isotropic phase transition by heating above T_{N-I}, the LC orientational ordering is disrupted. The absence of the repulsive LC elastic forces results in the release of microcapsules to the overlying aqueous phase. These results reveal that the release of microcapsules can be precisely controlled through manipulation of the LC orientational ordering using external stimuli such as heat and light.

Stabilization of LCs against water droplet-induced dewetting. Although the results presented suggest that LCs are a promising candidate for responsive inkjet printing liquid receiving substrate that would allow for control of microcapsules release. The design of LC-based substrates has been hindered by water droplet-induced dewetting of LC films coated on conventional hydrophobically modified substrates, including silane-functionalized surfaces, azlactone-functionalized surfaces, and porous polystyrene-coated surfaces.⁶⁵⁻⁶⁷ The dewetting of LC films causes the pinning of water droplets to the underlying solid substrate. The droplet sliding angle, defined as the threshold tilting angle of the surface required for the droplet to move, has been widely used to measure the pinning of water droplets on surfaces, as shown in FIG. 23. The pinning force (F_{pinning}) acting on the droplet can be written as:⁶⁸⁻⁷⁰

$${F}_{pinning} = mg sin α = {γ}_{w} w ( cos {θ}_{R} - cos {θ}_{A} ) \qquad ( 7 )$$

in which m is the mass of water droplets, w is the width of the droplet circumference, a is the sliding angle, and θ_{A} and θ_{R} are contact angles at the advancing and receding side of the droplet on the surface, respectively. As shown in Equation 7, the presence of large sliding angles arises from the difference between θ_{A} and θ_{R} (known as contact angle hysteresis), which stems from either a physical (e.g., surface roughness) or chemical (e.g., different surface energies across the surface) heterogeneity of the surface. Past studies have reported that upon the dewetting of the lubricating oil (e.g., LC) film on the substrate, the direct contact between the water droplet and the solid substrate causes a high pinning force and large sliding angle.^{66,67,71} For example, 10 μL water droplets become pinned on LC-coated azlactone-functionalized surfaces with an approximate sliding angle of 10°.⁶⁶

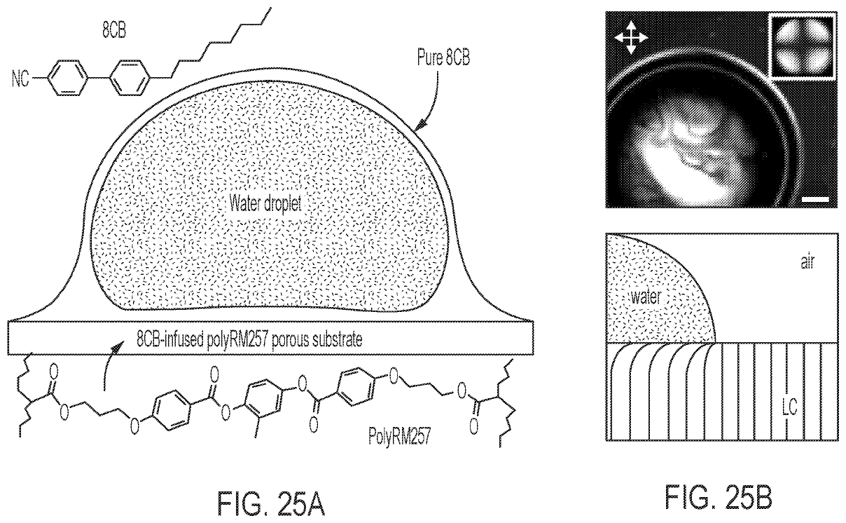

Inspired by the pitcher plant, promising results have been reported that the use of a LC porous polymeric network to stabilize LC mesogens to overcome the aforementioned issue of water droplet-induced LC dewetting.³⁷ As shown in FIG. 25A, a LC polymer (RM257) was used to form a porous substrate that was shown to stabilize a LC film against water droplet-induced dewetting through strong dipole-dipole interactions between the polyRM257 and 8CB. The LC polymer-LC system satisfies the criteria that the total interfacial energy of the porous substrate wetted by water (E_{A}) needs to be higher than those of the LC-infused porous surfaces with (E₁) or without (E₂) water on their surface.⁷²

Upon directly placing a 3 μL water droplet on the LC film, its sliding angle was measured to be ~2°, suggesting no pinning of droplets on the LC. In addition, when observed under a polarized light microscope, the nematic 8CB film was dark in air and turned bright when it came in contact with a water droplet, as shown in FIG. 25B. This transition is consistent with the different surface anchoring shown by nematic 8CB at an air-LC interface (perpendicular to the interface) and a water-LC interface (parallel to the interface), suggesting that the LC film remains stable under the water droplet.⁵³ These findings provide an opportunity to investigate droplet impacts on stable LC surfaces and explore the possibility of using droplet impacts to control the release of microcapsules from the LC film. In addition, we expect that the intrinsic slipperiness of LCs will enable us to easily peel off printed products from the LC receiving substrates.

Using the techniques taught herein, it is contemplated that that a specified quantity of chemical reagents can be released into a water droplet impacting a LC surface in a programmable and controlled manner due to the induced change of the LC molecular order. The Weber number-dependent chemical release mechanism from LC films activated by droplet impacts can be leveraged to release hard-to-print chemicals in conventional inkjet printing. It is contemplated that the techniques taught herein can be used for printing free-standing polymeric devices through the combination of droplet impact-mediated chemical reactions and the ability to peel the product off the LC substrates with ease.

Droplet impact-induced microcapsule release on LC substrates. As shown in FIG. 26A, a porous polyRM257 network was prepared on a silane dimethyl-octadecyl[3-(trimethoxysilyl) propyl]ammonium chloride-functionalized glass substrate by photopolymerizing a reactive LC mixture containing RM257, a non-reactive LC porogen, and a photoinitiator. The pore size of the porous polyRM257 network was measured with a scanning electron microscope (SEM) and was found to be between 200 nm and 500 nm (FIG. 26B).

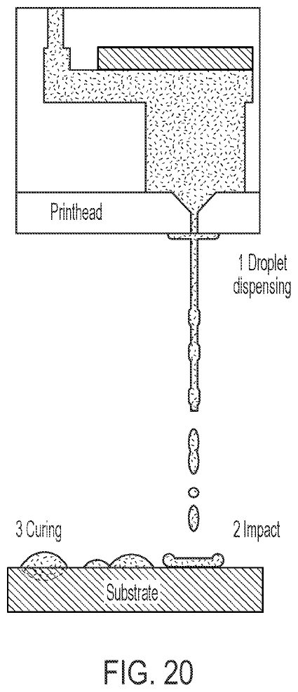

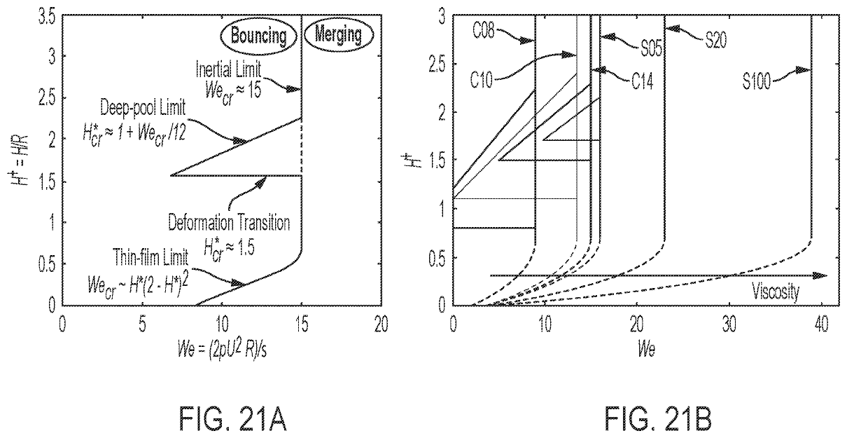

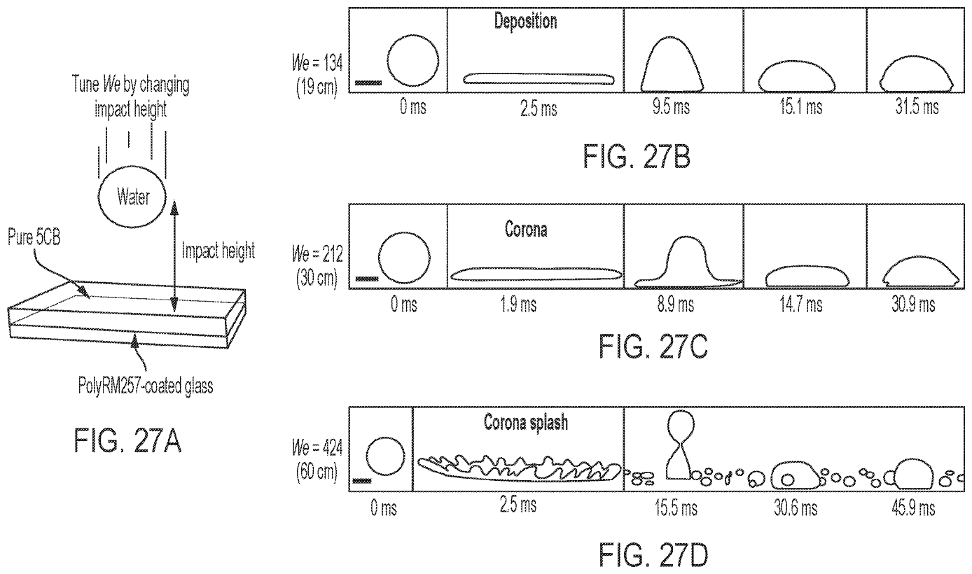

To elucidate the droplet impact-induced microcapsule release mechanism the droplet impact dynamics on LC surfaces were studied to determine the We range suitable for inkjet printing, as shown in FIG. 27A. First, nematic phase LCs, the simplest LC mesophase, in which molecules are randomly distributed in space with a long-range orientational order were studied. A 100 μm-thick film of pure 5CB (FIG. 26C) was coated on the porous polyRM257 network. The nematic-isotropic phase transition temperature, T_{N-I}, of 5CB is ~35° C., above which the 5CB molecules exhibit no intrinsic order, similar to the disordered molecular structure of simple fluids, such as water and silicone oils. It was observed that at room temperature (25° C.), impacts of 10 μL water droplet on a 5CB surface (nematic phase) followed a deposition behavior at lower We (FIG. 27B) and corona or corona splash behaviors at higher We (FIGS. 27C and 27D). A typical inkjet printing processes (FIG. 20) operates with a deposition regime of We ranging from 0 to 200. In addition, the sliding angle of the water droplets after impacting the LC surface was determined to be <2° over a wide range of We (0-450), suggesting the LC films are stabilized against dewetting by droplet impacts.

As previously demonstrated, when the size of the microcapsule in the LC film (R_{capsule}) is >K/W (i.e., WR_{capsule}²>KR_{capsule}), the microcapsule distorts the surrounding LCs. 53,56-58,62-64 It generates a repulsive elastic force that prevents the release of microcapsules from the bulk LC to the environment. For typical low molecular weight nematic LCs, K is Oct. 11, 2010-12 N and Wis Oct. 4, 2010-6 J/m², giving rise to a critical microcapsule size, K/W, on the scale of tens or hundreds of nanometers. It is contemplated that the interaction between the stress field generated by the droplet impact and the response of the LCs to the stress field is essential to the release of microcapsules. Unlike simple fluids, which are passive to stress fields, the stress field induced by droplet impacts creates a driving force that can disrupt the LC phase and overcome the repulsive LC elastic force, resulting in the release of microcapsules from the LC film to the water droplet. A higher We should lead to higher disturbances in the LC receiving substrate by creating more complex stress fields in the LC films.

Droplet impact-activated microcapsule release using 5CB on polyRM257 network. the polyRM257 network was coated with a 100 μm-thick 5CB film containing microcapsules. For a simplified visualization of microcapsule release, ethyl orange was dissolved in an aqueous solution of sodium dodecyl sulfate (SDS), an anionic surfactant that helps stabilize the aqueous microdroplets in the bulk LC, before dispersing the solution (10 wt %) in 5CB (90 wt %) at room temperature. The diameter of the formed ethyl orange aqueous microcapsules in the bulk 5CB was measured to be 2.0±0.5 μm using an optical microscope, larger than the K/W of 5CB. Next, the dispersion was drop-cast onto the surface of a porous polyRM257 network. The mass of the microcapsule released from the LC surface to the impacting water droplet was determined using gravimetry and the concentration of ethyl orange was quantified using UV-visible spectrophotometry.

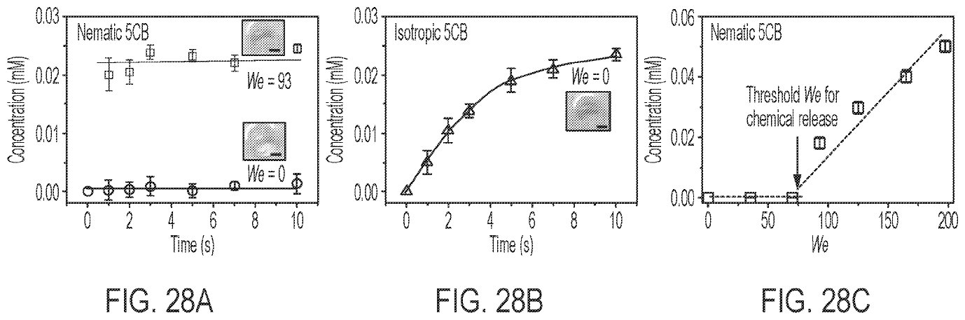

When a 10 μL water droplet was slowly placed directly on a nematic 5CB film (corresponding We=0), no measurable release of ethyl orange-containing aqueous microcapsules was observed, as shown in FIG. 28A. This absence of release is consistent with the previous studies, which is attributed to the repulsive LC elastic force around microcapsules caused by the long-range orientational ordering of the LC.^{37,38} In contrast, an abrupt release of microcapsules to the water droplet was observed when the 10 μL water droplet impacted the nematic 5CB surface from a height of 20 cm (corresponding We=92). However, no further release of ethyl orange was detected over a long time, as shown in FIG. 28A. It is contemplated that the droplet impact-induced hydrodynamic shear stress disrupts the long-range LC orientational ordering and causes microcapsule release. Water droplets impacting LC films were tested in the isotropic phase to provide more insight. In contrast to the nematic 5CB, it was observed a continuous microcapsule release from the isotropic 5CB film to the water droplets even with We=0 (slowly placed on the isotropic 5CB film), as shown in FIG. 28B. This observation suggests that simple fluids, such as isotropic LCs and hydrophobic oils, cannot mediate the release of microcapsules in a controlled manner. To provide more experimental evidence, the microcapsule release on nematic LC surfaces was measured using water droplets with We ranging from 0 to 200, as shown in FIG. 28C. It was observed that a threshold We needed for the release of microcapsules. For We up to ~75, no microcapsule release was measured. In contrast, when We was above 75, the microcapsule release was activated, and the release amount increased with an increase in We. The results provide a basis for droplet impact-mediated microcapsules release from nematic LC surfaces.

The results above suggest that the intrinsic long-range orientational order of nematic LCs plays an essential role in the release process of microcapsules with sizes >K/W. It is contemplated that the effect of the capsule size by tuning the homogenization speed and the surfactant concentration will relate to the threshold We as a function of microcapsule size. It is contemplated that when R_{capsule}<K/W, the absence of the LC elastic barrier will allow the release of nanocapsules at any We, which may reveal similarities to isotropic 5CB films.

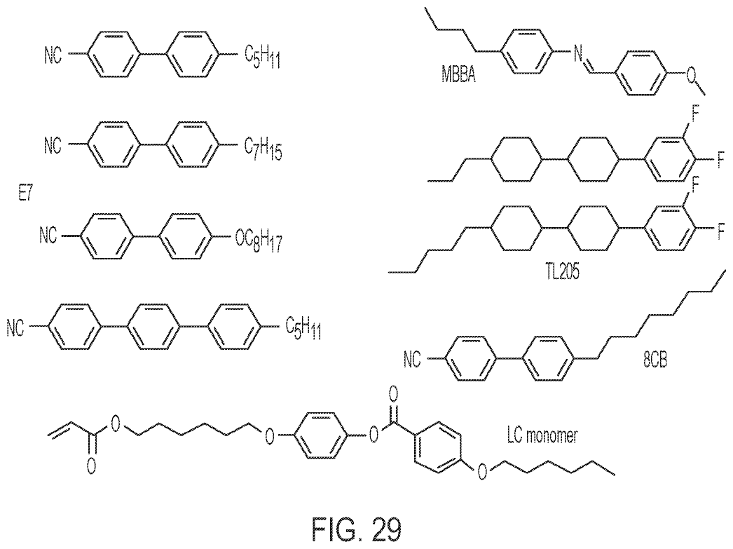

The elastic constant of nematic LCs can be varied to tune the critical size of microcapsules (R_{capsule, critical}=K/W). It is well established that the LC elastic constant decreases with an increase in the temperature (within the nematic phase temperature window) and reaches zero when the temperature reaches T_{N-I}.^{57,62} The threshold We needed to activate the microcapsule release from nematic 5CB substrates at multiple temperatures within the nematic phase (23-35° C.) were explored. The LC 5CB is one example, other nematic LCs are also suitable for the present techniques (see FIG. 29), including E₇, N-(4-methoxybenzylidene)-4-butylaniline (MBBA), TL205, MLC2080 (a proprietary mixture obtained from Merck company), and a reactive LC monomer that will be used to further cure the LC receiving substrate. Since each of these LCs has a different set of elastic constants (the average elastic constants vary from ~2 to ~20 pN), and the R_{capsule, critical} depends on the specific LC. Considering the fact that the LC elastic force depends on the elastic constants, it is contemplated that different LCs will give rise to distinct repulsive LC elastic forces and thus different threshold We for each of these LCs.

In the above experiments, the nematic phase was examined. The other LC mesophases, especially smectic A phase (where the mesogens have long-range orientational order and a one-dimensional positional order [lamellar structure]; 4′-n-octyl-4-cyano-biphenyl [8CB]) are also considered. Smectic A phases have dramatically different molecular orders and elastic constants compared to the conventional nematic phase. Because of the presence of partial positional order and ultrahigh elastic constant, smectic A phases exhibits a threshold We that is much higher than the nematic phase. As a result, microcapsules can be stored in the smectic A phase for a long time until a phase transition is conducted, allowing for further droplet impact-induced microcapsule release.

It is contemplated that the droplet impact-induced microcapsule release primarily depends on the droplet impact conditions and the LC orientational order rather than the microcapsules properties. The above results support this hypothesis and provide methods and systems to release hard-to-print ink from LC substrates to broaden the material available for inkjet printing. It is contemplated that a regime of microcapsule release behaviors for different encapsulated microcapsule viscosities, LC elastic constants, and LC mesophases upon droplet impacts with different We are possible selections for inkjet printing conditions.

Theoretical modelling of droplet impact-induced release from LC surface. The results show the effects droplet impacts have on LC orientational ordering and the consequent microcapsule release. Two characteristic behaviors of droplet impact-induced microcapsule release from LC substrates are observed: (1) LC phase-dependence-nematic LC substrates do not release microcapsules into droplets that are gently placed, We=0, on their surface, whereas isotropic LC substrates do; (2) We-dependence—a threshold We is required to trigger the microcapsule release from nematic LC substrates. Herein, theoretical models are presented to understand the effects of LC orientational ordering and droplet impacts on microcapsule release to validate the experimental observations.

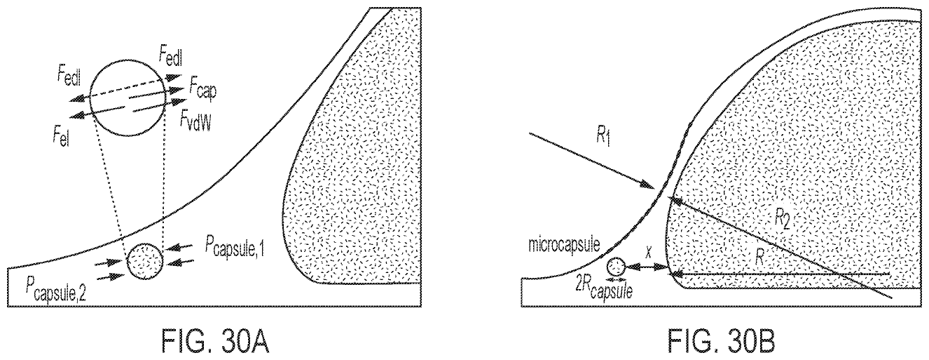

To understand how LC orientational ordering affects the first characteristic behavior, a theoretical model was developed to understand the interaction between a static water droplet and a microcapsule in the LC film. Specifically, the classic Derjaguin-Landau-Verwey-Overbeek (DLVO) model was modified by combining van der Waals force (F_{vdw}), capillary force (F_{cap}), electric double layer force (F_{edl}), and the elastic force (Fₑₗ) from the LC orientational order into a thermodynamic model to describe the essential behaviors of water droplets interacting with LC surfaces during microcapsule release (FIG. 30A).

Capillary force, F_{cap}, is induced by the fully developed, curved capillary meniscus (i.e., wetting ridge) surrounding the water droplet after impacting the LC surface provides a driving force that concentrates the microcapsules in the wetting ridge of the water droplet. At any arbitrary point in a curved LC surface, the local hydrostatic pressure P can be deduced from the Laplace pressure:⁷⁰

$$P = {P}_{a t m} + {γ}_{L C} ( - \frac{1}{{R}_{1}} + \frac{1}{{R}_{2}} ) \qquad ( 8 )$$

where Pₐₜₘ is the atmospheric pressure and R₁ and R₂ are the two principal radii of curvature, as shown in FIG. 30B. It is noted that because 1/R₁ is a negative curvature and 1/R₂ is a positive curvature, a negative and positive sign is applied to the respective terms in Equation 8.⁷⁴ A hydrostatic pressure jump across the microcapsule exists because of the curved air-LC surface:

$$Δ P = {P}_{capsule , 2} - {P}_{capsule , 1} \approx {γ}_{L C} ( \frac{1}{R + x + ξ {R}_{capsule}} - \frac{1}{R + x - ξ {R}_{capsule}} ) \approx \frac{- 2 {γ}_{L C} ξ {R}_{capsule}}{{( R + x )}^{2}} ( for R >> {R}_{c a p s u l e} ) \qquad ( 9 )$$

where x is the surface-to-surface distance between the microcapsule and water droplet, R is the radius of the water droplet on the LC surface, ξ is a coefficient used to estimate the average hydrostatic pressure acting on each hemisphere (ξ=2/3),⁷⁵ and P_{capsule,1} and P_{capsule,2} are the pressures on the side of the microcapsule closest to and farthest away from the water droplet, respectively, as seen in FIG. 30A. By multiplying ΔP by the cross-sectional area of the microcapsule, F_{cap} is obtained:

$${F}_{cap} = Δ P π {R}_{capsule}^{2} \approx - \frac{2 {γ}_{L C} π ξ {R}_{capsule}^{3}}{{( R + x )}^{2}} \qquad ( 10 )$$

The negative sign in Equation 10 indicates that F_{cap} is always attractive and acts as a driving force for microcapsule release.

The LC long-range orientational ordering-induced Fₑₗ between the microcapsule and the water droplet interface can be calculated as:⁶²

$${F}_{el} = + \frac{{δ}^{2} β π K {R}_{capsule}^{4}}{{( {R}_{capsule} + x )}^{4}} \qquad ( 11 )$$

where δ and β denote the dipole and quadrupole moments carried by the microcapsule in the LC and K denotes the Frank elastic constant of the LC. For microcapsules larger than K/W in a nematic phase LC bulk with homeotropic anchoring, δ is 2.04 and 0 for microcapsules in an isotropic phase LC bulk regardless of the radius, respectively. When the LC has a homeotropic anchoring, β is 1/2.⁵⁴ The positive sign in Equation 11 indicates that the LC elastic force is always repulsive and prevents microcapsule release.

First, the release behavior of water droplets slowly placed (We=0) on LC surfaces loaded with 5 mM SDS aqueous microcapsules of ethyl orange were observed, with no observable microcapsule release from nematic LC surfaces (FIG. 28A) and a release from isotropic LC surfaces (FIG. 28B). In the calculations, it was assumed that R_{capsule}=5 μm, R=1.75 mm for 10 μL water droplets, and K=5 pN for 5CB. In addition, the relative permittivity of the LC was 10,⁵³ Debye length was assumed to be 1.2 μm in the LC without added electrolytes.⁵⁴ The zeta potential of the microcapsules was set to −100 mV, whereas the zeta potential of a pure water droplet was set to −20 m V.^{54,76} T was set to 303 K and 313 K for the nematic and isotropic 5CB phases, respectively. The valence number of the dominant aqueous ionic species was set to 1 for the water droplet and the microcapsules, the net force (F_{vdw}+F_{cap}+F_{edl}+Fₑₗ) of a microcapsule in a nematic LC surface was calculated upon which a pure water droplet had been placed slowly (Fₛₕₑₐᵣ=0). The repulsive Fₑₗ and F_{edl} lead to a kinetic barrier (~ 25 pN) at x~100 nm that prevents the release of microcapsules, which is consistent with the experimental observations that no release occurs from a nematic LC surface. Next, the net force of a microcapsule in an isotropic LC surface with a pure water droplet slowly deposited on the surface (Fₛₕₑₐᵣ=0) was calculated. Fₑₗ was 0 when the LC was in the isotropic phase. The absence of the repulsive Fₑₗ allowed Fₙₑₜ to become negative (attractive), thus overcoming the repulsive F_{edl} and releasing the microcapsule into the water droplet.

These results confirm previous observations of LC mesophase-dependent chemical release when We is 0, which suggests that the orientational ordering of the LC plays an essential role in microcapsule release. It is contemplated that the release behavior is also effected by the size of the microcapsules, such that microcapsules with a size <K/W will not distort the orientational ordering of the surrounding nematic LC, meaning Fₑₗ=0, which may result in a release at all We numbers. In addition, the elastic constant K is varied to study the effect of different types of LCs (see FIG. 29). It is contemplated that different LCs to lead to different microcapsule size-dependent release behaviors (e.g., different K/W) and that the sign and magnitude of the zeta potential of microcapsules to investigate the effect of surface charges and microcapsules density. It is contemplated that opposite signs of zeta potential for water droplets and microcapsules will give rise to an attractive Fₑₗ (<0), which may provide another route to activate the release.

Next, a theoretical model was developed to understand the We-dependent droplet impact-induced microcapsule release behavior. It was contemplated that droplet impacts induce a flow field in the LC film that disrupts the LC ordering encapsulating the microcapsules. The effect of the impact and the LC ordering was coupled through the flow field u(x, y, t) and the LC director field d(x, y, t):

$$ρ {u}_{t} + ρ ( u \cdot ∇ ) u = ∇ \cdot ( μ ∇ u ) - ∇ p \qquad ( 12 )$$

$${d}_{t} + ∇ d \cdot u - ∇ u \cdot d = η Δ d \qquad ( 13 )$$

where ρ, μ and η are the density, dynamic viscosity, and rotational viscosity of the LC, respectively. The Navier-Stokes equation (Equation 12) describes the flow field in the LC and the Eriksen-Leslie equation (Equation 13)⁷⁷⁻⁸¹ couples the LC director field to the flow field. Solving this set of coupled partial differential equations gives rise to the stress field and the disrupted orientational order of the LC. However, the model does not rely on topological defects of the microcapsule nor the associated LC. It was assumed that a defect core is an isotropic LC phase surrounded by perpendicular anchoring of nematic LCs.⁵³

When the hydrodynamic stress induced by droplet impact is higher than the LC elastic force, the long-range LC orientation and the associated topological defects around the microcapsules are disrupted, resulting in the microcapsules release. The Eriksen number (Er), which is defined as the ratio of the viscous stress to the LC elastic stress,⁸² naturally serves as the criterion for the droplet impact-induced microcapsule release:

$$Er = μ vR / K \qquad ( 14 )$$

in which μνR is the hydrodynamic shear stress around the microcapsule (μ is the dynamic viscosity, ν is the local induced velocity, and R is the microcapsule radius). Further relating Er to We gives:

$$Er = Oh {We}^{1 / 2} {γ}_{w} R / K \qquad ( 15 )$$

To obtain the threshold Er and thus the corresponding threshold We for droplet impact-induced microcapsule release the local stress field in the LC film generated by the droplet impact was measured.⁸³ Specifically, fluorescent tracer particles were introduced into a microcapsule-loaded LC film and the particle velocity thus stress fields upon droplet impact was extracted through high-speed imaging. The droplet impact-induced stress field in the LC film (in cylindrical coordinates conforming to the droplet impact configuration) can be written as:

$$( 16 )$$

$$τ = ( \begin{matrix}{τ}_{rr} & {τ}_{r θ} & {τ}_{r z} \\ {τ}_{θ r} & {τ}_{θ θ} & {τ}_{θ z} \\ {τ}_{z r} & {τ}_{z θ} & {τ}_{zz}\end{matrix} ) = ( \begin{matrix}2 μ ( r \frac{\partial {u}_{r}}{\partial r} ) & μ ( r \frac{\partial }{\partial r} ( \frac{{u}_{θ}}{γ} ) + \frac{1}{r} \frac{\partial {u}_{r}}{\partial θ} ) & μ ( \frac{\partial {u}_{r}}{\partial z} + \frac{\partial {u}_{z}}{\partial r} ) \\ μ ( r \frac{\partial }{\partial r} ( \frac{{u}_{θ}}{r} ) + \frac{1}{r} \frac{\partial {u}_{r}}{\partial θ} ) & μ ( \frac{1}{r} \frac{\partial {u}_{θ}}{\partial r} + \frac{{u}_{r}}{r} ) & μ ( \frac{1}{r} \frac{\partial {u}_{θ}}{\partial θ} + \frac{{u}_{r}}{r} ) \\ μ ( \frac{\partial {u}_{r}}{\partial z} + \frac{\partial {u}_{z}}{\partial r} ) & μ ( \frac{1}{r} \frac{\partial {u}_{θ}}{\partial θ} + \frac{{u}_{r}}{r} ) & 2 μ ( r \frac{\partial {u}_{Z}}{\partial z} )\end{matrix} )$$

in which stress component τ_{rz} directly competes with the LC elastic forces that holds the microcapsules in place. In addition, the LC orientational ordering was imaged using a polarized light microscope.⁸⁴

The stress field analysis and the thermodynamic model were combined to calculate the global energy landscape to determine the threshold We. The initial kinetic energy (f_{KE,0}) and surface energy (f_{SE,0}) of the water droplet were dissipated during the interaction with the LC film. When the final kinetic energy (f_{KE}) was larger than the LC elastic energy, the LC orientation was disrupted, and the microcapsules released. The energy balance for the droplet after impact and the viscous dissipation (Øᵥ) are as follows:

$${f}_{KE , 0} + {f}_{S E , 0} = {f}_{KE} + {f}_{S E} + {∅}_{v} \qquad ( 17 )$$

$${∅}_{v} = 2 μ [ {( \frac{\partial {u}_{r}}{\partial r} )}^{2} + {( \frac{1}{r} \frac{\partial {u}_{θ}}{\partial θ} + \frac{{u}_{r}}{r} )}^{2} + {( \frac{\partial {u}_{z}}{\partial z} )}^{2} ] + {[ r \frac{\partial }{\partial r} ( \frac{{u}_{θ}}{r} ) + \frac{1}{r} \frac{\partial {u}_{r}}{\partial θ} ]}^{2} + {[ \frac{1}{r} \frac{\partial {u}_{z}}{\partial θ} + \frac{\partial {u}_{θ}}{\partial z} ]}^{2} + {[ \frac{\partial {u}_{r}}{\partial z} + \frac{\partial {u}_{z}}{\partial r} ]}^{2} \qquad ( 18 )$$

Assuming axial symmetry

$$( {u}_{θ} = 0 and \frac{\partial }{\partial θ} = 0 )$$

of Øᵥ, Equation 18 can be further simplified to:

$${∅}_{v} = 2 μ [ {( \frac{\partial {u}_{r}}{\partial r} )}^{2} + {( \frac{{u}_{r}}{r} )}^{2} + {( \frac{\partial {u}_{z}}{\partial z} )}^{2} ] + {[ \frac{\partial {u}_{r}}{\partial z} + \frac{\partial {u}_{z}}{\partial r} ]}^{2} \qquad ( 19 )$$

Due to the anisotropic nature of the LC film, the viscosity was assumed to be constant for different orientations and depended on the local strain. In addition, different LC molecular structures and mesophases have different models for viscosity.⁵³ Thus, care was taken for the viscosity of different LC systems when developing the above models. The model was in dimensionless forms, which provides guidance to systems not exemplified herein. The model developed here also fills the knowledge gap related to understanding mechanical stress-induced chemical release in LC systems.

Printing of polymers via chemical reactions induced by droplet impacts. The above results show the promising feasibility of printing highly viscous chemicals through a droplet impact-activated release of microcapsules from a LC film. For surface printing applications, thermosetting polymers, such as acrylate, polyurea, and polyurethane, are promising materials because of their potential applications in rapid prototyping, patterned surface fabrication, and pigment binders as overcoats.⁸⁵⁻⁸⁹ However, these finalized manufacturing polymers cannot be printed using state-of-the-art inkjet printing techniques because they are thermoset of their high viscosity.^{8,12} However, the disclosed method and system, droplet impact-induced microcapsule release from LC surfaces, can be used to print polymers. Instead of encapsulating polymers in their final state, the polymers can be synthesized in-situ using chemical reactions activated by droplets impacting the LC surface, which would allow one to tune the properties of the polymers by controlling droplet impact parameters, such as droplet volume and We, as well as the reaction stoichiometry. The chemical reactions can take place either in the bulk droplet or on the droplet surface. It is contemplated that droplet impacts can be used to conduct polymer complexation at the interfaces between the water droplet and LC films as a class of chemical reactions on droplet surfaces. Specifically, aqueous microcapsules of poly(styrene sulfonate) (PSS) and polyethylene glycol are dispersed in the LC films and a water droplet consisting of poly(diallyl dimethyl-ammonium chloride) (PDADMAC) and dextran are released. We was selected to activate the release of PSS with the expectation that the release will result in the formation of a complex between PSS and PDADMAC, which has the potential to serve as ion separation membranes. The timescale of the reaction is on the order of milliseconds (and up to seconds), which is comparable to the droplet impact process.

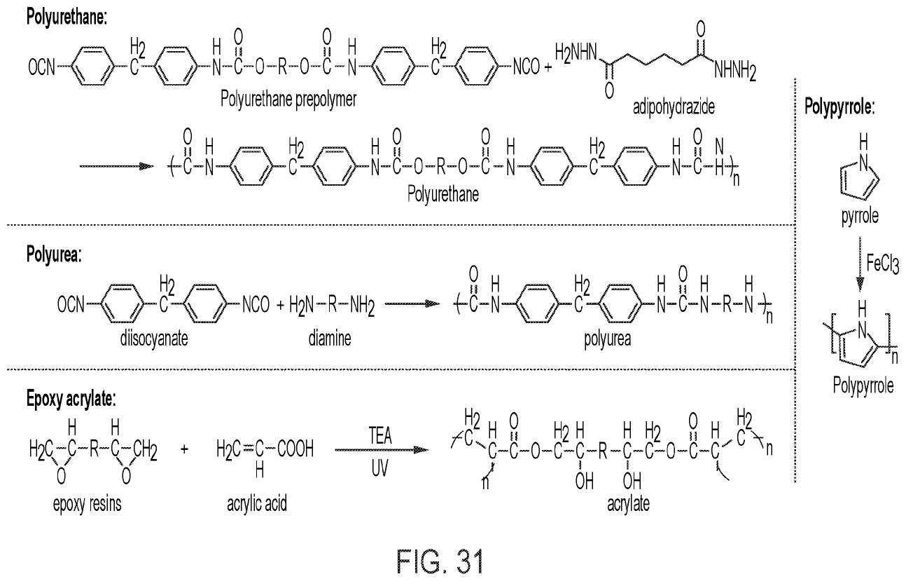

For example, droplet impacts are used to activate the synthesis of conventionally hard-to-print polymers such as polyurea, polyurethane, and epoxy acrylate and the chemical composition is tuned to control the properties of the formed polymers by adjusting the droplet impact parameters, as shown in FIG. 31. This example shows that conventional inkjet printers can be used to manufacture materials that would normally not be able to be printed.

For example, to synthesize polyurethane,⁹⁰ a waterborne polyurethane prepolymer was prepared by reacting isophorone diisocyanate, terathane 1400, dimethylolpropionic acid, 1,4-butanediol, and trimethylolpropane at 80° C. for 2 hours. Next, aqueous microcapsules of the obtained polyurethane prepolymers were trapped in the LC film and subsequently released and dissolved into the impacting aqueous droplet consisting of a crosslinker adipohydrazide and a chain extender (e.g., polyols). The droplets were dried on the LC surface at room temperature resulting in the formation of crosslinked polyurethane. Polyurea⁹¹ and epoxy acrylate⁹² were synthesized in a similar way. In the synthesis of each polymers, the weight fraction of microcapsules in the LC film was varied between 10 and 20 wt %, and the weight fraction of monomers or prepolymers dispersed in the microcapsules or impacting droplets were varied from 10 to 50 wt %. The impact droplet height and volume were varied to achieve We ranging from ~80 to 200. It is contemplated that varying the We will enable the tuning of the stoichiometry during droplet impacts, resulting in different polymer compositions that affect the physicochemical properties of the final polymers (e.g., tensile strength and glass transition temperature), as shown in FIG. 19C. The chemical structure and the thermal and mechanical properties of the prepolymers and final polymers can be characterized by gel permeation chromatography (GPC), proton nuclear magnetic resonance (¹H NMR) spectroscopy, Fourier-transform infrared spectroscopy (FTIR), thermogravimetric analysis (TGA), differential scanning calorimetry (DSC), dynamic mechanical analysis (DMA), and tensile testing.

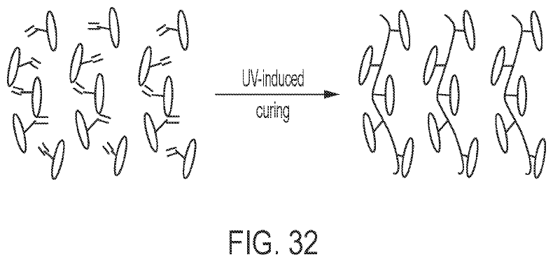

In addition, conjugated polymers, such as conducting and semiconducting polymers, have received significant attention because of their intrinsic electronic properties. Polypyrrole, as one of the most extensively investigated (semi) conducting polymers,⁹³ has been printed through traditional inkjet printing by dispensing an uncommon organic solution of pre-synthesized polypyrrole.^{94,95} However, after synthesis, polypyrrole is difficult to process as it is non-thermoplastic, and its molecular weight and composition, and thus its conductivity cannot be further tuned during the printing process. Moreover, the printed polypyrrole is difficult to separate from conventional solid receiving substrates. Here, droplet impacts were used to synthesize polypyrrole patterns on LC substrates. Instead of encapsulating pre-synthesized polymers in the LC film, pyrrole was encapsulated in the LC substrate and an aqueous droplet of ferric trichloride (as a catalyst) and p-toluenesulfonic acid (as a dopant) was released onto the LC substrate, as shown in FIG. 31. The degree of polymerization and the consequent conductivity of polypyrrole was tuned by changing the We. After printing the polypyrrole on the LC substrate, (i) UV cure the receiving substrate consisting of reactive LCs (FIGS. 19F and 32)⁹⁶ or (ii) peel off the finished product from the LC receiving substrate to obtain a free-standing 2D polypyrrole device. It was observed that nonreactive LC surfaces are slippery in the nematic phase^{37,38} which allows for easy peel off the finished product (FIG. 19F). These two methods are used to create organic electronics, biosensors, and artificial skins. The polymer structure can be characterized using FTIR, Raman spectroscopy, and x-ray diffraction (XRD), and the electronic conductivities of the polypyrrole devices can be determined using a four-point probe method.

In a final example, the material synthesis induced by droplet impacts was spatially patterned, such that different reactants can be patterned in the LC film and can all react with the chemical in the impacting droplet. Thus, different products can be formed in a programmable manner. A more versatile strategy can also be designed such that the patterning is achieved by utilizing printheads with multiple nozzles to generate droplets with different chemicals, without the need to pre-pattern the LC film. This technique will complement the current multi-material inkjet printing technique. Combined with the idea of different stoichiometry mentioned above, a material printed with a gradient in the thermal and mechanical properties can be achieved. To validate the stability of the patterned microcapsules, the thermally-induced diffusion of micrometer-sized droplets encapsulated in a LC film was estimated. The two-dimensional random diffusion of the microdroplets is calculated as: 75

$$〈 {d}^{2} 〉 = 4 Dt = \frac{2 {k}_{B} T}{3 π η a} \qquad ( 20 )$$

where <d²> is the mean square displacement, D is the diffusion coefficient, tis time, n is the viscosity of the LC (10⁻² Pa s), and a is the hydrodynamic radius of the microdroplets in the LC. The time required for lateral diffusion of a 10 μm-in-diameter microcapsule over a distance of 1 mm within the LC film is estimated to be >3×10⁴ hours. This calculation suggests that Brownian diffusion will not lead to a measurable diffusion of microcapsules loaded with different chemicals within the LC film. It is contemplated that spatial patterning using the described method and system will enable the printing of free-standing 2D polymeric devices for a wide range of applications including sensors, artificial skins, organic and wearable electronics, and electromagnetic shielding coatings.

Additional explanations and examples can be found in Xu, Y., et al, “Liquid Crystal-Based Open Surface Microfluidics Manipulate Liquid Mobility and Chemical Composition on Demand”, which incorporated herein in its entirety by reference.³⁷

Discussion Although controlled microcapsule release from LC films has been achieved using external stimuli, such as heat and light, droplet impact-induced microcapsule release has never been observed before. It is shown that the droplet impact-induced microcapsule release depends on both the LC mesophase and We. The disclosed examples revealed the intricate interplay between LC mesophases, long-range LC elasticity, and droplet impact-induced stresses. Additionally, the theoretical models create practical means to accurately predict the microcapsule release behavior by determining a set of release criteria. The release process is independent of the properties of the constituent chemicals of the microcapsules, such as viscosity, which leads to new mechanisms for droplet impact-induced ‘printing’ of conventionally hard-to-print materials, such as highly viscous liquids and thermosetting polymers. Finally, the intrinsic slipperiness of nematic LCs enables the printed polymers to be easily peeled off, which provides for printing free-standing, organic electronic devices.

### REFERENCES

(1) Lohse, D. Fundamental Fluid Dynamics Challenges in Inkjet Printing. Annu. Rev. Fluid Mech. 2022, 54, 349-382. https://doi.org/10.1146/ANNUREV-FLUID-022321-114001.
(2) Derby, B. Inkjet Printing of Functional and Structural Materials: Fluid Property Requirements, Feature Stability, and Resolution. Annu. Rev. Mater. Res. 2010, 40, 395-414. https://doi.org/10.1146/ANNUREV-MATSCI-070909-104502.
(3) Guo, Y.; Patanwala, H. S.; Bognet, B.; Ma, A. W. K. Inkjet and Inkjet-Based 3D Printing: Connecting Fluid Properties and Printing Performance. Rapid Prototyp. J. 2017, 23 (3), 562-576. https://doi.org/10.1108/RPJ-05-2016-0076/FULL/PDF.
(4) Gilani, N.; Aboulkhair, N. T.; Simonelli, M.; East, M.; Ashcroft, I.; Hague, R. J. M. Insights into Drop-on-Demand Metal Additive Manufacturing through an Integrated Experimental and Computational Study. Addit. Manuf. 2021, 48, 102402. https://doi.org/10.1016/J.ADDMA.2021.102402.
(5) Derby, B. Inkjet Printing Ceramics: From Drops to Solid. J. Eur. Ceram. Soc. 2011, 31 (14), 2543-2550. https://doi.org/10.1016/J.JEURCERAMSOC.2011.01.016.
(6) Tekin, E.; Smith, P. J.; Schubert, U. S. Inkjet Printing as a Deposition and Patterning Tool for Polymers and Inorganic Particles. Soft Matter 2008, 4 (4), 703-713. https://doi.org/10.1039/B711984D.
(7) Ngo, T. D.; Kashani, A.; Imbalzano, G.; Nguyen, K. T. Q.; Hui, D. Additive Manufacturing (3D Printing): A Review of Materials, Methods, Applications and Challenges. Compos. B. Eng. 2018, 143, 172-196. https://doi.org/10.1016/J.COMPOSITESB.2018.02.012.
(8) Singh, M.; Haverinen, H. M.; Dhagat, P.; Jabbour, G. E. Inkjet Printing-Process and Its Applications. Adv. Mater. 2010, 22 (6), 673-685. https://doi.org/10.1002/ADMA.200901141.
(9) Seifert, T.; Sowade, E.; Roscher, F.; Wiemer, M.; Gessner, T.; Baumann, R. R. Additive Manufacturing Technologies Compared: Morphology of Deposits of Silver Ink Using Inkjet and Aerosol Jet Printing. Ind. Eng. Chem. Res. 2015, 54 (2), 769-779. https://doi.org/10.1021/IE503636C/SUPPL_FILE/IE503636C_SI_001.PDF.
(10) Wijshoff, H. The Dynamics of the Piezo Inkjet Printhead Operation. Phys. Rep. 2010, 491 (4-5), 77-177. https://doi.org/10.1016/J.PHYSREP.2010.03.003.
(11) Hansen, C. J.; Saksena, R.; Kolesky, D. B.; Vericella, J. J.; Kranz, S. J.; Muldowney, G. P.; Christensen, K. T.; Lewis, J. A. High-Throughput Printing via Microvascular Multinozzle Arrays. Adv. Mater. 2013, 25 (1), 96-102. https://doi.org/10.1002/ADMA.201203321.
(12) de Gans, B. J.; Duineveld, P. C.; Schubert, U. S. Inkjet Printing of Polymers: State of the Art and Future Developments. Adv. Mater. 2004, 16 (3), 203-213. https://doi.org/10.1002/ADMA.200300385.
(13) Xu, C.; An, C.; Long, Y.; Li, Q.; Guo, H.; Wang, S.; Wang, J. Inkjet Printing of Energetic Composites with High Density. RSC Adv. 2018, 8 (63), 35863-35869. https://doi.org/10.1039/C8RA06610H.
(14) Basaran, O. A.; Gao, H.; Bhat, P. P. Nonstandard Inkjets. Annu. Rev. Fluid Mech. 2013, 45, 85-113. https://doi.org/10.1146/ANNUREV-FLUID-120710-101148.
(15) Castrejón-Pita, J. R.; Baxter, W. R. S.; Morgan, J.; Temple, S.; Martin, G. D.; Hutchings, I. M. Future, Opportunities and Challenges of Inkjet Technologies. At. Sprays 2013, 23 (6), 571-595. https://doi.org/10.1615/ATOMIZSPR.2013007653.
(16) Hoath, S. D.; Jung, S.; Hsiao, W. K.; Hutchings, I. M. How PEDOT:PSS Solutions Produce Satellite-Free Inkjets. Org. Electron. 2012, 13 (12), 3259-3262. https://doi.org/10.1016/J.θRGEL.2012.10.004.
(17) Saleh, E.; Zhang, F.; He, Y.; Vaithilingam, J.; Fernandez, J. L.; Wildman, R.; Ashcroft, I.; Hague, R.; Dickens, P.; Tuck, C. 3D Inkjet Printing of Electronics Using UV Conversion. Adv. Mater. Technol. 2017, 2 (10), 1700134. https://doi.org/10.1002/ADMT.201700134.
(18) Davoodi, E.; Fayazfar, H.; Liravi, F.; Jabari, E.; Toyserkani, E. Drop-on-Demand High-Speed 3D Printing of Flexible Milled Carbon Fiber/Silicone Composite Sensors for Wearable Biomonitoring Devices. Addit. Manuf. 2020, 32, 101016. https://doi.org/10.1016/J.ADDMA.2019.101016.
(19) Choi, J.; Kim, Y. J.; Lee, S.; Son, S. U.; Ko, H. S.; Nguyen, V. D.; Byun, D. Drop-on-Demand Printing of Conductive Ink by Electrostatic Field Induced Inkjet Head. Appl. Phys. Lett. 2008, 93 (19), 193508. https://doi.org/10.1063/1.3020719.
(20) Lessing, J.; Glavan, A. C.; Walker, S. B.; Keplinger, C.; Lewis, J. A.; Whitesides, G. M. Inkjet Printing of Conductive Inks with High Lateral Resolution on Omniphobic “RF Paper” for Paper-Based Electronics and MEMS. Adv. Mater. 2014, 26 (27), 4677-4682. https://doi.org/10.1002/ADMA.201401053.
(21) Wang, L.; Liu, J. Advances in the Development of Liquid Metal-Based Printed Electronic Inks. Front. Mater. 2019, 6, 303. https://doi.org/10.3389/FMATS.2019.00303/BIBTEX.
(22) Derby, B. Additive Manufacture of Ceramics Components by Inkjet Printing. Engineering 2015, 1 (1), 113-123. https://doi.org/10.15302/J-ENG-2015014.
(23) Simonelli, M.; Aboulkhair, N.; Rasa, M.; East, M.; Tuck, C.; Wildman, R.; Salomons, O.; Hague, R. Towards Digital Metal Additive Manufacturing via High-Temperature Drop-on-Demand Jetting. Addit. Manuf. 2019, 30, 100930. https://doi.org/10.1016/J.ADDMA.2019.100930.
(24) Kim, Y. K.; Park, J. A.; Yoon, W. H.; Kim, J.; Jung, S. Drop-on-Demand Inkjet-Based Cell Printing with 30-Mm Nozzle Diameter for Cell-Level Accuracy. Biomicrofluidics 2016, 10 (6), 064110. https://doi.org/10.1063/1.4968845.
(25) Hausmann, M. K.; Siqueira, G.; Libanori, R.; Kokkinis, D.; Neels, A.; Zimmermann, T.; Studart, A. R. Complex-Shaped Cellulose Composites Made by Wet Densification of 3D Printed Scaffolds. Adv. Funct. Mater. 2020, 30 (4), 1904127. https://doi.org/10.1002/ADFM.201904127.
(26) Xu, C.; Zhang, M.; Huang, Y.; Ogale, A.; Fu, J.; Markwald, R. R. Study of Droplet Formation Process during Drop-on-Demand Inkjetting of Living Cell-Laden Bioink. Langmuir 2014, 30 (30), 9130-9138. https://doi.org/10.1021/LA501430X/ASSET/IMAGES/MEDIUM/LA-2014-01430X_0011.GIF.
(27) Barui, S. 3D Inkjet Printing of Biomaterials: Principles and Applications. Med. Devices Sensors 2021, 4 (1), e10143. https://doi.org/10.1002/MDS3.10143.
(28) Sen, K.; Manchanda, A.; Mehta, T.; Ma, A. W. K.; Chaudhuri, B. Formulation Design for Inkjet-Based 3D Printed Tablets. Int. J. Pharm. 2020, 584, 119430. https://doi.org/10.1016/J.IJPHARM.2020.119430.
(29) Trondle, K.; Koch, F.; Finkenzeller, G.; Stark, G. B.; Zengerle, R.; Koltay, P.; Zimmermann, S. Bioprinting of High Cell-Density Constructs Leads to Controlled Lumen Formation with Self-Assembly of Endothelial Cells. J. Tissue Eng. Regen. Med. 2019, 13 (10), 1883-1895. https://doi.org/10.1002/TERM.2939.
(30) Cader, H. K.; Rance, G. A.; Alexander, M. R.; Gonçalves, A. D.; Roberts, C. J.; Tuck, C. J.; Wildman, R. D. Water-Based 3D Inkjet Printing of an Oral Pharmaceutical Dosage Form. Int. J. Pharm. 2019, 564, 359-368. https://doi.org/10.1016/J.IJPHARM.2019.04.026.
(31) Lohse, D. Fundamental Fluid Dynamics Challenges in Inkjet Printing. Annu. Rev. Fluid Mech. 2022, 54, 349-382. https://doi.org/10.1146/ANNUREV-FLUID-022321-114001.
(32) van der Meulen, M. J.; Reinten, H.; Wijshoff, H.; Versluis, M.; Lohse, D.; Steen, P. Nonaxisymmetric Effects in Drop-on-Demand Piezoacoustic Inkjet Printing. Phys. Rev. Appl. 2020, 13 (5), 054071. https://doi.org/10.1103/PHYSREVAPPLIED.13.054071/FIGURES/11/MEDIUM.
(33) Barui, S.; Mandal, S.; Basu, B. Thermal Inkjet 3D Powder Printing of Metals and Alloys: Current Status and Challenges. Curr. Opin. Biomed. Eng. 2017, 2, 116-123. https://doi.org/10.1016/J.COBME.2017.05.010.
(34) Clasen, C.; Phillips, P. M.; Palangetic, L.; Vermant, and J. Dispensing of Rheologically Complex Fluids: The Map of Misery. AIChE J. 2012, 58 (10), 3242-3255. https://doi.org/10.1002/AIC.13704.
(35) Liu, Y.; Derby, B. Experimental Study of the Parameters for Stable Drop-on-Demand Inkjet Performance. Phys. Fluids 2019, 31 (3), 032004. https://doi.org/10.1063/1.5085868.
(36) Mckinley, G. H.; Renardy, M. Wolfgang von Ohnesorge. Phys. Fluids 2011, 23 (12), 127101. https://doi.org/10.1063/1.3663616.
(37) Xu, Y.; Rather, A. M.; Yao, Y.; Fang, J. C.; Mamtani, R. S.; Bennett, R. K. A.; Atta, R. G.; Adera, S.; Tkalec, U.; Wang, X. Liquid Crystal-Based Open Surface Microfluidics Manipulate Liquid Mobility and Chemical Composition on Demand. Sci. Adv. 2021, 7 (40). https://doi.org/10.1126/SCIADV.ABI7607/SUPPL_FILE/SCIADV.ABI7607_MOVIES_S1_TO_S6.ZIP.
(38) Xu, Y.; Chang, Y.; Yao, Y.; Zhang, M.; Dupont, R. L.; Rather, A. M.; Bao, X.; Wang, X. Modularizable Liquid-Crystal-Based Open Surfaces Enable Programmable Chemical Transport and Feeding Using Liquid Droplets. Adv. Mater. 2022, 2108788. https://doi.org/10.1002/ADMA.202108788.
(39) Wang, X.; Sun, H.; Kim, Y.-K.; Wright, D. B.; Tsuei, M.; Gianneschi, N. C.; Abbott, N. L. Stimuli-Responsive Liquid Crystal Printheads for Spatial and Temporal Control of Polymerization. Adv. Mater. 2022, 34 (12), 2106535. https://doi.org/10.1002/ADMA.202106535.
(40) Neitzel, G. P.; Dell′aversana, P. Noncoalescence and Nonwetting Behavior of Liquids. Annu. Rev. Fluid Mech. 2001, 34, 267-289.
(41) Rein, M. Phenomena of Liquid Drop Impact on Solid and Liquid Surfaces. Fluid Dyn. Res. 1993, 12, 61-93.
(42) Josserand, C.; Thoroddsen, S. T. Drop Impact on a Solid Surface. Annu. Rev. Fluid Mech. 2016, 48, 365-391. https://doi.org/10.1146/annurev-fluid-122414-034401.
(43) Liang, G.; Mudawar, I. Review of Mass and Momentum Interactions during Drop Impact on a Liquid Film. Int. J. Heat Mass Transf. 2016, 101, 577-599. https://doi.org/10.1016/j.ijheatmasstransfer.2016.05.062.
(44) Yarin, A. L. Drop Impact Dynamics: Splashing, Spreading, Receding, Bouncing. Annu. Rev. Fluid Mech. 2006, 38, 159-192.
(45) Tang, X.; Saha, A.; Law, C. K.; Sun, C. Nonmonotonic Response of Drop Impacting on Liquid Film: Mechanism and Scaling. Soft Matter 2016, 12 (20), 4521-4529. https://doi.org/10.1039/c6sm00397d.
(46) Tang, X.; Saha, A.; Law, C. K.; Sun, C. Bouncing-to-Merging Transition in Drop Impact on Liquid Film: Role of Liquid Viscosity. Langmuir 2018, 34 (8), 2654-2662. https://doi.org/10.1021/acs.langmuir.7b03936.
(47) Howison, S. D.; Ockendon, J. R.; Oliver, J. M.; Purvis, R.; Smith, F. T. Droplet Impact on a Thin Fluid Layer. J. Fluid Mech. 2005, 542, 1-23. https://doi.org/10.1017/S0022112005006282.
(48) Thoroddsen, S. T.; Thoraval, M. J.; Takehara, K.; Etoh, T. G. Droplet Splashing by a Slingshot Mechanism. Phys. Rev. Lett. 2011, 106 (3), 034501. https://doi.org/10.1103/PhysRevLett.106.034501.
(49) Kittel, H. M.; Roisman, I. v.; Tropea, C. Splash of a Drop Impacting onto a Solid Substrate Wetted by a Thin Film of Another Liquid. Phys. Rev. Fluids 2018, 7 (3), 073601. https://doi.org/10.1103/PhysRevFluids.3.073601.
(50) Saha, A.; Wei, Y.; Tang, X.; Law, C. K. Kinematics of Vortex Ring Generated by a Drop upon Impacting a Liquid Pool. J. Fluid Mech. 2019, 875, 842-853. https://doi.org/10.1017/jfm.2019.503.
(51) Demus, D.; Goodby, J.; Gray, G. W.; Spiess, H.-W.; Vill, V. Handbook of Liquid Crystals; Wiley-VCH Verlag GmbH: New York, 1998.
(52) Luo, Y.; Beller, D. A.; Boniello, G.; Serra, F.; Stebe, K. J. Tunable Colloid Trajectories in Nematic Liquid Crystals near Wavy Walls. Nat. Commun. 2018, 9 (1), 1-11. https://doi.org/10.1038/s41467-018-06054-y.
(53) Kléman, M.; Lavrentovich, O. D. Soft Matter Physics: An Introduction; Springer Science and Business Media, 2007.
(54) Kim, Y. K.; Wang, X.; Mondkar, P.; Bukusoglu, E.; Abbott, N. L. Self-Reporting and Self-Regulating Liquid Crystals. Nature 2018, 557 (7706), 539-544. https://doi.org/10.1038/s41586-018-0098-y.
(55) Zhan, Y.; Zhou, G.; Lamers, B. A. G.; Visschers, F. L. L.; Hendrix, M. M. R. M.; Broer, D. J.; Liu, D. Artificial Organic Skin Wets Its Surface by Field-Induced Liquid Secretion. Matter 2020, 3 (3), 782-793. https://doi.org/10.1016/J.MATT.2020.05.015.
(56) Wood, T. A.; Lintuvuori, J. S.; Schofield, A. B.; Marenduzzo, D.; Poon, W. C. K. A Self-Quenched Defect Glass in a Colloid-Nematic Liquid Crystal Composite. Science 2011, 334 (6052), 79-83. https://doi.org/10.1126/SCIENCE.1209997/SUPPL_FILE/1209997.WOOD.SOM.PDF.
(57) Pishnyak, O. P.; Tang, S.; Kelly, J. R., Shiyanovskii, S. V.; Lavrentovich, O. D. Levitation, Lift, and Bidirectional Motion of Colloidal Particles in an Electrically Driven Nematic Liquid Crystal. Phys. Rev. Lett. 2007, 99 (12), 127802. https://doi.org/10.1103/PHYSREVLETT.99.127802/FIGURES/4/MEDIUM.
(58) Poulin, P.; Stark, H.; Lubensky, T. C.; Weitz, D. A. Novel Colloidal Interactions in Anisotropic Fluids. Science 1997, 275 (5307), 1770-1773. https://doi.org/10.1126/SCIENCE.275.5307.1770.
(59) Muševič, I.; Škarabot, M.; Tkalec, U.; Ravnik, M.; Žumer, S. Two-Dimensional Nematic Colloidal Crystals Self-Assembled by Topological Defects. Science 2006, 313 (5789), 954-958. https://doi.org/10.1126/SCIENCE.1129660/SUPPL_FILE/MUSEVIC.SOM.PDF.
(60) Lin, I. H.; Miller, D. S.; Bertics, P. J.; Murphy, C. J.; de Pablo, J. J.; Abbott, N. L. Endotoxin-Induced Structural Transformations in Liquid Crystalline Droplets. Science 2011, 332 (6035), 1297-1300. https://doi.org/10.1126/SCIENCE.1195639/SUPPL_FILE/LIN.SOM.PDF.
(61) Anyfantakis, M.; Jampani, V. S. R.; Kizhakidathazhath, R.; Binks, B. P.; Lagerwall, J. P. F. Responsive Photonic Liquid Marbles. Angew. Chem. Int. Ed. 2020, 132 (43), 19422-19429. https://doi.org/10.1002/ANGE.202008210.
(62) Chernyshuk, S. B.; Lev, B. I. Theory of Elastic Interaction of Colloidal Particles in Nematic Liquid Crystals near One Wall and in the Nematic Cell. Phys. Rev. E 2011, 84 (1), 011707. https://doi.org/10.1103/PHYSREVE.84.011707/FIGURES/23/MEDIUM.
(63) Gupta, J. K.; Sivakumar, S.; Caruso, F.; Abbott, N. L. Size-Dependent Ordering of Liquid Crystals Observed in Polymeric Capsules with Micrometer and Smaller Diameters. Angew. Chem. Int. Ed. 2009, 48 (9), 1652-1655. https://doi.org/10.1002/ANIE.200804500.
(64) Drzaic, P. S. Liquid Crystal Dispersions; World Scientific Publishing Company: Singapore, 1995.
(65) Yang, Z.; Abbott, N. L. Spontaneous Formation of Water Droplets at Oil-Solid Interfaces. Langmuir 2010, 26 (17), 13797-13804. https://doi.org/10.1021/LA101740P/SUPPL_FILE/LA101740P_SI_001.PDF.
(66) Manna, U.; Lynn, D. M.; Manna, U.; Lynn, D. M. Fabrication of Liquid-Infused Surfaces Using Reactive Polymer Multilayers: Principles for Manipulating the Behaviors and Mobilities of Aqueous Fluids on Slippery Liquid Interfaces. Adv. Mater. 2015, 27 (19), 3007-3012. https://doi.org/10.1002/ADMA.201500893.
(67) Wang, Z.; Xu, Q.; Wang, L.; Heng, L.; Jiang, L. Temperature-Induced Switchable Interfacial Interactions on Slippery Surfaces for Controllable Liquid Manipulation. J. Mater. Chem. A 2019, 7 (31), 18510-18518. https://doi.org/10.1039/C9TA05164C.
(68) Liu, M.; Wang, S.; Jiang, L. Nature-Inspired Superwettability Systems. Nat. Rev. Mater. 2017, 2 (7), 1-17. https://doi.org/10.1038/natrevmats.2017.36.
(69) Gao, L.; McCarthy, T. J. Contact Angle Hysteresis Explained. Langmuir 2006, 22 (14), 6234-6237. https://doi.org/10.1021/LA060254J/ASSET/IMAGES/MEDIUM/LA060254JN00001.GIF.
(70) de Gennes, P.-G.; Brochard-Wyart, F.; Quéré, D. Capillarity and Wetting Phenomena; Springer New York, 2004. https://doi.org/10.1007/978-0-387-21656-0.
(71) Li, J.; Ueda, E.; Paulssen, D.; Levkin, P. A. Slippery Lubricant-Infused Surfaces: Properties and Emerging Applications. Adv. Funct. Mater. 2019, 29 (4), 1802317. https://doi.org/10.1002/ADFM.201802317.
(72) Wong, T. S.; Kang, S. H.; Tang, S. K. Y.; Smythe, E. J.; Hatton, B. D.; Grinthal, A.; Aizenberg, J. Bioinspired Self-Repairing Slippery Surfaces with Pressure-Stable Omniphobicity. Nature 2011, 477 (7365), 443-447. https://doi.org/10.1038/nature10447.
(73) Takamura, K.; Fischer, H.; Morrow, N. R. Physical Properties of Aqueous Glycerol Solutions. J. Pet. Sci. Eng. 2012, 98-99, 50-60. https://doi.org/10.1016/J.PETROL.2012.09.003.
(74) Kreder, M. J.; Daniel, D.; Tetreault, A.; Cao, Z.; Lemaire, B.; Timonen, J. V. I.; Aizenberg, J. Film Dynamics and Lubricant Depletion by Droplets Moving on Lubricated Surfaces. Phys. Rev. X 2018, 8 (3), 031053. https://doi.org/10.1103/PHYSREVX.8.031053/FIGURES/13/MEDIUM.
(75) Israelachvili, J. N. Intermolecular and Surface Forces, Elsevier.; 2011.
(76) Moayedi, H.; Asadi, A.; Moayedi, F.; K Huat, B. B.; Wee Chea, L. Optimizing Stabilizers Enhanced Electrokinetic Environment to Improve Physicochemical Properties of Highly Organic Soil. Int. J. Electrochem. Sci 2011, 6, 1277-1293.
(77) Bukusoglu, E.; Pantoja, M. B.; Mushenheim, P. C.; Wang, X.; Abbott, N. L. Design of Responsive and Active (Soft) Materials Using Liquid Crystals. Annu. Rev. Chem. Biomol. Eng. 2016, 7, 163-196. https://doi.org/10.1146/ANNUREV-CHEMBIOENG-061114-123323.
(78) Liu, C.; Shen, J.; Yang, X. Dynamics of Defect Motion in Nematic Liquid Crystal Flow: Modeling and Numerical Simulation. Commun. Comput. Phys. 2007, 2 (6), 1184-1198.
(79) Cheng, C. H. A.; Kellogg, L. H.; Shkoller, S.; Turcotte, D. L. A Liquid-Crystal Model for Friction. Proc. Natl. Acad. Sci. USA. 2008, 105 (23), 7930-7935. https://doi.org/10.1073/PNAS.0710990105.
(80) Stark, H.; Ventzki, D. Non-Linear Stokes Drag of Spherical Particles in a Nematic Solvent. Europhys. Lett. 2002, 57 (1), 60. https://doi.org/10.1209/EPL/I2002-00541-0.
(81) Kos, Ž.; Ravnik, M. Field Generated Nematic Microflows via Backflow Mechanism. Sci. Rep. 2020, 10 (1), 1-10. https://doi.org/10.1038/s41598-020-57944-5.
(82) Larson, R. G.; Mead, D. W. The Ericksen Number and Deborah Number Cascades in Sheared Polymeric Nematics. Liq. Cryst. 2007, 15 (2), 151-169. https://doi.org/10.1080/02678299308031947.
(83) Sun, T.-P.; Alvarez-Novoa, F.; Andrade, K.; Gutiérrez, P.; Gordillo, L.; Cheng, X. Stress Distribution and Surface Shock Wave of Drop Impact. Nat. Commun. 2022, 13 (1), 1-8. https://doi.org/10.1038/s41467-022-29345-x.
(84) Matham, M. V.; Wong, T.; Shinoj, V. K.; Huang, Y. Particle Free Optical Imaging of Flow Field by Liquid Crystal Polarization. Opt. Express 2018, 26 (8), 10452-10461. https://doi.org/10.1364/OE.26.010452.
(85) Izdebska, J.; Thomas, S. Printing on Polymers: Fundamentals and Applications, Elsevier, 2016.
(86) El-Molla, M. M. Synthesis of Polyurethane Acrylate Oligomers as Aqueous UV-Curable Binder for Inks of Ink Jet in Textile Printing and Pigment Dyeing. Dyes Pigm. 2007, 74 (2), 371-379. https://doi.org/10.1016/J.DYEPIG.2006.02.021.
(87) Fan, H.; Lu, Y.; Stump, A.; Reed, S. T.; Baer, T.; Schunk, R.; Perez-Luna, V.; López, G. P.; Brinker, C. J. Rapid Prototyping of Patterned Functional Nanostructures. Nature 2000, 405 (6782), 56-60. https://doi.org/10.1038/35011026.
(88) Yuan, M.; Wang, S.; Li, G.; He, S.; Liu, W.; Liu, H.; Huang, M.; Zhu, C. UV Curable Hyperbranched Polyester Polyurethane Acrylate for Hydraulic Machinery Coating. Mater. Res. Express 2021, 8 (3), 035104. https://doi.org/10.1088/2053-1591/ABECCE.
(89) Xu, J.; Qiu, F.; Rong, X.; Dai, Y.; Yang, D. Preparation and Surface Pigment Protection Application of Stone Substrate on UV-Curable Waterborne Polyurethane-Acrylate Coating. J. Polym. Mater 2014, 31 (3), 287-303.
(90) Akindoyo, J. O.; Beg, M. D. H.; Ghazali, S.; Islam, M. R.; Jeyaratnam, N.; Yuvaraj, A. R. Polyurethane Types, Synthesis and Applications—a Review. RSC Adv. 2016, 6 (115), 114453-114482. https://doi.org/10.1039/C6RA14525F.
(91) Yamaguchi, I.; Miya, K. I.; Osakada, K.; Yamamoto, T. Synthesis of Polyurea Rotaxanes Using a Cyclodextrin Complex of α, ω-Diamine. Polym. Bull. 2000, 44 (3), 247-253. https://doi.org/10.1007/S002890050599.
(92) Wang, Y., Cao, Z., Liu, F., Xue, X. Synthesis and Characterization of UV-Curing Epoxy Acrylate Coatings Modified with Organically Modified Rectorite. J. Coat. Technol. Res. 2017, 14, 107-115. https://doi.org/10.1007/s11998-016-9832-2
(93) Chondath, S. K.; Menamparambath, M. M. Interface-Assisted Synthesis: A Gateway to Effective Nanostructure Tuning of Conducting Polymers. Nanoscale Adv. 2021, 3 (4), 918-941. https://doi.org/10.1039/DONA00940G.
(94) Qi, G.; Wu, Z.; Wang, H. Highly Conductive and Semitransparent Free-Standing Polypyrrole Films Prepared by Chemical Interfacial Polymerization. J. Mater. Chem. C 2013, 1 (42), 7102-7110. https://doi.org/10.1039/C3TC31340A.
(95) Mabrook, M. F.; Pearson, C.; Petty, M. C. Inkjet-Printed Polypyrrole Thin Films for Vapour Sensing. Sens. Actuators B Chem. 2006, 115 (1), 547-551. https://doi.org/10.1016/J.SNB.2005.10.019.
(96) Xu, Y.; Dupont, R. L.; Yao, Y.; Zhang, M.; Fang, J.-C.; Wang, X. Random Liquid Crystalline Copolymers Consisting of Prolate and Oblate Liquid Crystal Monomers. Macromolecules 2021, 54 (12), 5376-5387. https://doi.org/10.1021/acs.macromol.1c00006.
(97) Scientific Thinkers https://μ.osu.edu/cemscientificthinkers/(accessed 2021 Jul. 20).
(98) Translating Engineering Research K-8 https://μ.osu.edu/tek8/(accessed 2021 Jul. 20).
(99) Young Scholar's Program (YSP)—Center for STEM Education https://stem.northeastern.edu/summer/ysp/(accessed 2022 Apr. 23).
(100) UPLIFT-Center for STEM Education https://stem.northeastern.edu/programs/ayp/uplift/(accessed 2022 Apr. 23).
(101) Diversity, Equity δ Inclusion Resources https://engineering.osu.edu/diversity-equity-inclusion-resources (accessed 2021 Jul. 20).
(102) Academic Services https://engineering.osu.edu/diversity-inclusion/academic-services (accessed 2021 Jul. 20).
(103) Society of Women Engineers—Northeastern University Student Chapter https://www.northeastern.edu/swe/(accessed 2022 Apr. 23).
(104) Women in Engineering Program-Northeastern University College of Engineering https://coe.northeastern.edu/about/coe-diversity/women-in-engineering-program/(accessed 2022 Apr. 23).
(105) Women's Research Engagement Network—Northeastern University https://www.northeasterniwc.org/wren (accessed 2022 Apr. 23).

What is claimed is:

1. A method for printing comprising:
dispensing an aqueous droplet from a source; and
impacting of the aqueous droplet onto a top surface of a receiving substrate, wherein the receiving substrate comprises a first printing material;
wherein an impact of the aqueous droplet causes the first printing material to transfer from the receiving substrate to the aqueous droplet.

2. The method of claim 1, wherein the receiving substrate further comprises:
a supporting substrate;
a porous polymer layer having a surface, wherein the porous polymer layer comprises a continuous phase permeated by a plurality of pores, and wherein the continuous phase comprises a liquid crystal polymer; and
an anisotropic lubricant infused within and over the porous polymer layer, such that that the anisotropic lubricant at least partially fills the plurality of pores and forms a film on the surface of the porous polymer layer, wherein the anisotropic lubricant comprises thermotropic liquid crystal mesogen and the first printing material.

3. The method of claim 2, wherein the liquid crystal polymer is derived from 1,4-Bis-[4-(3-acryloyloxypropyloxy)benzoyloxy]-2-methylbenzene (RM257), 4-(6-acryloxy-hex-1-yl-oxy) phenyl 4-(hexyloxy)benzoate, 4-methoxybenzoic acid 4-(6-acryloyloxyhexyloxy) phenyl ester 4″-acryloyloxybutyl 2,5-di(4′-butyloxybenzoyloxy) benzoate, or combinations thereof.

4. The method of claim 2 or 3, wherein the thermotropic liquid crystal mesogen comprises 4-cyano-4′-n-pentyl-biphenyl (5CB), 4-cyano-4′-n-heptyl-biphenyl (7CB), 4′-octyl-4-biphenylcarbonitrile (8CB), 4-cyano-4′-oxyoctyl-biphenyl (8OCB), 4-cyano-4′-n-pentyl-terphenyl (5CT), (S)-4-Cyano-4′-(2-methylbutyl)biphenyl (CB15), or a combination thereof.

5. The method of any one of claims 2-4, wherein the thermotropic liquid crystal mesogen has:
a crystal mesophase when the thermotropic liquid crystal mesogen is at a temperature that is less than a first transition temperature, wherein when the thermotropic liquid crystal mesogen is in the crystal mesophase the thermotropic liquid crystal mesogen has long range orientational order and three dimensional positional order;
a smectic mesophase when the thermotropic liquid crystal mesogen is at a temperature greater than the first transition temperature and less than a second transition temperature, wherein the second transition temperature is greater than the first transition temperature, and wherein the smectic mesophase has long range orientational order and at least unidirectional positional order;
a nematic mesophase when the thermotropic liquid crystal mesogen is at a temperature greater than the second transition temperature and less than a third transition temperature, wherein the third transition temperature is greater than the second transition temperature, and wherein the nematic mesophase has long range orientational order and no positional order; and
an isotropic mesophase when the thermotropic liquid crystal mesogen is at a temperature above a second transition temperature, and wherein the isotropic mesophase has no orientational order and no positional order.

6. The method of claim 5, further comprising changing a temperature of the receiving substrate resulting in a mesophase change of the liquid crystal mesogen.

7. The method of any one of claims 1-6, wherein the first printing material comprises a microparticle in an aqueous solution.

8. The method of any one of claims 2-7, wherein the first printing material is present as an emulsion in the anisotropic lubricant.

9. The method of any one of claims 1-8, wherein the first printing material comprises one or more of a polymer, a biologic material, a dye, a salt, a surfactant, an ionic liquid, or a colloidal dispersion of inorganic, organic, or metallic molecules, or combinations thereof.

10. The method of any one of claims 1-9, wherein an aqueous droplet density, a height of the source from the top surface of the receiving substrate, and/or a diameter of droplet of the aqueous droplet are varied to achieve an optimal Weber number.

11. The method of claim 10, wherein the optimal Weber number is 10 to 200.

12. The method of any one of claims 1-11, wherein the source of the aqueous droplet is configured to dispense aqueous printing liquid droplets of 10 nL to 1 mL.

13. The method of any one of claims 1-12, wherein the first printing material has a viscosity of 1 cP to 10⁶ cP.

14. The method of any one of claims 1-13, wherein the receiving substrate comprises up to 40% by volume of the first printing material.

15. The method of any one of claims 1-14, wherein the aqueous droplet comprises one or more activating or reactive species, wherein an activating or reactive species is activating and/or reactive with the first printing material.

16. The method of any one of claims 1-15, wherein the receiving substrate comprises a second printing material, and wherein the receiving substrate comprises up to 40% by volume of the first printing material and the second printing material.

17. The method of claim 16, wherein the aqueous droplet comprises one or more activating or reactive species, wherein an activating or reactive species is activating and/or reactive with the first printing material and the second printing material.

18. A system for printing comprising:
a receiving substrate comprising a first printing material;
an aqueous printing liquid; and
a device for dispensing said aqueous printing liquid as an aqueous droplet onto a top surface of the receiving substrate;
wherein an impact of the aqueous droplet causes the first printing material to transfer from the receiving substrate to the aqueous droplet.

19. The system of claim 18, wherein the receiving substrate further comprises:
a supporting substrate;
a porous polymer layer having a surface, wherein the porous polymer layer comprises a continuous phase permeated by a plurality of pores, and wherein the continuous phase comprises a liquid crystal polymer; and
an anisotropic lubricant infused within and over the porous polymer layer, such that that the anisotropic lubricant at least partially fills the plurality of pores and forms a film on the surface of the porous polymer layer, wherein the anisotropic lubricant comprises thermotropic liquid crystal mesogen and the first printing material.

20. The system of claim 19, wherein the liquid crystal polymer is derived from 1,4-Bis-[4-(3-acryloyloxypropyloxy)benzoyloxy]-2-methylbenzene (RM257), 4-(6-acryloxy-hex-1-yl-oxy) phenyl 4-(hexyloxy)benzoate, 4-methoxybenzoic acid 4-(6-acryloyloxyhexyloxy) phenyl ester 4″-acryloyloxybutyl 2,5-di(4′-butyloxybenzoyloxy) benzoate, or combinations thereof.

21. The system of one of claim 19 or 20, wherein the thermotropic liquid crystal mesogen comprises 4-cyano-4′-n-pentyl-biphenyl (5CB), 4-cyano-4′-n-heptyl-biphenyl (7CB), 4′-octyl-4-biphenylcarbonitrile (8CB), 4-cyano-4′-oxyoctyl-biphenyl (8OCB), 4-cyano-4′-n-pentyl-terphenyl (5CT), (S)-4-Cyano-4′-(2-methylbutyl) biphenyl (CB15), or a combination thereof.

22. The system of any one of claims 19-21, wherein the thermotropic liquid crystal mesogen has:
a crystal mesophase when the thermotropic liquid crystal mesogen is at a temperature that is less than a first transition temperature, wherein when the thermotropic liquid crystal mesogen is in the crystal mesophase the thermotropic liquid crystal mesogen has long range orientational order and three dimensional positional order;
a smectic mesophase when the thermotropic liquid crystal mesogen is at a temperature greater than the first transition temperature and less than a second transition temperature, wherein the second transition temperature is greater than the first transition temperature, and wherein the smectic mesophase has long range orientational order and at least unidirectional positional order;
a nematic mesophase when the thermotropic liquid crystal mesogen is at a temperature greater than the second transition temperature and less than a third transition temperature, wherein the third transition temperature is greater than the second transition temperature, and wherein the nematic mesophase has long range orientational order and no positional order; and
an isotropic mesophase when the thermotropic liquid crystal mesogen is at a temperature above a second transition temperature, and wherein the isotropic mesophase has no orientational order and no positional order.

23. The system of any one of claims 19-22, further comprising changing the phase of the liquid crystal mesogen by changing a temperature of the receiving substrate.

24. The system of any one of claims 18-23, wherein the first printing material comprises a microparticle in an aqueous solution.

25. The system of any one of claims 18-24, wherein the first printing material comprises one or more of a polymer, a biologic material, a dye, etc.

26. The system of any one of claims 19-25, wherein the first printing material is present as an emulsion in the anisotropic lubricant.

27. The system of any one of claims 18-26, wherein the first printing material comprises one or more of a polymer, a biologic material, a dye, a salt, a surfactant, an ionic liquid, or a colloidal dispersion of inorganic, organic, or metallic molecules, or combinations thereof.

28. The system of any one of claims 18-27, wherein an aqueous droplet density, a height of the device for dispensing from the top surface of the receiving substrate, and a diameter of droplet of the aqueous droplet are varied to achieve an optimal Weber number (e.g. We).

29. The system of claim 28, wherein the optimal Weber number is 10 to 200.

30. The system of any one of claims 18-29, wherein the device for dispensing of the aqueous droplet is configured to dispense aqueous printing liquid droplets of 10 nL and 1 mL.

31. The system of any one of claims 18-30, wherein the first printing material has a viscosity of 1 cP to 10⁶ cP.

32. The system of any one of claims 18-31, wherein the receiving substrate comprises up to 40% by volume of the first printing material.

33. The system of any one of claims 18-32, wherein the aqueous droplet comprises one or more activating or reactive species, wherein an activating or reactive species is activating and/or reactive with the first printing material.

34. The system of any one of claims 18-33, wherein the receiving substrate comprises a second printing material, and wherein the receiving substrate comprises up to 40% by volume of the first printing material and the second printing material.

35. The system of claim 34, wherein the receiving substrate comprises a second printing material, and wherein the receiving substrate comprises up to 40% by volume of the first printing material and the second printing material.

36. The system of any one of claims 34-35, wherein the aqueous droplet comprises one or more activating or reactive species, wherein an activating or reactive species is activating and/or reactive with the first printing material and the second printing material.

37. A hydrogel product comprising one or more bioactive and/or bioinert compounds, the hydrogel product having a discrete size and shape, wherein the hydrogel material is formed by droplet-induced printing, wherein a receiving substrate comprises one or more hydrogel precursors, and wherein a printing liquid comprises an aqueous printing liquid dispensed from a source.

38. The hydrogel product of claim 37, wherein a hydrogel is printed on a receiving substrate, the receiving substrate comprising:
a supporting substrate;
a porous polymer layer having a surface, wherein the porous polymer layer comprises a continuous phase permeated by a plurality of pores, and wherein the continuous phase comprises a liquid crystal polymer; and
an anisotropic lubricant infused within and over the porous polymer layer, such that that the anisotropic lubricant at least partially fills the plurality of pores and forms a film on the surface of the porous polymer layer, wherein the anisotropic lubricant comprises thermotropic liquid crystal mesogen and the one or more hydrogel precursors.

39. The hydrogel product of claim 37 or 38, wherein the printing liquid further comprises bioglass.

40. The hydrogel product of any one of claims 37-39, comprising a thickness of 5 micrometers to 20 micrometers.

41. The hydrogel product of any one of claims 37-40, comprising a tensile strength of 0.25 MPa to 2.5 MPa.

42. The hydrogel product of any one of claims 37-41, wherein the hydrogel product has a disc shape.

43. The hydrogel product of any one of claims 37-42, wherein the hydrogel product has a ring shape.

44. The hydrogel product of any one of claims 37-43, wherein the source of the aqueous printing liquid is an ink jet printer.
